(19) United States
(12) Patent Application Publication
(10) Pub. No.: US 2011/0167025 A1
(43) Pub. Date: Jul. 7, 2011

(54) SYSTEMS AND METHODS FOR PARAMETER ADAPTATION

(76) Inventors: Kourosh Danai, Amherst, MA (US); James R. McCusker, East Bridgewater, MA (US)

(21) Appl. No.: 12/902,687

(22) Filed: Oct. 12, 2010

Related U.S. Application Data
(63) Continuation-in-part of application No. 12/220,446, filed on Jul. 24, 2008.
(60) Provisional application No. 61/250,349, filed on Oct. 9, 2009.

(51) Int. Cl. G06F 15/18; G06N 5/02

(52) U.S. Cl. 706/12; 706/45

(57) ABSTRACT

A method of parameter adaptation is used to modify the parameters of a model to improve model performance. The model separately estimates the contribution of each model parameter to the prediction error. It achieves this by transforming to the time-scale plane the vectors of output sensitivities with respect to model parameters and then identifying the regions within the time-scale plane at which the dynamic effect of individual model parameters is dominant on the output. The method then attributes the prediction error in these regions to the deviation of a single parameter from its true value as the basis of estimating individual parametric errors. The proposed Signature Isolation Method (PARSIM) then uses these estimates to adapt individual model parameters independently of the others, implementing, in effect, concurrent adaptation of individual parameters by the Newton-Raphson method in the time-scale plane. The Signature Isolation Method has been found to have an adaptation precision comparable to that of the Gauss-Newton method for noise-free cases. However, it surpasses the Gauss-Newton method in precision when the output is contaminated with noise or when the measurements are generated by inadequate excitation.

### CROSS REFERENCE TO RELATED APPLICATION

This application is a continuation-in-part application of U.S. application Ser. No. 12/220,446, filed on Jul. 24, 2008, and also claims priority to U.S. Application No. 61/250,349, filed on Oct. 9, 2009, the entire contents of the above applications being incorporated herein by reference.

### BACKGROUND OF THE INVENTION

Engineers and scientists are increasingly turning to sophisticated computer-based simulation models to predict and optimize process behavior in virtual environments. Yet, to be effective, simulation models need to have a high degree of accuracy to be reliable. An important part of simulation development, therefore, is parameter adaptation wherein the values of model parameters (i.e., model coefficients and exponents) are adjusted so as to maximize the accuracy of simulation relative to the experimental data available from the process. If parameter adaptation leads to acceptable predictions, the model is declared valid. Otherwise, the model is refined to higher levels of complexity so as to provide an expanded basis for parameter adaptation. The availability of an efficient and reliable parameter adaptation method, therefore, is crucial to model validation and simulation development.

Methods of parameter adaptation typically seek solutions to a set of parameters e that minimize a loss function V(Θ) over the sampled time T, as set forth in the relation:

\hat{Θ}=\hat{Θ}(Z^{N})=arg_{Θ} min V(Θ,Z^{N}) (1)

where Z^{N} comprises the measured outputs y(t), and

V(Θ,Z^{N})=∫_{O}^{T}L(∈(t))dt (2)

is a scalar-valued (typically positive) function of the prediction error E(t)=y(t)−y(t) between the measured outputs y(t) and model outputs y(t)=Mθ(u(t)) with u(t) being the input applied to the process. In cases where the process can be accurately represented by a model that is linear in parameters, or when the nonlinear model is transformed into a functional series that is linear in parameters, each model output can be defined as a linear function of the parameters to yield an explicit gradient of the loss function in terms of the parameters for regression analysis. Otherwise, parameter adaptation becomes analogous to a multi-objective (due to multiplicity of outputs) nonlinear optimization, wherein the solution is sought through a variety of methods, such as gradient-descent, genetic algorithms, convex programming, Monte Carlo, etc. In all these error minimization approaches a search of the entire parameter space is conducted for the solution.

However, not all model parameters are erroneous. Neither is the indiscriminate search of the entire parameter space practical for complex simulation models. As a remedy, experts use a manual approach of selecting parameters that they speculate to most effectively reduce each prediction error. They usually select the suspect parameters by the similarity of the shape of their dynamic effect to the shape of the transient prediction error. They then alter these parameters within their range in the direction that are expected to reduce the error and run new simulations to evaluate the effect of these parameter changes. If the new parameter values improve the results, they are further adjusted until they no longer improve the simulation. This process is followed for another set of suspect parameters and repeated for all the others until satisfactory results are obtained. If at the end of parameter adaptation adequate precision is attained, the model is declared valid and the adjusted model is presumed to represent the process. Even though this manual approach lacks a well-defined procedure and is tedious and time-consuming, it provides the advantage of targeted (selective) adaptation wherein each parameter is adapted separately.

A continuing need exists, however, for further improvements in model development and operation.

### SUMMARY OF THE INVENTION

The present invention provides a method of parameter adaptation or parameter selection that is used to adjust parameter values. A preferred embodiment of this method involves the use of a transformation of operating parameters into a domain and selectively varying parameter values in the domain to determine a set of adjusted parameter values that can be used to operate a particular system or process.

A preferred embodiment uses a transformation that identifies regions of the time-scale plane at which the effect of each parameter on the prediction error is dominant. It then approximates the prediction error in each region in terms of a single parameter to estimate the corresponding parameter's deviation from its “true” value, i.e., the parameter value that can be used to more accurately represent or model a selected system or method. Using these estimates, it then adapts individual parameters independently of the others in direct contrast to traditional error minimization of regression. This process can be referred to as the Parameter Signature Isolation Method (PARSIM), which takes the form of the Newton-Raphson method applied to single-parameter models, has been shown to provide better precision than the Gauss-Newton method in presence of noise. PARSIM is also found to produce more consistent and precise estimates of the parameters in the absence of rich excitation.

A preferred embodiment of the invention uses a processing system to perform the transformation and determine parameter values. The processing system can be a computer programmed to perform parameter adaptation for a variety of different applications. The system performs a process sequence in accordance with a programmed set of instructions that includes transformation to a selected domain and minimization of error associated with a given parameter value.

An important feature of the preferred system and method of the invention is that different parameter values can be determined separately from each other. Thus, a first parameter value can be determined without influencing the determination of additional parameter values.

Preferred embodiments of the present invention can be used in diverse applications including the design and use of engines such as gas turbine engines that can be used to propel aircraft and other vehicles. These systems can also be used in the design and use of control systems, such as building HVAC systems, chemical plant operations, in fault diagnosis and other simulation applications. A model based recurrent neural network can also be analyzed using the systems and methods described herein the neural network nodes can be represented by contours of Gaussian radial basis function (RBF) where the system is drained by adjusting the weights of the RBFs to modify the contours of the activation functions. The systems and methods can also be used in the design and use of filters or filter banks, which can be used in noise suppression, for example. This can be done, for example, by transforming the signal to the time scale domain, reducing the high frequency noise by thresholding the wavelength coefficients in the lower scales (higher frequencies) but avoids the need to reconstruct wavelet coefficients in the time domain due to the determination of parameters in the time-scale domain.

Confidence factors can be used to represent estimates of the noise distortion at different pixels in the time-scale plane. These confidence factors can be used as weights to determine adjusted parameter values.

### BRIEF DESCRIPTION OF THE DRAWINGS

FIG. 1A shows a processing system used to perform preferred embodiments of the present invention;

FIG. 1B shows a method of performing the adaptation method in accordance with a preferred embodiment of the invention;

FIG. 1C shows a graphical user interface to operate the system in accordance with preferred embodiments of the invention;

FIGS. 2A and 2B show the simulation errors resulted from univariate changes to parameters M and D respectively, where M and D denote their nominal values in the initial simulation;

FIGS. 3A-3D show the impulse response prediction error of the mass-spring-damper model in Eq. (12) (top plot solid line) and its approximation by the weighted sum of its parameter effects according to Eq. (11) (top plot dashed line); and 3B-3D show the parameter effects of m, c, and k at several nominal parameter values;

FIGS. 4A-4C show the parameter signatures of m, c and k of the mass-spring-damper model by Gauss WT, respectively;

FIGS. 5A-5C show two nearly correlated signals and the difference between the absolute values of their transforms in the time-scale domain;

FIGS. 6A-6C show two uncorrelated signals and the difference between the absolute values of their transforms in the time-scale domain;

FIGS. 7A-7D show two uncorrelated signals (7A, 7B) and the difference between the absolute values of their transforms in the time-scale domain (7C, 7D);

FIGS. 8A and 8B show the Gauss WT of the impulse response error of the mass-spring-damper model (8A) and its modulus maxima (8B);

FIGS. 9A-9D show the Gauss WT modulus maxima of the impulse response prediction error of the mass-spring-damper model and the parameter signatures of m, c and k at the error edges;

FIGS. 10A-10C show the parameter estimates for M, C and K, respectively, during adaptation by PARSIM and the Gauss-Newton method of the mass-spring-damper model when only one of the parameters is erroneous;

FIGS. 11A and 11B show Gauss error edges of the mass-spring-damper model associated with a noise-free output (11A) and a noise contaminated output (11B);

FIGS. 12A-12C illustrate the separation between noise related regions of the time-scale plane and the parameter signatures at the error edges of the mass spring damper model for M, C and K, respectively;

FIG. 13 graphically illustrates the mean value of the precision error corresponding to the results of Table 4;

FIG. 14A-14C graphically illustrate the parameter effects of K₂₁, K₁₂ and K₀₂ in the drug kinetics model of Carson et al.;

FIGS. 15A and 15B illustrate the adapted parameter of the drug kinetics model of Carson et al provided by the present invention (PARSIM) and the Gauss Newton method, respectively;

FIG. 16 graphically illustrates the mean prediction error of one hundred adaptation procedures of a Van der Pol oscillator parameters by the present invention (PARSIM) and the Gauss Newton model;

FIGS. 17A-17Z9g) illustrate aspects of a non-linear system with estimation of parameters.

FIGS. 18A and 18B illustrate the a sample of the Gauss wavelet transform of the measured pressure in FIGS. 18A and 18B, y(t), and simulated pressure by Model B in FIG. 18B, ŷ(t) and the time-scale plane are the contours of the wavelet coefficients, respectively;

FIGS. 18C and 18D illustrate measured and simulated values of pressure, respectively, inside the mold during an injection molding operation;

FIGS. 19A-19C are images to show the characteristic of image distances in comparison;

FIG. 20 shows an instrumented ASTM test mold and preliminary model;

FIGS. 21A-21E show pressure values obtained at five different locations of the mold shown together with their simulated counterparts;

FIGS. 22A-22C illustrate examples of contours of the Gauss wavelet coefficients of measured and simulated pressures by Models 2 and 3, respectively;

FIG. 23 illustrates an impulse response of the mass-spring-damper model with and without noise, and its low-pass filtered version;

FIGS. 24A-24B illustrate the noise affected wavelet coefficients smoothed along time and scale, respectively;

FIGS. 25A-25B illustrate the wavelet transform of a noise sample and the difference between the wavelet transform of the prediction error and its smoothed version, respectively;

FIG. 26 estimated confidence factor at each pixel used as weights wₖₗ in the estimation of \hat{Δ}\hat{θ}_{ib};

FIG. 27 illustrates the precision error obtained with PARSIM and Gauss-Newton method at different levels of signal-to-noise ratio;

FIG. 28 illustrates an improvement in the precision error of the proposed method when noise has a uniform distribution;

FIGS. 29A-29C illustrate parameter signatures extracted at the three different dominance factors of 2, 2.5, and 3.68, respectively;

FIGS. 30A-30C illustrate the estimated value of the parameter error at individual pixels of its parameter signatures in FIGS. 29A-29C extracted at the three different dominance factors of 2, 2.5, and 3, respectively;

FIG. 31 is a schematic diagram of the high-bypass-ratio turbofan engine represented by the FANJETPW simulation model, together with the station and primary component locations;

FIGS. 32A-32I illustrate the parameter signature of HPC_{eff} corresponding to each measurement with a dominance factor of 2;

FIGS. 33A-33C are graphical representations of the percentage of parameter signatures that remain present for each measurement across ten different nominal parameter values using the dominance factors of 2, 2.5, and 3, respectively;

FIGS. 34A-34C illustrates the input (Power Lever Angle in degrees) applied to the model to generate the transient outputs along with two of the outputs (y₁: Temperature at Station 2.5 (° R) and y₃: Pressure at Station 3 (psia));

FIGS. 35A-35J are parameter estimates of the map scalars at each iteration of adaptation by the hybrid approach where the dashed lines indicate the true parameter values;

FIGS. 36A-36B illustrate the prediction and precision errors obtained during adaptation by the hybrid method for four different initial parameter value sets;

FIG. 37 illustrates a system using application of PARSIM for controller tuning;

FIGS. 38A-38D illustrate the closed-loop response of the systems in FIG. 37 with each of the four plants in Table tuned by PARSIM or IFT;

FIGS. 39A-39D illustrate the control applied to the four plants in Table 16 with the controllers tuned by PARSIM or IFT;

FIGS. 40A-40B illustrate the closed-loop response of the system in FIG. 37 with G₃ in Table 16 as the plant. Several responses are shown with controllers tuned by both IFT and PARSIM using different segments of the time-scale plane for parameter signature extraction;

FIGS. 41A-41B illustrate a search of the control parameters θ₁ and θ₂ in a difficult terrain. Three starting points are shown where either IFT or PARSIM, or both have difficulty leading the solution to its global minimum;

FIGS. 42A-42D illustrate performance error obtained from the application of IFT, PARSIM and the Hybrid method to tuning the controllers for the four plants in Table 16;

FIGS. 43A-43D illustrate performance error obtained from the application of IFT, PARSIM and the Hybrid method to tuning the controllers for the four plants in Table 16. For these tests, noise was also added to the system output to more closely depict reality.

### DETAILED DESCRIPTION OF THE INVENTION

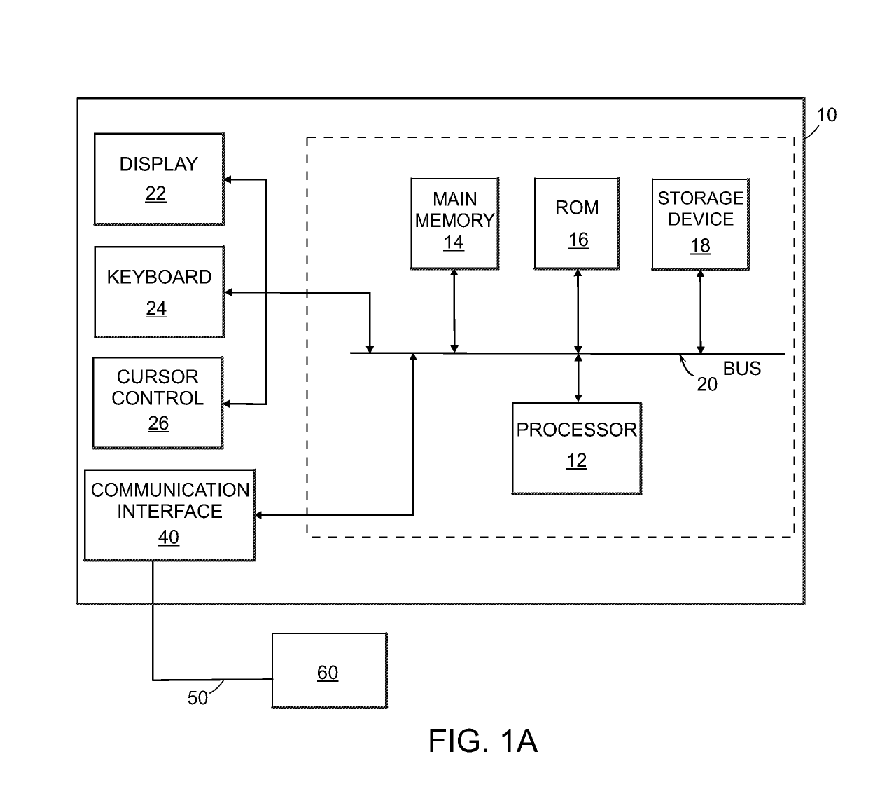

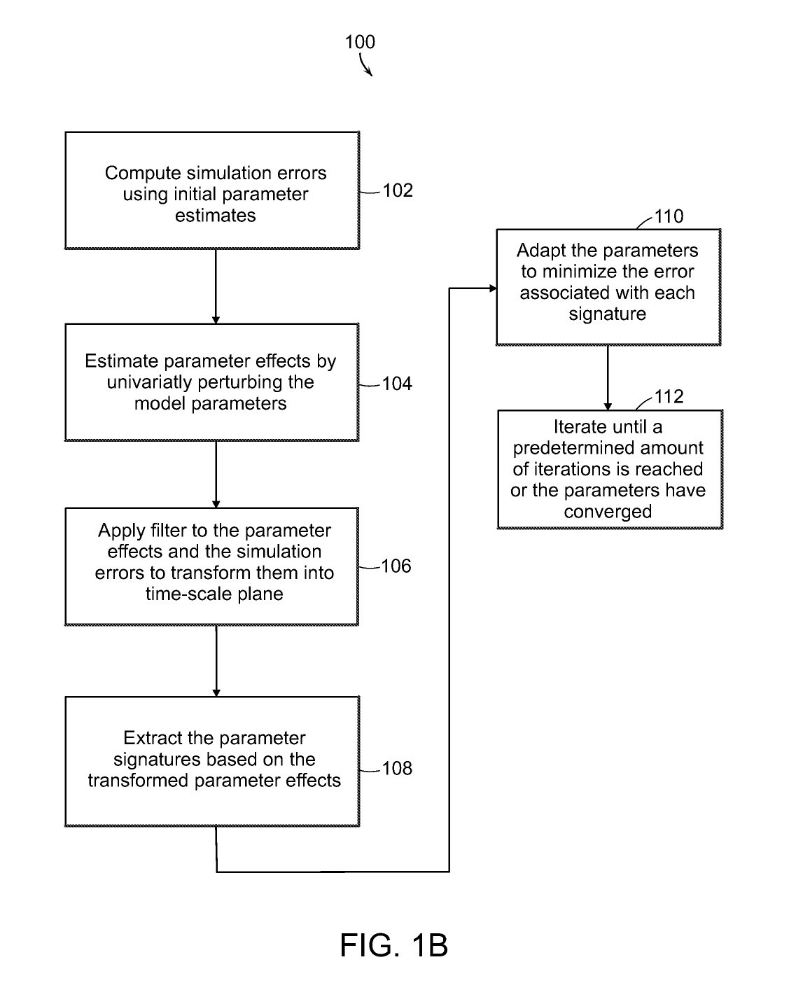

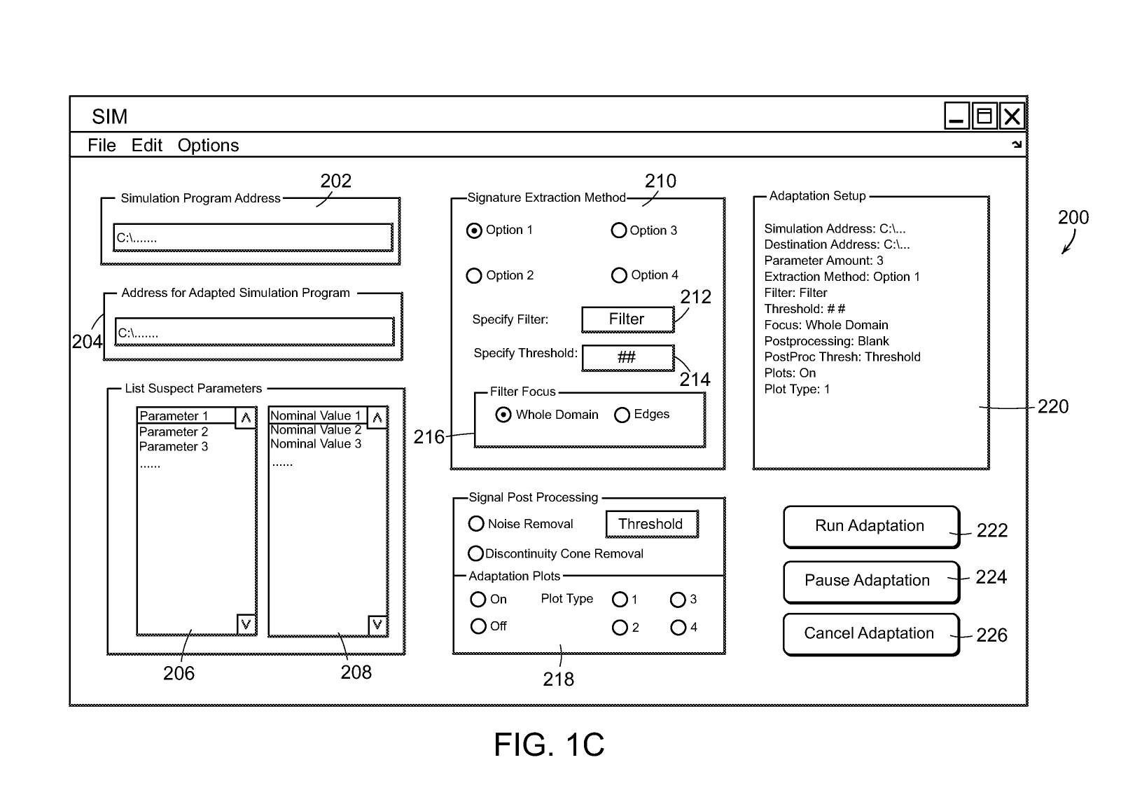

Preferred embodiments of the present invention systems or data processors that perform the processing functions useful in determining the parameter values that can improve model performance. Such a system 10 is shown in connection with FIG. 1A. The system 10 can include a processor 12 that can interface with a main memory 14, a read-only memory (ROM) 16, or other storage device or medium 18 via a bus 20. A user interface, such as, a keyboard 24 or cursor control 26 can be used to program processor 12 or to access data stored in memory. A display 22 can be used with the graphical user interface described in FIG. 1B. A communication interface 40 can be used for a network interface or to provide a wired or wireless connection 50 to other computer systems with application 60 to access the parameter adaptation capabilities of the system 10. The processor 12 can be programmed to perform operations in accordance with the present invention using a programming language, such as MATLAB® available from The Mathworks of Natick, Mass. MATLAB® versions 6.5 or 7.4 can be used, for example, to implement the methods described herein. The system 10 preferably has at least 512 MB of RAM and a processor, such as an Intel Pentium® 4 or AMD Athlon® 64. The system 10 can include at least a 16 bit OpenGL graphics adapter and utilizes about 100 MB of disk space from the programs used to perform operations in accordance with the invention, although reduced storage requirements can be implemented, particularly when the invention is implemented as a standalone executable file that is independent from the MATLAB® or other operating environment. To interact with a particular simulation program operating on the same or some external processor, the outputs are preferably in either .dat or .mat form to facilitate operation with a preferred embodiment. The software is configured to access and adjust the model parameters within a simulation model, for example, to perform the desired adaptation.

Preferred embodiments of the present invention can be used for a variety of applications 60 including: controller tuning, simulation models, learning methods, financial models and processes communication systems and feedback control systems, such as, active vibration control.

Controllers used in a variety of equipment and machinery used in manufacturing, for example, have multiple outputs that require timing for proper operation of the system. A preferred embodiment of the present invention can be installed on such a system or it can be connected to the system 10 of FIG. 1A by interface 40.

Simulation programs are used for many applications including computer games, biological systems, drug design, aircraft design including aircraft engines, etc.

Learning systems, such as, neural networks, involve adjustment of operating parameters to improve system operation. Neural networks, which can rely upon the gradient of the output, can utilize a preferred embodiment of the invention for correction of neural network parameters.

Financial modeling and arbitrage methods in the financial markets can be improved with the use of the present invention. Statistical arbitrage typically relies on regression techniques can be replaced by a preferred embodiment of the invention to provide improved financial modeling and market operations parameter adaptation.

Parameter adaptation is used in communication systems to provide improved operation control. A preferred embodiment of the present invention can modify the operating parameters of such a system to provide improved system operation. Feedback systems generally can employ the present invention to improve operational control, such as in active vibration control where sensors are used to measure vibration and the measured data is processed to provide adjusted operating parameters of the system causing vibration.

Illustrated in FIG. 1B is a process sequence 100 illustrating a preferred method of performing parameter adaptation in accordance with a preferred embodiment of the invention. Initially, a user computes 102 simulation errors using estimates of initial parameters. The user then univariately perturbs or varies 104 the parameters before transforming 106 them into a domain from which the signature of parameters can be extracted 108. The parameters can then be adapted or varied 110 to minimize error. This process can be iterated 112 until convergence of parameter values. Shown in FIG. 1C is a screen 200 illustrating a graphical user interface (GUI) used in performing the method illustrated in FIG. 1C. The screen includes data entry and process selection features including the program address 202, the adapted simulation program 204, parameters 206 and values 208 thereof. Features included signature extraction method options 210, filter selection 212 with thresholding 214 and focus 216. Post processing 218, such as, noise removal and plot types can be selected. A list of set-up features 220 can be displayed and run 222, pause 224 and cancel 226 icons can be selected.

The concept of determining model parameters signature isolation is based on selection of the parameters by matching the features of the variation or error to those of the parameter effects. The approach is illustrated in the context of the following model representing the velocity of a submarine, as

$$\dot{v} ( t ) = - \frac{ρ {AC}_{d}}{2 M} {v}^{2} ( t ) + \frac{1}{M} F ( t ) \qquad ( 3 )$$

where v(t) represents velocity, ρ the water density, A the cross-sectional area of the boat, M its mass, C_{d} the drag coefficient, and F(t) its thrust. Since the drag parameters ρ, A, and C_{d} are grouped together, they are individually nonidentifiable and only their product (parameter group) D=ρAC_{d} can be numerically adjusted. The conditions for mutual identifiability of parameters as a precondition to signature extraction will be specified hereinafter.

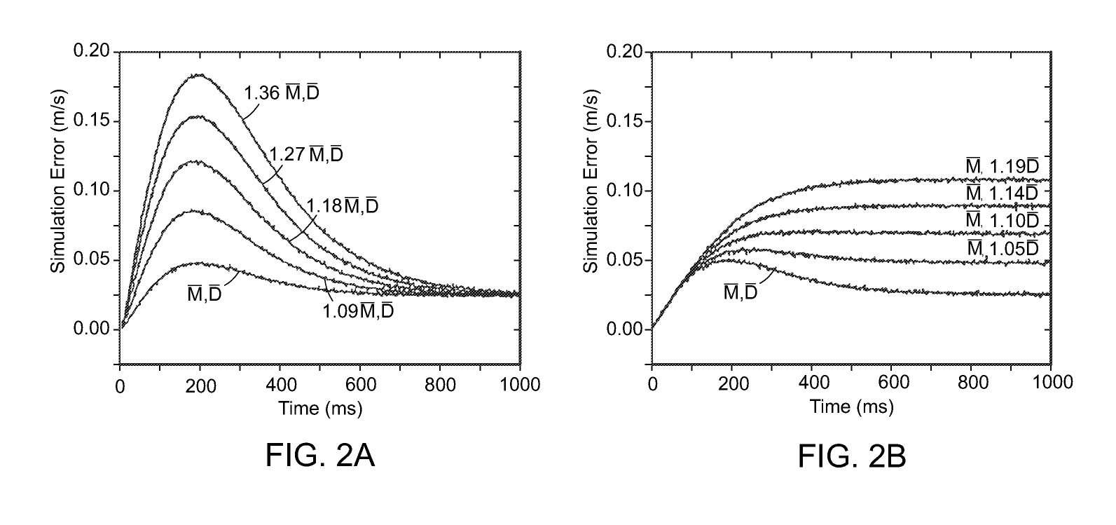

The prediction errors resulting from univariate changes in parameters M and D are shown in FIGS. 2A and 2B. From an examination of these error shapes, one can observe that M predominantly affects the transient part of the error (the left-hand plot), whereas the lumped drag parameter D affects its steady-state value (the right-hand plot). This indicates, among other things, the uniqueness of the effects of the two parameters, hence, their mutual identifiability. Using the error-shape changes in FIGS. 2A and 2B as mental models, the expert can refer to the original prediction error, the plot marked by “ M̅, D̅”, and conclude that because both error types exist in the original prediction error, both parameters M̅ and D̅ need to be adjusted.

The ability to record the prediction error shapes as mental models is a cognitive trait that computers typically do not possess. Therefore, the parameter signatures need to be defined in terms of the quantitative features of the error shapes. As it is shown hereinafter, such a quantification can be performed in the time-scale plane by filtering the error and output sensitivities to the parameters.

Let the model M_{Θ} (u(t)) accurately represent the process. Then the model outputs ŷ(t,u(t))=M_{Θ}(u(t)) generated with the same input u(t) applied to the process will match the measured process outputs y(t, u(t)) (in mean-square sense) if the model parameters Θ=[θ₁, . . . , θ_{Q}]^{T}εR^{Q} match the true parameters Θ*=[θ₁*, . . . , θ_{Q}*]^{T}; i.e.,

y(t,u(t))=\hat{y}(t,u(t),Θ*)+v (4)

with v representing unbiased measurement noise. If the model is identifiable [20]; i.e.,

ŷ(t,u(t)|Θ′)≡\hat{y}(t,u(t)Θ″) [symbol] Θ=Θ″ (5)

then

y(t,u(t))≡\hat{y}(t,u(t), Θ̅)+v [symbol] Θ̅=Θ* (6)

Parameter adaptation becomes necessary when the model parameters Θ̅ are inaccurate, as represented by a nonzero prediction (simulation) error between the measured outputs y(t,u(t)) and model outputs ŷ(t,u(t) Θ̅), as

ε(t)=y(t,u(t))−\hat{y}(t,u(t), Θ̅ (7)

PARSIM, like the gradient-based methods of parameter adaptation, relies on a first-order Taylor series approximation of the measure output y(t) as

$$y ( t , u ( t ) ) \approx \hat{y} ( t , u ( t ) , \hat{Θ} ) + {\sum }_{i = 1}^{Q} Δ {θ}_{i} \frac{\partial \hat{y} ( t , u ( t ) , Θ )}{\partial {θ}_{i}} \vert Θ = \overline{Θ} \qquad ( 8 )$$

where Δθᵢ=θᵢ*− θ̅ᵢ denotes the deviation of each parameter from its true value (parametric error) and ∂ŷ(t,u(t),Θ)/∂θᵢ represents the vector of output sensitivity with respect to parameter θᵢ. By substituting (8) into (7), the prediction error can be approximated as the weighted sum of the output sensitivities as

ε(t,u(t),Θ*, Θ̅)≈ΔΘ^{T}Φ (9)

where Φ denotes the matrix of output sensitivities with respect to the model parameters at individual sample points tₖ:

$$Φ = [ \begin{matrix}\frac{\partial \hat{y} ( {t}_{1} , \overline{Θ} )}{\partial {θ}_{1}} & … & \frac{\partial \hat{y} ( {t}_{1} , \overline{Θ} )}{\partial {θ}_{Q}} \\ ⋮ & ⋱ & ⋮ \\ \frac{\partial \hat{y} ( {t}_{N} , \overline{Θ} )}{\partial {θ}_{1}} & … & \frac{\partial \hat{y} ( {t}_{N} , \overline{Θ} )}{\partial {θ}_{Q}}\end{matrix} ] \qquad ( 10 )$$

In gradient-based methods, the individual rows of the sensitivity matrix Φ are generally of interest to denote the gradient of the output with respect to individual parameters at each sample point tₖ. In PARSIM, instead, the individual columns of Φ are considered. Each column is treated as a signal that characterizes the sensitivity of the output to a model parameter during the entire sampled time T. The columns of the sensitivity matrix are called parameter sensitivities in traditional sensitivity analysis, but we refer to them here as parameter effects to emphasize their relation to the outputs, analogous to the models in FIGS. 2A and 2B.

Parameter effects can be obtained empirically (in simulation) by perturbing each parameter to compute its dynamic effect on the prediction error, similar to the strategy used by the experts to obtain the input sensitivities to individual parameters in manual simulation tuning. According to this strategy, parameter effects, εᵢ, can be defined as:

$${ɛ}_{i} ( t , u ( t ) , \overline{Θ} ) = \frac{\hat{y} ( t , u ( t ) , \overline{Θ} + δ {θ}_{i} ) - \hat{y} ( t , u ( t ) , \overline{Θ}}{{δθ}_{i}} \qquad ( 11 )$$

where δθᵢ represents a perturbation to parameter θᵢ. Given that parameter effects approximate the model output sensitivities to individual parameters:

$${ɛ}_{i} ( t , u ( t ) , \overline{Θ} ) \approx \frac{\partial \hat{y} ( t , u ( t ) , Θ )}{\partial {θ}_{i}} {\vert}_{Θ = \overline{Θ}} {=}_{{δθ}_{i} \to 0}^{lim} \frac{\hat{y} ( t , u ( t ) , \overline{Θ} + δ {θ}_{i} ) - \hat{y} ( t , u ( t ) , \overline{Θ}}{{δθ}_{i}} \qquad ( 12 )$$

one can write the prediction error in terms of the parameter effects, as:

$$ɛ ( t , u ( t ) , {Θ}^{*} , \overline{Θ} ) \approx {\sum }_{i = 1}^{Q} Δ {θ}_{i} {ɛ}_{i} ( t , u ( t ) , \overline{Θ} ) + v \qquad ( 13 )$$

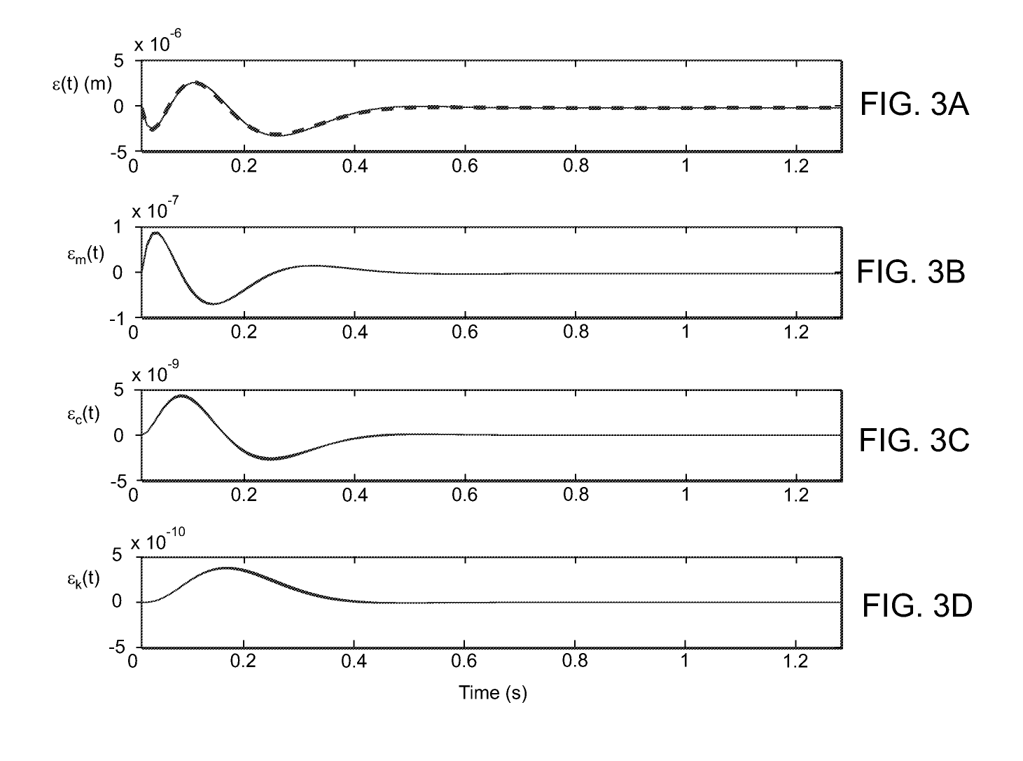

To illustrate the concept of parameter effects and their utility in approximating the prediction error, let us consider the error in the impulse response of the linear mass-spring-damper model:

$$m \frac{{d}^{2} x}{d {t}^{2}} + c \frac{d x}{d t} + kx = F ( t ) \qquad ( 14 )$$

where x denotes displacement, m its lumped mass, c its damping coefficient, k its spring constant, and F(t) an external excitation force. The prediction error here is caused by the mismatch between the nominal parameters Θ̅=[ m̅, c̅, k̅]^{T}=[340, 10500, 125×10³]^{T}, responsible for x(t, Θ̅), and the true parameters Θ*=[375,9800,130×10³]^{T} used to obtain x(t, Θ̅*). The prediction error ε(t)=x(t)− x̅(t) is shown in the top plot of FIG. 3A (solid line) along with its approximation by the weighted sum of the parameter effects (dashed line). Together with this plot, are shown the parameter effects of m, c, and k (FIGS. 3B, 3C and 3D) at several nominal parameter values within 10% of Θ̅. The results indicate close approximation of the error by the weighted sum of parameter

$$∀ t ∈ \vert β ( t ) \vert \leq \frac{{C}_{m}}{1 + {t}^{m}}$$

effects in FIGS. 3A-3D, as well as low sensitivity of the parameter effects to variations in Θ̅.

In a preferred embodiment of the invention, a transformation to the time-scale plane is used to obtain error data. Let β(t) be a smoothing function with a fast decay; i.e., any real function β(t) that has a nonzero integral and: [symbol]
(15)
   for some Cₘ and any decay exponent m. One may consider this smoothing function to be the impulse response of a low-pass filter. An example of such a smoothing function is the Gaussian function. For function β(t), βₛ(t) denotes its dilation by the scale factor s, as:

$${β}_{s} ( t ) = \frac{1}{s} β ( \frac{t}{s} ) \qquad ( 16 )$$

and its convolution with f(t) is represented as:

f(t)*β(t)=∫_{-∞}^{∞}f(t)β(t−τ)dτ (17)

Now if ψ(t) is the nth order derivative of the smoothing function β(t); i.e.,

$$ψ ( t ) = {( - 1 )}^{n} \frac{{d}^{n} ( β ( t ) )}{d {t}^{n}} \qquad ( 18 )$$

and has a zero average:

∫_{-∞}^{∞}ψ(τ)dτ=0 (19)

then it is called a wavelet, and its convolution with f(t) is called the wavelet transform W{f(t)} of f(t); i.e.,

W{f(t)}=f(t)*φₛ(t) (20)

It has been shown that this wavelet transform is a multiscale differential operator of the smoothed function f(t)*βₛ(t) in the time-scale plane; i.e.,

$$W \{ f ( t ) \} = {s}^{n} \frac{{d}^{n}}{d {t}^{n}} ( f ( t ) * {β}_{s} ( t ) ) \qquad ( 21 )$$

For instance, the Gauss wavelet which is the first derivative of the Gaussian function will result in a wavelet transform that is the first derivative of the signal f(t) smoothed by the Gaussian function at different scales, and orthogonal to it. Similarly, the Mexican Hat wavelet will produce a wavelet transform that is the second derivative of the smoothed signal in the time-scale plane and the first derivative of the wavelet transform by the Gauss wavelet. As such, the transforms by these wavelets accentuate the differences between the parameter effects, such that one can then isolate regions of the time-scale plane wherein the wavelet transform of a single parameter effect is larger than all the others. At these regions, the prediction error can be attributed to the error of individual parameters and used to separately estimate the contribution of each parameter to the error.

If one considers the above analogy in the time domain, it is synonymous with finding one component ∂ŷ(tₖ)/∂θᵢ in the sensitivity matrix Φ in Chen et al, “Identification of Nonlinear Systems by Haar Wavelet,” Proc of IMECE04 Paper No. INECE 2004-62417 (2004), incorporated herein by reference, that can be much larger than all the other components in that row, associated with an individual sample time tₖ. Even if such a single row with such characteristic could be found, it would be considered just ‘lucky.’ Yet the present invention provides for identification of such isolated regions can be consistently found within the time-scale plane, for example, using different wavelets for all but mutually nonidentifiable parameters. To illustrate the improved identifiability achieved in time-scale, consider the singular values of the parameter effects of the mass-spring-damper model at a nominal parameter vector. In time domain, the singular values are:

[λ₁ₜ λ₂ₜ λ₃ₜ]=[1.8366 0.9996 0.1638]

but in the time-scale plane they vary, depending on the function used for the transformation of the parameter effects. For illustration purposes, the mean of singular values across all scales obtained by the Gaussian smoothing function and the Gauss and Mexican Hat wavelets are shown in Table 1 along with those at the smallest scale.

TABLE 1
The singular values of the transformed parameter effects in the time-scale
plane by both the Gaussian function and Gauss and Mexican Hat wavelets.

| | Averaged Across Scales | | | At the Smallest Scale | | | | |
|---|---|---|---|---|---|---|---|---|
| Function | λ̅_{iw} | | | λ_{iw} | | | Πᵢ₌₁³ λ̅_{iw} | λ̅_{1w}/ λ̅_{3w} |
| Gaussian function | 1.9235 | 1.0009 | 0.0756 | 1.845 | 0.9996 | 0.1553 | 0.1455 | 25.4543 |
| Gauss wavelet | 1.6584 | 0.9999 | 0.3417 | 1.1378 | 1 | 0.8621 | 0.5666 | 4.8541 |
| Mexican Hat | 1.6026 | 0.9994 | 0.398 | 1.2803 | 0.9982 | 0.7215 | 0.6374 | 4.027 |
| wavelet | | | | | | | | |

According to principle component analysis, the more separated the characteristic roots (singular values) are, the more correlated the data; i.e., the parameter effects. As observed from the above singular values, while the sum of each set is the same in both time and time-scale; i.e.,

$${\sum }_{i = 1}^{3} {λ}_{it} = {\sum }_{i = 1}^{3} {λ}_{iw} = 3$$

the singular values are considerably more separated in the time domain than those in time-scale obtained by the wavelets. In the time domain, these indices are:

$${\prod }_{i = 1}^{3} {λ}_{it} = 0.3007 and \frac{{λ}_{1 t}}{{λ}_{3 t}} = 11.2128$$

which are both larger than those obtained with the Gauss and Mexican Hat wavelets, indicating weaker delineation of the parameter effects in time domain than their transformed versions in the time-scale plane by the wavelets. It is reaffirming to also note that the transformed parameter effects by the Gaussian function become more overlapped due to the smoothing effect of the Gaussian function.

A parameter signature is defined here as the union of all pixels in the time-scale plane at which the effect of a single parameter dominates the others in affecting the error. The formal definition of a parameter signature is as follows.

The signature of a parameter is defines as follows: If a pixel (tₖ, Sₗ) exists which satisfies the following condition:

W{εᵢ}(tₖ,sₗ)>>W{εⱼ}(tₖ,sₗ) ∀j=1, . . . , Q≠i (22)

then it is labeled as (tₖⁱ,sₗⁱ) and included in Γᵢ, the signature of parameter θᵢ.

The availability of parameter signatures Γᵢ, provides significant transparency to the parameter adaptation problem. It makes possible attributing the wavelet transform of the prediction error:

$$W \{ ɛ ( t , u ( t ) , {Θ}^{*} , \overline{Θ} ) \} \approx {\sum }_{i = 1}^{Q} Δ {θ}_{i} W \{ {ɛ}_{i} ( t , u ( t ) , \overline{Θ} ) \} + W \{ v \} \qquad ( 23 )$$

to a single parametric error Δθᵢ for all the pixels (tₖⁱ,sₗⁱ)∈Γᵢ, as:

$$W \{ ∈ ( t , {Θ}^{*} , \overline{Θ} ) \} ( {t}_{k}^{i} , {s}_{l}^{i} ) \approx Δ {θ}_{i} W \{ {ɛ}_{i} ( t , \overline{Θ} ) \} ( {t}_{k}^{i} , {s}_{l}^{i} ) \qquad ( 24 )$$

The above equation, which represents one of the Q single-parameter replacement equations to the multi-parameter error equation described by S. Mallat in “A Wavelet tour of Signal Processing,” Academic Press, 2^{nd} Edition (1999), is a method to decoupling the prediction error as a function of individual parameters. Using the above single-parameter approximation of the error over the pixels (tₖⁱ,sₗⁱ)∈Γᵢ, one can then obtain the mean estimate of each parametric error as:

$$\hat{Δ {θ}_{i}} ( \overline{Θ} ) \approx \frac{1}{{N}_{i}} {\sum }_{l = 1}^{M} {\sum }_{k = 1}^{N} \frac{W \{ ε ( t , {Θ}^{*} , \overline{Θ} ) \} ( {t}_{k}^{i} , {s}_{l}^{i} )}{W \{ {ɛ}_{i} ( t , \overline{Θ} ) \} ( {t}_{k}^{i} , {s}_{l}^{i} )} \qquad ( 25 )$$

where Nᵢ denotes the number of pixels (tₖⁱ,sₗⁱ) included in Γᵢ. The above estimate of individual parametric errors then provides the basis for correcting each parametric error separately.

Preferred embodiments of the present invention provide different techniques for extracting the parameter signatures. The simplest technique entails applying a common threshold to the wavelet transform (WT) of each parameter effect W{εᵢ} across the entire time-scale plane, and then identifying those pixels at which only one W{εᵢ} is nonzero. The threshold operation takes the form:

$$\overline{W \{ {ɛ}_{i} \}} = \{ \begin{matrix}0 & \vert W \{ {ɛ}_{i} \} ( {t}_{k} , {s}_{l} ) \vert < η \vert {max}_{( t , s )} W \{ {ɛ}_{i} \} \vert \\ W \{ {ɛ}_{i} \} ( {t}_{k} , {s}_{l} ) & otherwise\end{matrix} \qquad ( 26 )$$

where 0<η<1 is an arbitrary threshold value and |max_{(t,s)}W{εᵢ}| denotes the largest absolute wavelet coefficient of the parameter effect. Parameter signature extraction then entails searching in the time-scale plane for those pixels (tₖⁱ,sₗⁱ) where only one \overline{W{εᵢ}} is non-zero. The pixels labeled as (tₖⁱ,sₗⁱ)εΓᵢ, then satisfy the following:

| \overline{W{εⱼ}}(tₖⁱ,sₗⁱ)|>0, \overline{W{εⱼ}}(tₖⁱ,sₗⁱ=0∀j=1, . . . , Q≠i (27)

which is synonymous with:

$$\vert W \{ {ɛ}_{i} \} ( {t}_{k}^{i} , {s}_{l}^{i} ) \vert > η {max}_{( t , s )} W \{ {ɛ}_{i} \} \vert , \vert W \{ {ɛ}_{j} \} ( {t}_{k}^{i} , {s}_{l}^{i} ) \vert < η \vert {max}_{( t , s )} W \{ {ɛ}_{j} \} \vert ∀ j = 1 , … , Q \neq i \qquad ( 28 )$$

By comparing (28) to (22), one can see that the proposed signature extraction technique does not necessarily ensure that every pixel (tₖⁱ,sₗⁱ) will satisfy (20), because it is always possible that for some small εᵢ>0:

$$\vert W \{ {ɛ}_{i} \} ( {t}_{k}^{i} , {s}_{l}^{i} ) \vert + {ɛ}_{t} > η {max}_{( t , s )} W \{ {ɛ}_{i} \} \vert , \vert W \{ {ɛ}_{j} \} ( {t}_{k}^{i} , {s}_{l}^{i} ) \vert - {ɛ}_{t} < η \vert {max}_{( t , s )} W \{ {ɛ}_{j} \} \vert ∀ j = 1 , … , Q \neq i \qquad ( 29 )$$

It is shown below that the more dissimilar the parameters effects are, the more likely it is to approximate the parameter signatures by the above thresholding technique.

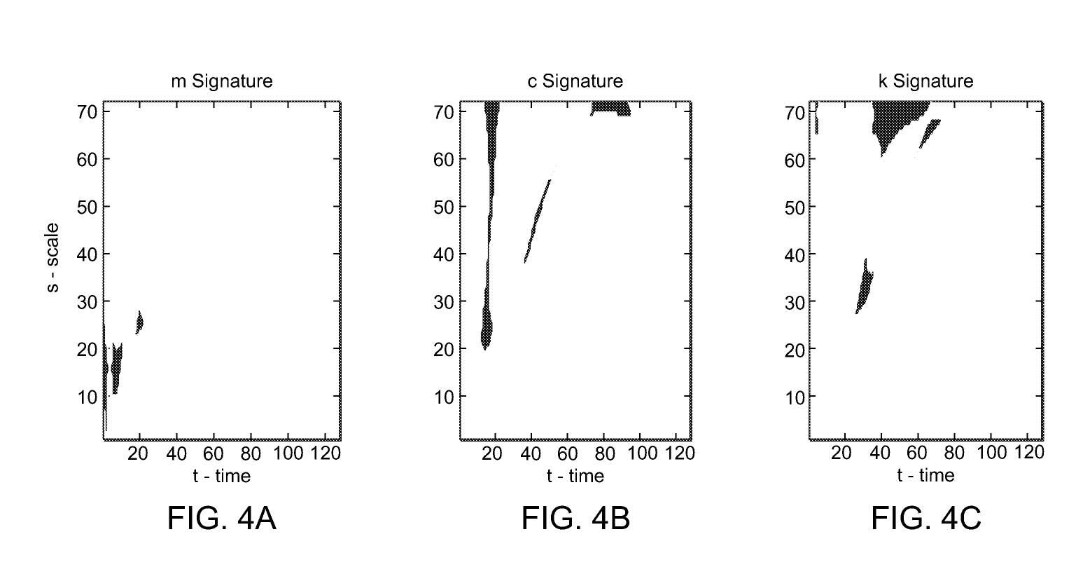

The effectiveness of the above parameter signature approximation strategy can be demonstrated in the context of the prediction error of FIGS. 3A-3D. The parameter signatures obtained from the Gauss WT of the parameter effects with a threshold value of η=0.2 are shown in FIGS. 4A-4C. Based on these signatures, the average estimate of parametric errors obtained are:

\hat{Δ}\hat{θ}=[\hat{Δ}\hat{m},\hat{Δ}ĉ,\hat{Δ}\hat{k}]=[30,−759,5962] vs ΔΘ=[Δm,Δc,Δk]=[35,−700,5000] (30)

which compare favorably together.

Before proceeding to parameter adaptation, consider the conditions for signature extraction. In general, the uniqueness of the parameter adaptation solution resulting from the parameter signatures is bound by the posterior identifiability of the model which is dependent on the input conditions and noise, in addition to structural identifiability of the model. But the above strategy of isolating pixels at which the contribution to the prediction error of a single parameter is dominant depends, by and large, on the dissimilarity of the pairs of parameter effects. This is defined in terms of mutual identifiability of model parameters. Specifically, if δθᵢ and δθⱼ denote perturbations to the two mutually identifiable parameters θᵢ and θⱼ, respectively, then according to (5), the following must be true:

∀δθᵢ and δθⱼ≠0 [symbol] ŷ(t| Θ̅+δθᵢ)≢\hat{y}(t| Θ̅+δθⱼ) (31)

Mutual identifiability is analytically tractable for linear models and empirically assessable for nonlinear models with various input conditions. Furthermore, it can be evaluated in the timescale domain. The important feature of mutual identifiability (m.i.) is that it can be assessed through the correlation of parameter effects, as stated in the following proposition.

It is known that given input u(t), two parameters θᵢ and θⱼ are mutually identifiable if and only if their parameter effects εᵢ(t) and εⱼ(t) are not collinear; i.e.,

θᵢ and θⱼ m.i. [symbol] εᵢ(t)≠αεⱼ(t)∀α∈ [symbol] (32)

According to the above, mutual identifiablility only ensures pairwise linear independence of the columns of the sensitivity matrix Φ. As such, it is only a necessary condition for posterior identifiability which requires that the sensitivity matrix Φ be full column rank.

The extension of these results to parameter signature extraction becomes clear when one considers the WT of the parameter effects of two mutually nonidentifiable parameters θᵢ and θⱼ. According to the above theorem, the parameter effects of two mutually nonidentifiable (m.n.i.) parameters θᵢ and θⱼ are collinear; i.e.,

θᵢ and θⱼ m.i.

Therefore, the threshold operation in equation (26) will result in identical nonzero regions for \overline{W{εᵢ}} and \overline{W{εⱼ}}, thus making it impossible to extract unique signatures for either of the two parameters according to equation (25). Consequently, parameter signatures cannot be extracted for two mutually nonidentifiable parameters.

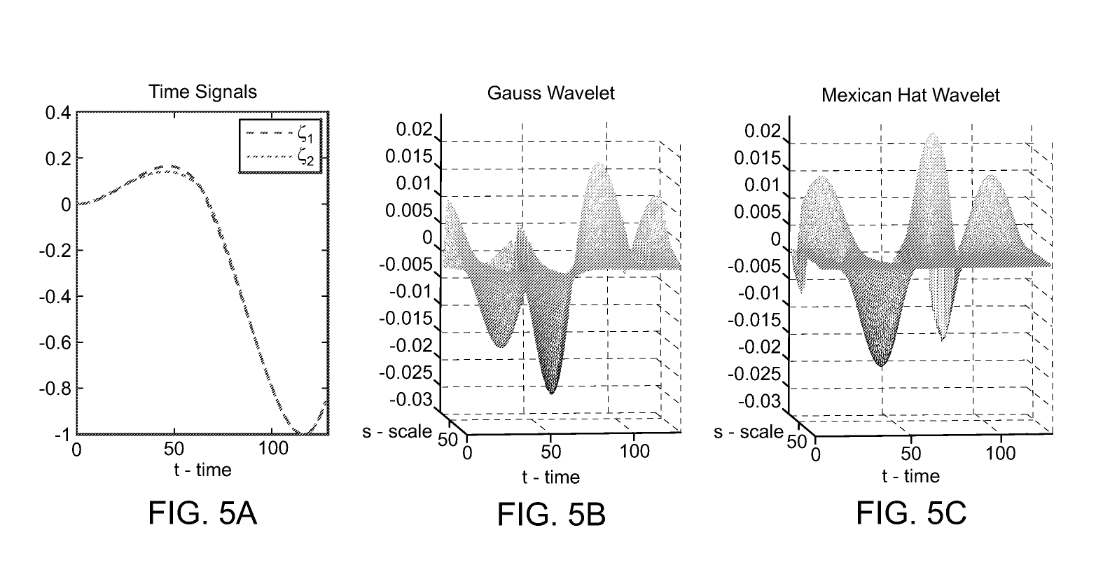

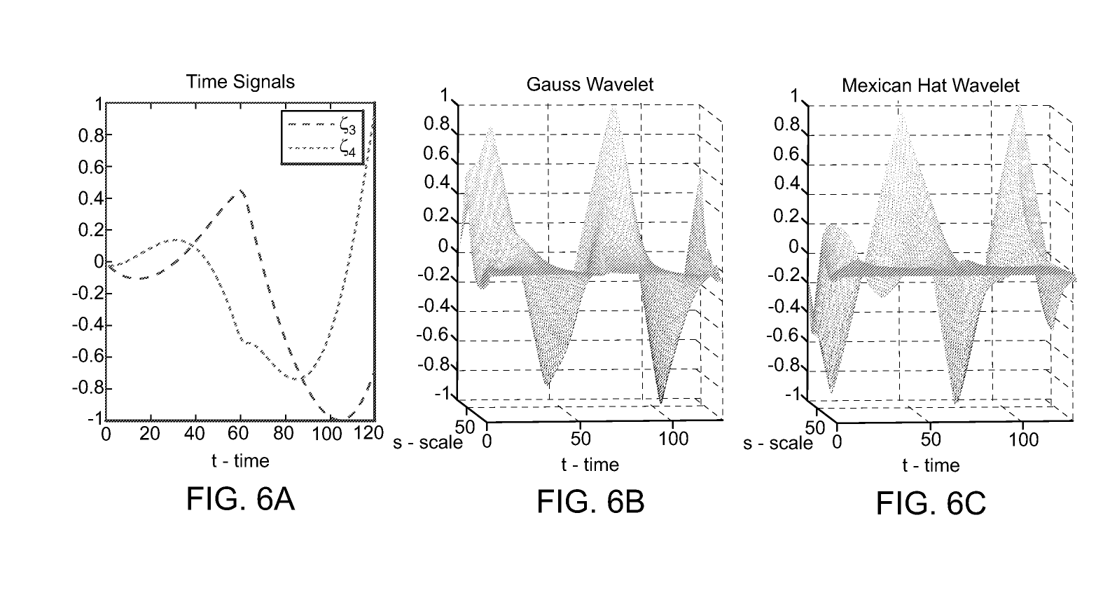

Mutual identifiability is also a sufficient condition for approximating parameter signatures by thresholding. To substantiate this, consider the two signals ζ1 and ζ2 in FIG. 5A to represent the hypothetical parameter effects of two parameters θ₁ and θ₂. These two signals are nearly collinear with a correlation coefficient of 0.9997. Yet when the difference between their absolute normalized wavelet transforms is considered, |W{ζ₁}|/max|W{ζ₁}|−|W{ζ₂}|/max|W{ζ₂}|, shown in FIGS. 5B and 5C for both the Gauss and Mexican Hat wavelets, one observes that there are both positive and negative wavelet coefficients. This indicates that for each signal, there are regions of the time-scale plane where each signal's wavelet coefficient exceeds the other's, albeit by a small margin. As such, some threshold η can be found that satisfies (26). It is also clear that because of the small difference margins between the wavelet coefficients in each case, the approximation of the parameter signatures of θ₁ and θ₂ by thresholding can be quite poor, hence, resulting in unreliable parametric error estimates. One can extrapolate these results to multiple signals, with the expectation that the regions included in each parameter's signature will become smaller as the other signals' wavelet coefficients will overlap its wavelet coefficients. In contrast to the signals in FIGS. 5A-5C, examine the two uncorrelated signals ζ₃ and ζ₄ with the correlation coefficient of 0.0772 in FIGS. 6A-6C, associated with the parameters θ₃ and θ₄. While one can observe that the trend of positive and negative values exists for |W{ζ₃}|/max|W{ζ₃}|−|W{ζ₄}|/max|W{ζ₄}| as well, one can also note that the difference margins between the wavelet coefficients are now much larger. This makes it possible to isolate regions where W{ε₃}(tₖ,sₗ)>>W{ε₄}(tₖ,sₗ) as well as those where W{ε₄}(tₖ,sₗ)>>W{εⱼ}(tₖ,sₗ), hence providing a much more accurate approximation of the signatures.

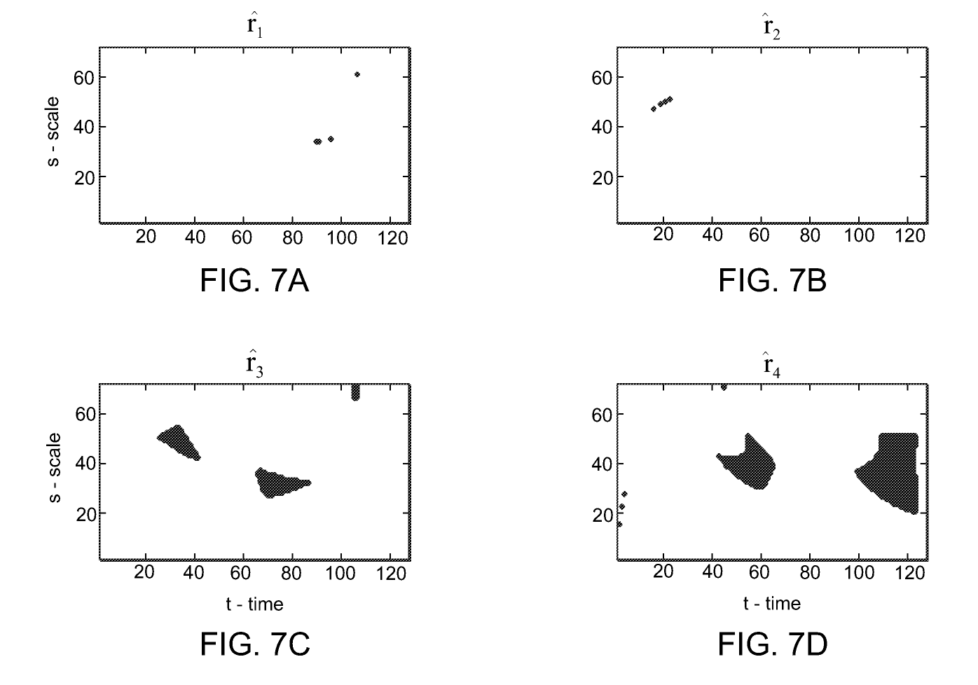

To illustrate the influence of correlation between the parameter effects on the quality of approximated signatures, the estimated signatures of the four parameters θ₁ to θ₄ with the Gauss wavelet transform of the signals ζ₁ to ζ₄ using a threshold level of η=0.1 are shown in FIGS. 7A-7D. The signatures \hat{Γ}₁ and \hat{Γ}₂ are clearly more sparse than \hat{Γ}₃ and \hat{Γ}₄, reflecting the difficulty of signature extraction for closely correlated ζ₁ and ζ₂.

In image processing, it is generally known that the ‘edges’ represent the most distinguishable aspect of images and are used extensively for data condensation. Furthermore, edges of the WT represent the local time-signal irregularities which characterize the transient features of dynamic systems and distinguish them from each other.

Edges are detected in the time-scale domain by the modulus maxima of the WT which are good indicators of decay of the WT amplitude across scales. Following the definition by Mallat, a modulus maximum at any point of the time-scale plane (t₀, s₀) is a local maximum of |W{f(t,s₀)}| at t=t₀. This implies that at a modulus maximum:

$$\frac{\partial W \{ f ( {t}_{0} , {s}_{0} ) \}}{\partial t} = 0$$

and the maxima lines are the connected curves s(t) in the time-scale plane (t,s) along which all points are modulus maxima.

There is support indicating that the WT modulus maxima captures the content of the (at least 80% or 90%) image, and that signals can be substantially reconstructed based on the WT modulus maxima. In fact, Mallat and Zhong report that “according to numerical experiments, one can obtain signal approximations with a relative mean-square error of the order of 10⁻² and that is because fast numerical computation of modulus maxima is limited to dyadic scales {2^{j}}j∈z which seems to be the limiting factor in the reconstruction of the signal.” But a good indication of the effectiveness of WT modulus maxima in capturing the main aspects of an image is that signals with the same WT modulus maxima differ from each other by small variations in the data. Although Meyer has shown that the WT modulus maxima do not provide a complete signal representation, the functions that were characterized by the same WT modulus maxima, to disprove true representation, only differed at high frequencies, with their relative L²(R) distance being of the same order as the precision of the dyadic reconstruction algorithm.

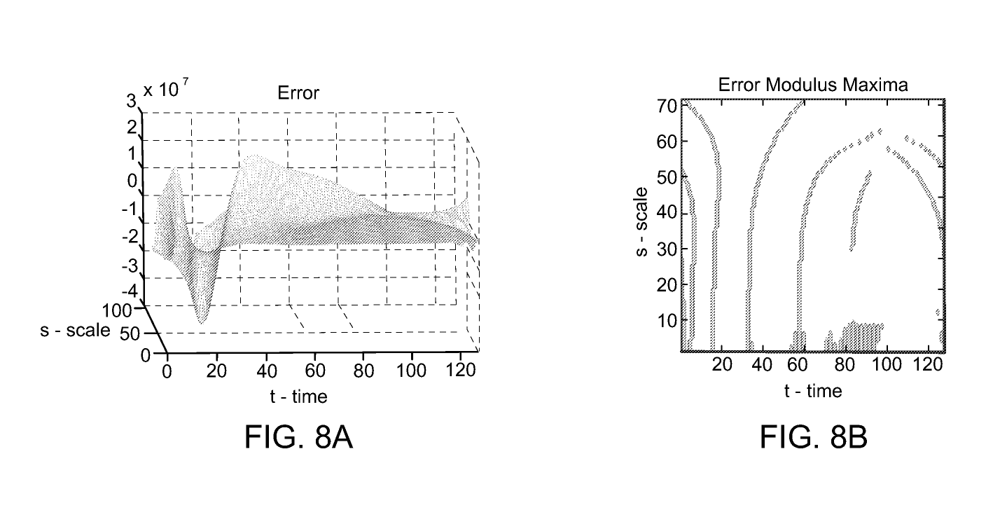

Given that the WT modulus maxima successfully represent the signal's image in the time-scale domain and can be effectively used for signal reconstruction, the question arises as to whether they represent the data content of the time signal as well. As a test, use the modulus maxima of the WT of the error to estimate the parameters of the mass-spring-damper model of Eq. 12. Shown in FIGS. 8A-8B are the Gauss WT of the error (8A) and the contours of its WT modulus maxima (8B). Specifically, the least-squares estimates of the parameters were obtained as:

\hat{Θ}= Θ̅+(Φ^{T}Φ)⁻¹Φ^{T}ζ (33)

which for time-based estimation:

ζ=∈(t), Φ=[ε₁(t),ε₂(t),ε₃(t)] (34)

and for estimation according to the WT modulus maxima:

ζ=MM{W{∈(t)}}⊙W{∈(t)}, Φ=[MM{W{∈(t)}}⊙W{εᵢ(t)}] i=1,2,3 (35)

where MM denotes modulus maxima and ⊙ represents pixel to pixel multiplication. It should be noted that the WT modulus maxima MM{W} is a binary matrix of ones and zeros, having the value of one at the pixels where the maxima occur and 0 elsewhere. Therefore, to only consider the wavelet coefficients at the edges of the WT of the error (hereafter referred to as error edges), ζ(t,s) is obtained from pixel to pixel multiplication of the binary WT modulus maxima of the error by the corresponding wavelet coefficients of the error. The logic here is that if indeed the error edges adequately characterize the signal's image in the time-scale domain, then they ought to represent the data content of the time signal as well. To be consistent with Eq. 23, matrix Φ in Eq. 35 is defined to comprise the WT of the parameter effects at the same pixels as ζ(t,s).

The least-squares estimates of m, c, and k according to the time data, the entire time-scale data, and the wavelet coefficients at the error edges are shown in Table 2. The results indicate that the estimates obtained from the error edges are even slightly more precise than those obtained from the time or the entire time-scale data. This validates the belief that the local time-signal irregularities used by the experts contain important features of the error signal. It also gives credence to seeking parameter signatures at the edges of the prediction error as the means to characterize signal irregularities in the time-scale domain.

TABLE 2
Least-squares parameter estimates of the linear mass-
spring-damper model with Θ* = [375, 9800, 130 × 10³]^{T}.

| | Parameter Estimates | | | Precision Error (10⁻⁵) |
|---|---|---|---|---|
| Data Base | \hat{m} | ĉ | \hat{k} | Σᵢ₌₁³((θᵢ* − \hat{θ}ᵢ)/θᵢ*)² |
| Time Data | 377 | 9784 | 130 × 10³ | 4.23 |
| (ε(t)) | | | | |
| Time-Frequency | 377 | 9787 | 130 × 10³ | 2.80 |
| Data (W{ε(t)}) | | | | |
| WT Modulus | 375 | 9765 | 130 × 10³ | 1.66 |
| Maxima | | | | |
| (M{W{ε(t)}}) | | | | |

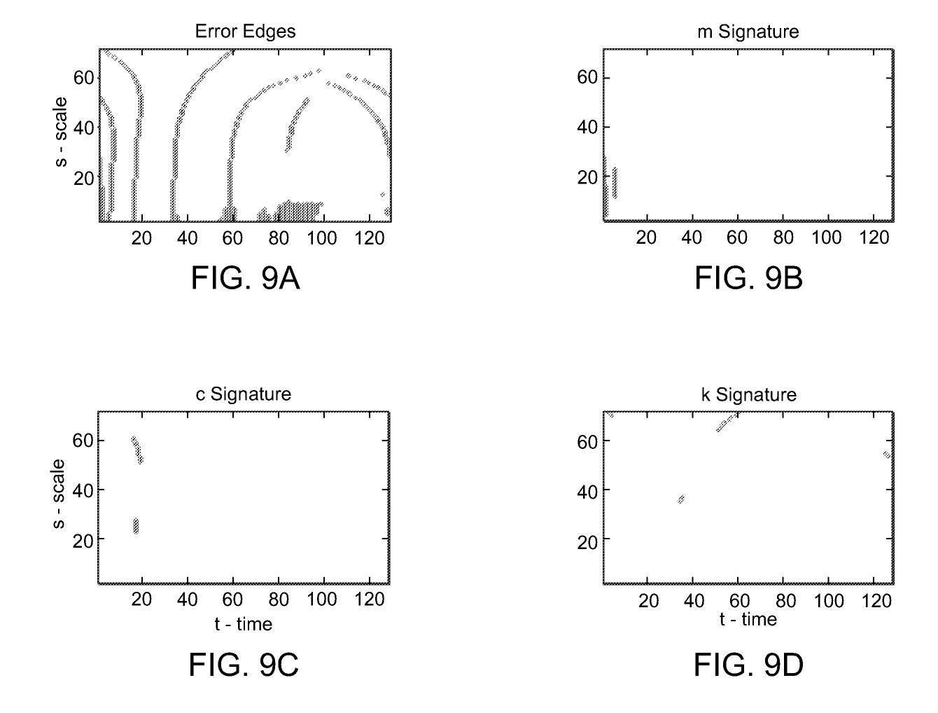

Having been convinced of the fidelity of data content at the error edges, the parameter signatures of the mass-spring-damper model can be re-extracted to only include the pixels at the error edges. The contour plot of the error edges of the mass-spring-damper model in Eq. 12 using the Gauss wavelet are shown in FIGS. 9A-9D along with the edge signatures of m, c, and k. Using these signatures, the average estimate of parametric errors are:

Δ̅Θ̅=[ Δ̅m̅, Δ̅c̅, Δ̅k̅]^{T}=[30,−897,6645]^{T} vs ΔΘ=[Δm, Δc, Δk]^{T}=[35,−700,5000]^{T}

which are in general agreement.

The parametric error estimates are not exact for several reasons:
1. The extracted parameter signatures \hat{Γ}ᵢ are only approximations to the ideal signatures Γᵢ, thus ignore the effects of other parameters at individual pixels.
2. The parameters are estimated by relying solely on the first-order Taylor series approximation of the prediction error and ignoring measurement noise.
3. The parameter signatures depend on the nominal parameter vector Θ̅.

As such, adaptation of parameters based on the parametric error estimates needs to be conducted iteratively, so as to incrementally reduce the error in Θ̅.

Following the general form of adaptation in Newton methods, parameter adaptation in PARSIM takes the form:

\hat{θ}ᵢ(k+1)=\hat{θ}ᵢ(k)+\hat{Δ}\hat{θ}ᵢ(k) (36)

where \hat{Δ}\hat{θ}ᵢ is estimated and μ is the iteration step to account for the inaccuracy of parametric error estimates. The logic of PARSIM's adaptation can best be understood in comparison to the Newton-Raphson method applied to a single parameter model having the form:

$${\hat{θ}}_{i} ( k + 1 ) = {\hat{θ}}_{i} ( k ) + μ \frac{ɛ ( {t}_{k} )}{\frac{\partial \hat{y} ( {t}_{k} )}{\partial {θ}_{i}}} \qquad ( 37 )$$

By comparing the two adaptation algorithms, one can observe that PARSIM is the implementation of the Newton-Raphson method in the time-scale domain. In the Newton-Raphson method, the parametric error estimate ∈(tₖ)/(∂ŷ(tₖ)/∂θᵢ) is the ratio of the error to the output's derivative with respect to the parameter. In PARSIM, Δ\hat{θ}ᵢ is the mean of the WT of this same ratio at the pixels included in each parameter's signature.

Consider now the evaluation of PARSIM's performance in adaptation. As a benchmark, PARSIM's performance is compared with that of the Gauss-Newton method which is a mainstream yet effective regression method. The Gauss-Newton method used in this study has the form:

\hat{Θ}(k+1)=\hat{Θ}(k)+μ\hat{Δ}\hat{Θ}(k) (38)

where \hat{Δ}\hat{Θ} is obtained with ζ and Φ defined as in Walter et al, “on the Identifiability of Nonlinear Parametric Models” Mathematics and Computers in simulation, Vol. 42, pp. 125-134 (1996), the entire contents of which is incorporated herein by reference.

As a measurement of PARSIM's performance, it was applied to the adaptation of the mass-spring-damper model parameters. Adaptation was performed with one hundred random initial parameter values within 25% of Θ*. A step size of μ=0.25 was used for both PARSIM and the Gauss-Newton method with a threshold level of η=0.20. The mean values of the parameter estimates after 25 iterations of PARSIM and the Gauss-Newton method are listed in Table 3. Along with the estimates are the mean values of the precision error ε_{Θ} computed as:

$${∈}_{Θ} = {\sum }_{i = 1}^{3} {( ( {θ}_{i}^{*} - {\hat{θ}}_{i} ) / {θ}_{i}^{*} )}^{2} \qquad ( 39 )$$

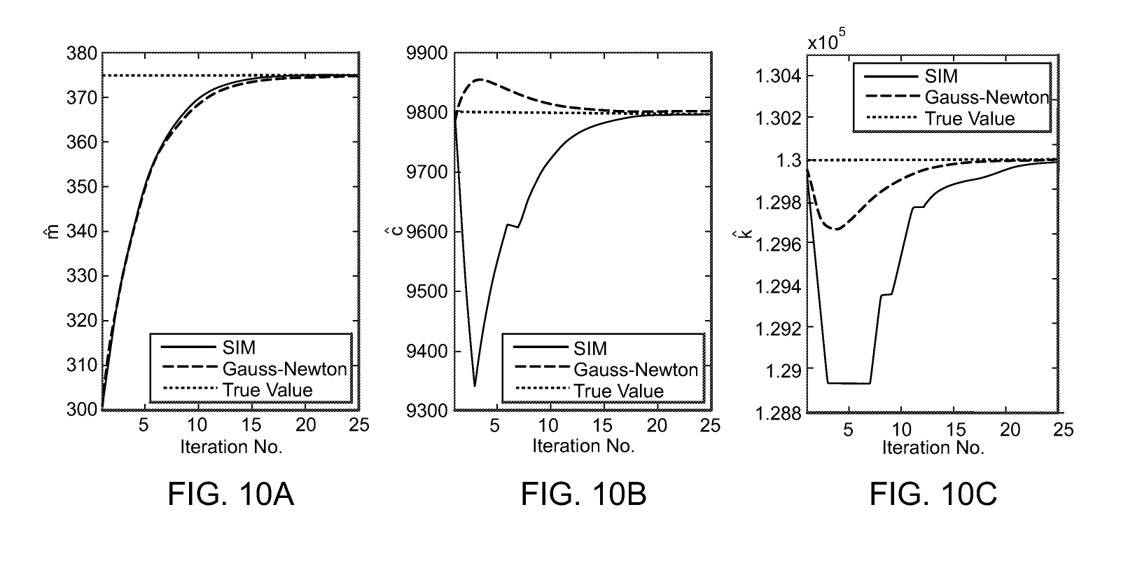

They indicate that PARSIM provides nearly as precise an adaptation as the Gauss-Newton method. Note that PARSIM does not necessarily adjust only the erroneous parameters during adaptation. The reason is the dependence of the parameter signatures on the nominal parameter vector Θ̅. To illustrate this point, consider adapting the parameters of the mass-spring-damper model when only one of the parameters is erroneous, as in Θ̅=[300,9800,130×10³] that corresponds to ΔΘ=[75,0,0]. The parametric error estimates using the Gauss WT and a threshold value of η=0.2 are \hat{Δ}\hat{Θ}=[64,−1194,−2311], which provide a close estimation of only the first parametric error. Note that the estimated parametric error above results in a reduced precision error of 0.0257 from its initial value of 0.04. The adapted parameters from this adaptation run of PARSIM are shown in FIGS. 10A-10C, which indicate that the disturbed parameters c and k from their correct values converge to their true values in the subsequent adaptation iterations of PARSIM. Along with PARSIM's estimates in FIGS. 10A-10C are those by the Gauss-Newton method which exhibit a similar trend, albeit less drastic.

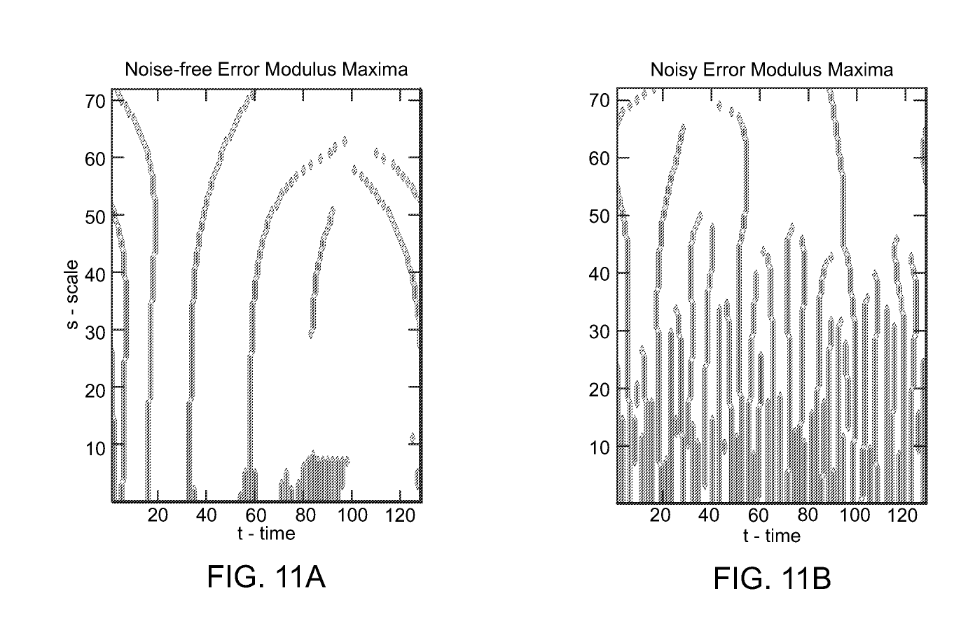

The comparable adaptation results of PARSIM to the Gauss-Newton method confirm the basic validity of its parametric error minimization strategy by PARSIM. To further evaluate its efficacy, PARSIM is next applied to noisy outputs with the objective of taking advantage of the transparency afforded by the parameter signatures. For this, one can explore the vast body of noise-rejection and compensation techniques available in the time-frequency domain to develop an elaborate solution for PARSIM. Here we suffice to a simple approach of identifying and separating the regions affected by noise, to only illustrate the basic advantage of access to the time-scale plane. For illustration purposes, noise was added to the output of the mass-spring-damper model. The error edges of the noise-free case, compared with those of the new error in FIGS. 11A and 11B, indicate significant distortion in the error edges due to noise, as well as many more edges at the finer scales of the time-scale plane. This suggests that by removing the noise-related pixels from those included in the parameter signatures one may be able to improve the adaptation results, although it can be difficult to completely account for the distortion of the error wavelet coefficients in every region.

TABLE 3
Twenty fifth-iteration mean of the adapted mass-spring-damper
model parameters from one hundred adaptation runs of PARSIM and
the Gauss-Newton method. Random initial parameter values were
used for each adaptation run within 25% of the true values.

| True | Parameter Estimates | |
|---|---|---|
| Parameter | PARSIM | Gauss-Newton |

| Value | Mean | St. Dev. | Mean | St. Dev. |
|---|---|---|---|---|
| m = 375 | 375 | 0.1013 | 375 | 0.0205 |
| c = 9800 | 9800 | 1.3410 | 9800 | 0.5000 |
| k = 130 × 10³ | 130 × 10³ | 11.9476 | 130 × 10³ | 6.6988 |

| | | |
|---|---|---|
| Precision | 9.9748 × 10⁻⁸ | 8.2655 × 10⁻⁹ |
| Error | | |

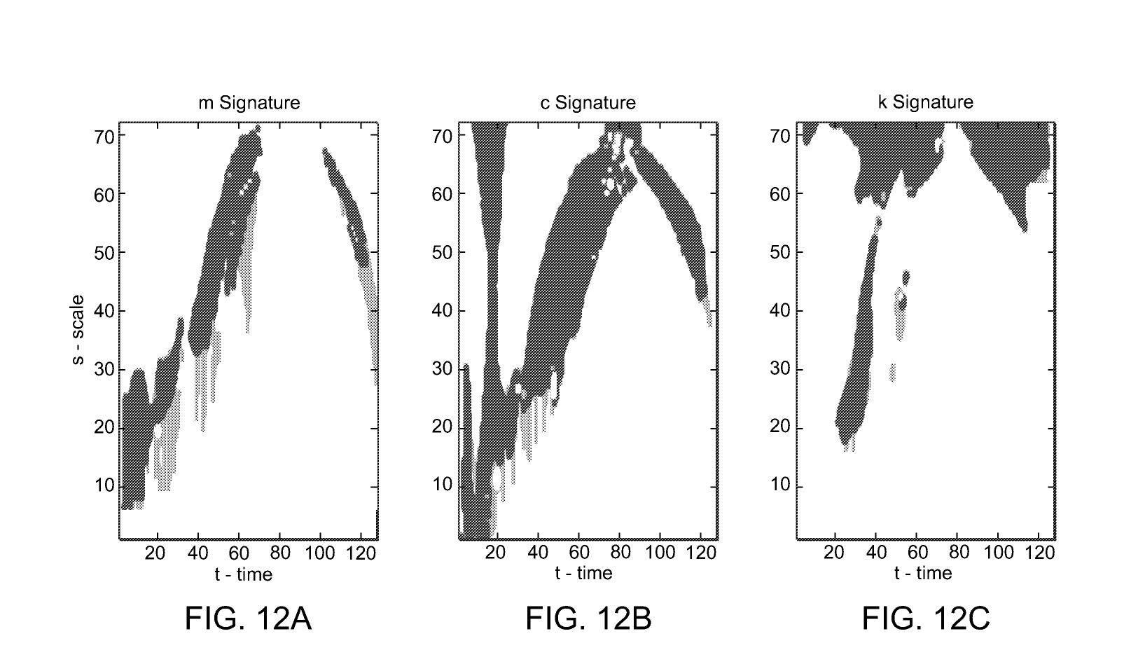

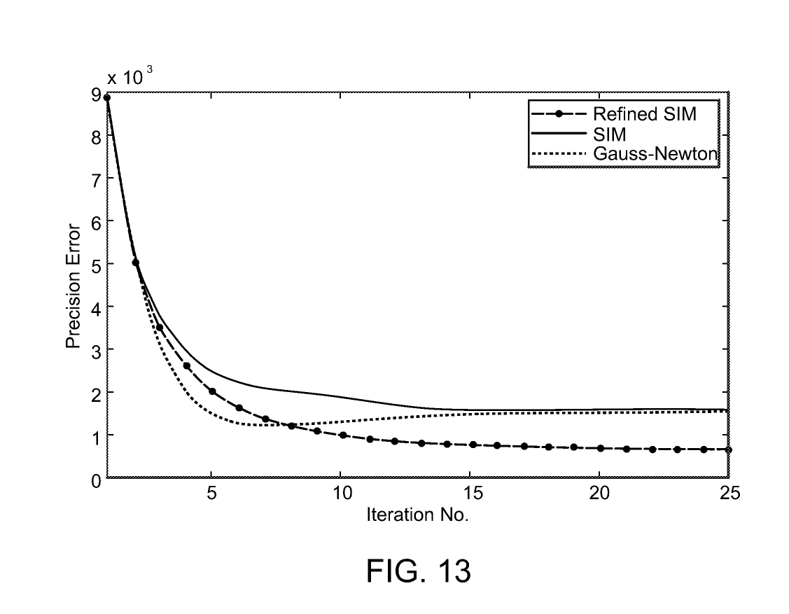

To evaluate the exclusion method described above, the regions of the time-scale plane included in 5000 parameter signature samples of the mass-spring-damper model at random nominal parameter values Θ̅, within 25% of Θ*, were used as reference. These regions are shown in FIGS. 12A, 12B, and 12C together with their counterparts obtained with the noise-contaminated output. The results show specific regions of the time-scale plane affected purely by noise, which can be excluded from the parameter signatures when estimating the parametric errors during parameter adaptation. The mean and standard deviation of the adapted parameters from one hundred adaptation trials of PARSIM, obtained with and without the noise-related regions, and by the Gauss-Newton method, are shown in Table 3 along with the mean of the precision errors by the two methods. The results indicate that by excluding the noise-affected regions from the parameter signatures, the precision of the adapted parameters improves. But a more telling aspect of the adaptation results is evident from the magnitude of the precision error shown in FIG. 13 for both PARSIM and the Gauss-Newton method. According to this figure, the precision error by the Gauss-Newton method does reach lower levels in the midst of adaptation, but it is passed up in favor of a lower prediction error which is the objective of adaptation by the Gauss-Newton method. PARSIM, on the other hand, focuses on individual parametric error corrections, so it continually reduces the precision error during adaptation as indicated by the corresponding precision error in FIG. 13.

TABLE 4
Twenty fifth-iteration mean and standard deviation values of the adapted
mass-spring-damper model parameters obtained with the noise-contaminated
regions (denoted as PARSIM) and without them (denoted as Refined PARSIM).
One hundred adaptation runs were performed with random initial parameter
values within 25% of the true values. For comparison, also included are the
results of the Gauss-Newton method for the same initial parameter values.

| | Parameter Estimates | | | | | |
|---|---|---|---|---|---|---|
| True | PARSIM | | Refined PARSIM | | Gauss-Newton | |
| Parameter | | St. | | St. | | St. |
| Value | Mean | Dev. | Mean | Dev. | Mean | Dev. |
| m = 375 | 386.67 | 5.77 | 377.41 | 5.91 | 388.54 | 0.02 |
| c = 9800 | 9618.9 | 47.35 | 9622.0 | 36.07 | 9795.4 | 0.53 |
| k = 130 × 10³ | 130.48 × 10⁻³ | 414.84 | 129.67 × 10⁻³ | 438.71 | 131.87 × 10⁻³ | 7.13 |

| | | | |
|---|---|---|---|
| Precision | 0.0016 | 6.4846 × 10⁻⁴ | 0.0015 |
| Error | | | |

Another potential advantage of PARSIM is in adaptation of poorly excited models. A common requirement in system identification is the richness (persistent excitation) of inputs. Persistent excitation (pe), which is necessary for exciting the modes of the system, ensures the availability of adequate equations for the unknowns (parameters) in regression-based estimation. But the results in Table 3 by both PARSIM and the Gauss-Newton method indicate that effective adaptation can be achieved with a non-pe input such as an impulse. The explanation to this seemingly counter-intuitive point is provided by Söderström and Stoica as: “The condition of persistent excitation (pe) is important only in noisy systems. For noise-free systems, it is not necessary that the input be pe. Consider for example, an nth order linear system initially at rest. Assume that an impulse is applied, and the impulse response is recorded. From the first 2n (nonzero) values of the signal it is possible to find the system parameters. The reason is that noise-free systems can be identified from a finite number of data points (N<∞) whereas pe concerns the input properties for N→∞ (which are relevant to the analysis of the consistency of the parameter estimates in noisy systems). For systems with a large signal-to-noise ratio, an input step can give valuable information about the dynamics. Rise time, overshoot and static gain are directly related to the step response. Also, the major time constants and a possible resonance can be at least crudely estimated from a step response.”

To measure the performance of PARSIM in the absence of persistent excitation, the free responses of two (linear and nonlinear) mass-spring-damper models were simulated to an initial displacement of x(0)=0.2. The linear model is that in Leontartitis et al., “Input-Output Parametric Models for Non-linear Systems,” Int. J. of control, Vol. 41, No. 2, pp. 303-344 (1985), the entire contents of which is incorporated herein by reference, the nonlinear model has the form:

m\ddot{x}(t)+c|\dot{x}(t)|\dot{x}(t)+kx³(t)=0 (40)

where m is the system's lumped mass, c its damping coefficient kits spring constant, having the same parameter values as the linear model. The mean and standard deviation of the adapted parameters from one hundred adaptation runs of PARSIM and the Gauss-Newton method using random initial parameter values, within 25% of the actual parameter vector Θ*, are shown in Table 5. The results indicate that the adapted parameters by PARSIM are considerably more accurate than those by the Gauss-Newton method, having smaller standard deviations as well. These results indicate the more robust nature of the parametric error minimization strategy use by PARSIM.

TABLE 5
Twentieth-iteration mean and standard deviation values of adapted linear and nonlinear mass-spring-damper
models parameters obtained with poor excitation. One hundred adaptation runs were performed by both
PARSIM and the Gauss-Newton method with random initial parameter values within of the true values.

| | Parameter Estimates | | | | | | | |
|---|---|---|---|---|---|---|---|---|
| | Linear mass-spring-damper | | | | Nonlinear mass-spring-damper | | | |
| True | PARSIM | | Gauss-Newton | | PARSIM | | Gauss-Newton | |
| Parameter | | St. | | St. | | St. | | St. |
| Values | Mean | Dev. | Mean | Dev. | Mean | Dev. | Mean | Dev. |
| m = 375 | 374 | 13 | 394 | 45 | 374 | 13 | 437 | 80 |
| c = 9800 | 9776 | 339 | 10300 | 1188 | 9776 | 336 | 1142 | 2084 |
| k = 130 × 10³ | 130 × 10³ | 4496 | 137 × 10³ | 15757 | 130 × 10³ | 4451 | 151 × 10³ | 2764 |
| Precision | 0.0036 | 0.0044 | 0.0514 | 0.1047 | 0.0035 | 0.0043 | 0.2162 | 0.6796 |
| Error | | | | | | | | |

The performance of PARSIM is next evaluated in application to two nonlinear models. The first model is a nonlinear two compartment model of drug kinetics in the human body, which is shown to have near nonidentifiable parameters. The second model is the Van der Pol oscillator, which in addition to being structurally nonidentifiable, due to numerous local minima, exhibits bifurcation characteristics 40 and has been a benchmark of adaptation.

The drug kinetics model has the form:

$${\dot{x}}_{1} ( t ) = - ( {k}_{21} + \frac{{V}_{M}}{{K}_{m} + {x}_{1} ( t )} ) {x}_{1} ( t ) + {k}_{12} {x}_{2} ( t ) + {b}_{1} u ( t ) \\ {\dot{x}}_{2} ( t ) = {k}_{21} {x}_{1} ( t ) - ( {k}_{02} + {k}_{12} ) {x}_{2} ( t ) \\ y ( t ) = {c}_{1} {x}_{1} ( t ) \qquad ( 41 )$$

which represents the drug injected into the blood (compartment 1) as it exchanges linearly with the tissues (compartment 2). The drug is irreversibly removed with a nonlinear saturation characteristic (Michaelis-Menten dynamics) from compartment 1 and linearly from compartment 2. The experiment takes place in compartment 1. The state variables x₁ and x₂ represent drug masses in the two compartments, u(t) denotes the drug input, y(t) is the measured drug, k₁₂, k₂₁, and k₀₂ denote constant parameters, V_{M} and Kₘ are classical Michaelis-Menten parameters, and b₁ and c₁ are input and output parameters. For simulation purposes, the parameter values were obtained from Carson et al. 37 to represent galactose intake per kg body weight (kg B W), as:

Θ*=[k₂₁*,k₁₂*,V_{M}*,Kₘ*,k₀₂*,c₁*,b₁*]=[3.033,2.4,378,2.88,1.5,1.0,1.0] (42)

Using the nominal parameters:

Θ̅=[ k̅₂₁, k̅₁₂, V̅_{M}, K̅ₘ, k̅₀₂, c̅₁, b̅₁]=[2.8,2.6,378,2.88,1.6,1.0,1.0] (43)

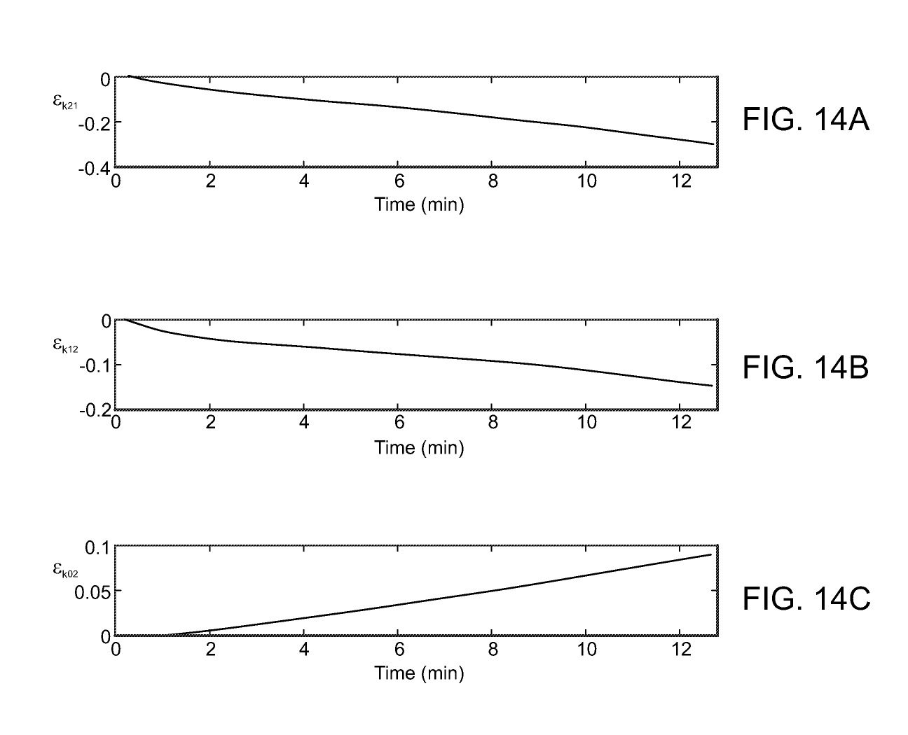

the system response to a single dose of drug x₁(0)=0.2 mg/100 ml kg B W, x₂(0)=0 was simulated. The parameter effects of k₂₁, k₁₂, and k₀₂ obtained from simulation are shown in FIGS. 14A-14C with the correlation coefficient values:

ρk₂₁k₁₂=0.9946 ρk₂₁k₀₂=−0.9985 ρk₁₂k₀₂=−0.9888 (44)

As observed from these results, the correlation coefficients between the three parameter effect pairs are very close to 1, indicating near mutual nonidentifiability of the three parameters, even though the structural identifiability of the parameters has been verified by Audoly et al., “Global Identifiability of Nonlinear Models of Biological Systems,” IEEE Trans on Biomedical Eng., Vol. 48, No. 1 pp. 55-65 (2001), the entire contents of which is incorporated herein by reference. According to these results, it can be very difficult to extract reliable signatures for these parameters. To verify this point, the signatures of the three parameters k₂₁, k₁₂, and k₀₂ were extracted using the Gauss WT. Based on these signatures, the parametric errors were estimated according to \hat{Δ}\hat{Θ}=[\hat{Δ}\hat{k}\hat{Δk₂₁},\hat{Δ}\hat{k}\hat{Δk₁₂},\hat{Δ}\hat{k}\hat{Δk₀₂}]=[0.1942,0,0] which are null for k₁₂ and k₀₂ due to our inability to extract signatures for these two parameters.

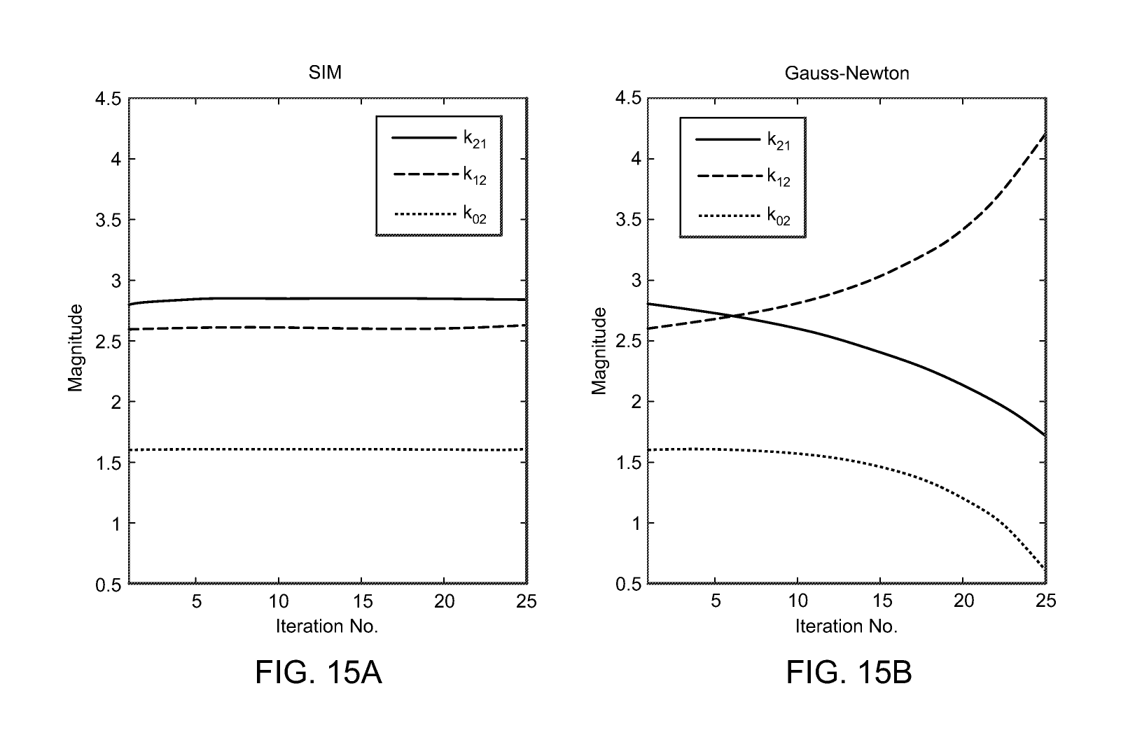

For adaptation purposes, the output ŷ(t,\hat{Θ}) of the drug kinetics model described in Carson et al, “The Mathematical Modeling of Metabolic and Endocrine Systems,” John Wiley and Sons (1983), the contents of which is incorporated herein by reference, was simulated. Both PARSIM and the Gauss-Newton method were used to adapt the parameters k₂₁, k₁₂, and k₀₂, which deviated from their true values. The adapted parameters, shown in FIGS. 15A and 15B, indicate that the near nonidentifiability of the parameters of this model makes adaptation impossible by either method. However, the results reveal another inherent characteristic of the two methods. In PARSIM's case, the near nonidentifiability of the parameters impedes signature extraction for two of the parameters, so these parameters remain unchanged at their initial values. In the Guass-Newton method's case, on the other hand, all three parameters are adapted to minimize the error, but due to near nonidentifiability, adaptation is completely ineffective and the adapted parameters never approach their true values.

The Van der Pol oscillator has the form:

$$m \frac{{d}^{2} x}{d {t}^{2}} - c ( 1 - {x}^{2} ) \frac{d x}{d t} + kx = 0 \qquad ( 45 )$$

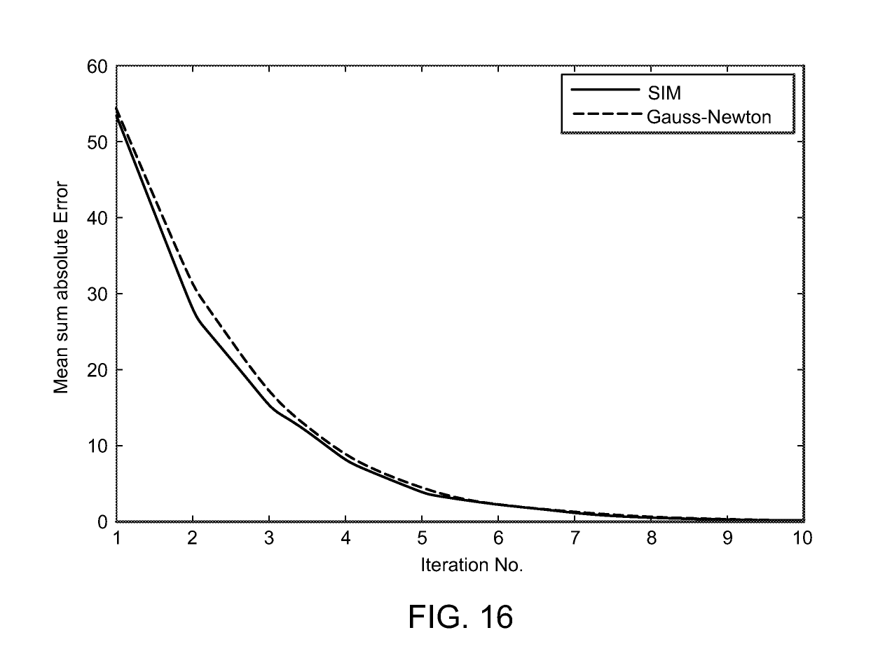

with its true parameters defined as Θ*=[m*,c*,k*]=[375,9800,130×10³]^{T}. The Van der Pol oscillator was simulated with the initial conditions x(0)=0.02, and as with the mass-spring-damper model, the adaptation convergence of PARSIM was tested with one hundred different initial parameter values within 10% of Θ*. Both PARSIM and the Guass-Newton method were applied to this model with a step size of μ=0.50. The threshold value for PARSIM was η=0.20. The mean value of the adapted parameters and their standard deviations at the twenty-fifth iteration of the two methods are listed in Table 6. As observed from the results, the two methods are similar in that they do not consistently converge to the global minimum. The results, however, indicate that PARSIM provides a more accurate estimate of this model's parameters, in part due to its more frequent convergence to the global minimum among the adaptation runs. Also shown for this model in FIG. 16, are plots of the mean prediction errors during the one hundred adaptation runs of the two methods. They indicate that PARSIM has a similar performance to the Gauss-Newton method in error minimization even though its focus is solely on parametric error reduction.

The results presented so far highlight important features of PARSIM and its potential advantages. All of these results, however, have been obtained with a threshold value of η=0.2 and the Gauss wavelet transform. It is, therefore, of interest to examine the effect of other threshold values and other wavelets on the performance of PARSIM.

A further study of the effect of the threshold level η on the extracted signatures, entails an extensive investigation of this effect on the size of parameter signatures and the regions of the time-scale plane they occupy. It can also involve evaluation of the consistency of parametric error estimates obtained, which can in turn influence the robustness of adaptation. Here, the effect of the threshold level on the quality of adaptation of the mass-spring-damper model parameters is considered. The mean estimates from one hundred adaptation runs of the mass-spring-damper model parameters with noise-contaminated output obtained with three different threshold levels are shown in Table 7. As before, the initial parameter values in each adaptation run were randomly selected within 25% of the true parameter values. The mean estimates indicate the highest precision is associated with a threshold level of η=0.2, although the standard deviation of the estimates seems to decrease with the higher threshold levels. The smaller standard deviations can be attributed to the smaller number of pixels included within each parameter signature due to the elimination of a larger portion of the parameter effects wavelet coefficients. However, these more concentrated parameter signatures do not seem to contribute to more precise estimates, perhaps due to the smaller number of pixels used for averaging the parametric error estimates used previously.

TABLE 6
Twenty fifth-iteration mean and standard deviation values
of the adapted Van der Pol oscillator parameters from
one hundred adaptation runs of PARSIM and the Gauss-Newton
method. Random initial parameter values were used for
each adaptation run within 10% of the true values.

| True | Parameter Estimates | | | |
|---|---|---|---|---|
| Parameter | PARSIM | | Gauss-Newton | |
| Value | Mean | St. Dev. | Mean | St. Dev. |
| m = 375 | 380 | 16.17 | 385 | 17.87 |
| c = 9800 | 9921 | 422.32 | 1006 | 467.11 |
| k = 130 × 10³ | 131.6 × 10³ | 5.605 × 10³ | 133.5 × 10³ | 6.196 × 10³ |

| | | |
|---|---|---|
| Precision | 0.0060 | 0.0089 |
| Error | | |

TABLE 7
Twenty fifth-iteration mean estimates by PARSIM of the mass-spring-damper model
parameters with noisy output and different threshold levels. The estimates were
obtained using one hundred different initial parameter values randomly selected
within 25% of the correct values.

| True | Parameter Estimates | | | | | |
|---|---|---|---|---|---|---|
| Parameter | η = 0.1 | | η = 0.2 | | η = 0.3 | |
| Value | Mean | St. Dev. | Mean | St. Dev. | Mean | St. Dev. |
| m = 375 | 346 | 5.9 | 387 | 5.77 | 394 | 4.46 |
| c = 9800 | 9257 | 39.25 | 9619 | 47.35 | 9695 | 34.39 |
| k = 130 × 10³ | 121.87 × 10³ | 1258 | 130.48 × 10³ | 414.84 | 131.79 × 10³ | 317.82 |

| | | | |
|---|---|---|---|
| Precision | 0.0133 | 0.0016 | 0.0030 |
| Error | | | |

There is considerable literature on the smoothing effect of different wavelet transforms and the edges associated with these transforms. Here, consider an empirical study of the influence of various wavelets on adaptation of the mass-spring-damper model parameters. Mean precision error at the twenty-fifth iteration of one hundred adaptation runs with four different wavelets are shown in Table 8. Results were obtained from signatures across the entire time-scale plane as well as at the edges of the prediction error. The results indicate that the Gauss wavelet, which was used for all our previous results, provides the best precision, although the Morlet and Mexican Hat wavelets are not far behind. Although the Gauss wavelet provides decent results for signatures across the entire time-scale plane, it is less effective than the other wavelets when signatures are obtained at the edges of the error. This is perhaps due to the smaller sets of wavelet transform modulus maxima produced by this wavelet relative to others.

TABLE 8
Mean precision error at the twenty fifth-iteration of one hundred adaptation
runs of the mass-spring-damper model parameters obtained with different
wavelets. Random initial parameter values within 25% of the correct values
were used for each adaptation run.

| | True Parameters | | | |
|---|---|---|---|---|
| | Precision Error | | | |
| | Entire time-scale | | | |
| | Plane | | At the Edges of Error | |
| Wavelet Type | Mean | STD | Mean | STD |
| Gauss | 6.8632 × 10⁻⁶ | 8.5501 × 10⁻⁶ | 0.0036 | 0.0040 |
| Gauss | 5.1174 × 10⁻⁷ | 6.3810 × 10⁻⁷ | 9.9748 × 10⁻⁸ | 1.3413 × 10⁻⁷ |
| Morlet | 5.6952 × 10⁻⁵ | 6.4121 × 10⁻⁵ | 1.7723 × 10⁻⁷ | 2.0145 × 10⁻⁷ |
| Mexican Hat | 1.2093 × 10⁻⁶ | 1.5122 × 10⁻⁶ | 1.3025 × 10⁻⁷ | 1.7723 × 10⁻⁷ |

It is shown that isolated pixels within the time-scale domain can be identified where the dynamic effect of individual parameters on the output is dominant. It is also shown that at these pixels the prediction error approximated solely in terms of individual parameters yields a reliable estimate of the parametric error. This makes possible separate approximation of the prediction error in terms of individual parameters in different regions of the time-scale plane, in lieu of one multi-parameter approximation that is commonly used in regression. The adaptation method implemented according to this parametric error minimization strategy exhibits several advantages over traditional regression-based adaptation.

To further illustrate parameter effects in nonlinear systems and their utility in approximating the prediction error, consider the error in the displacement of a nonlinear mass-spring-damper:

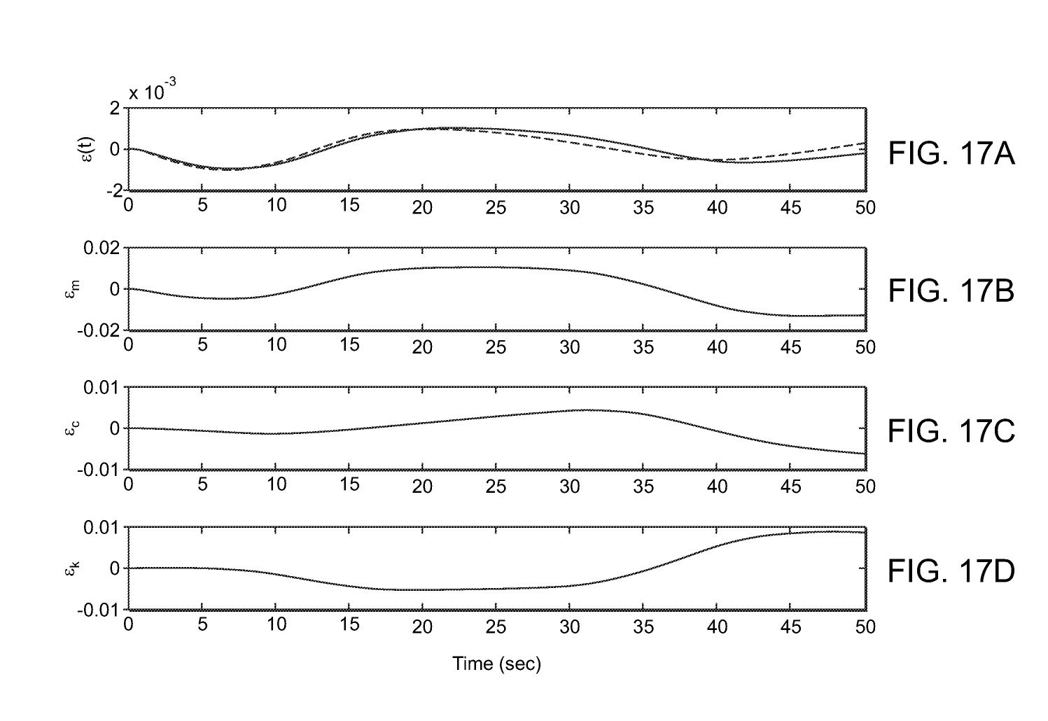

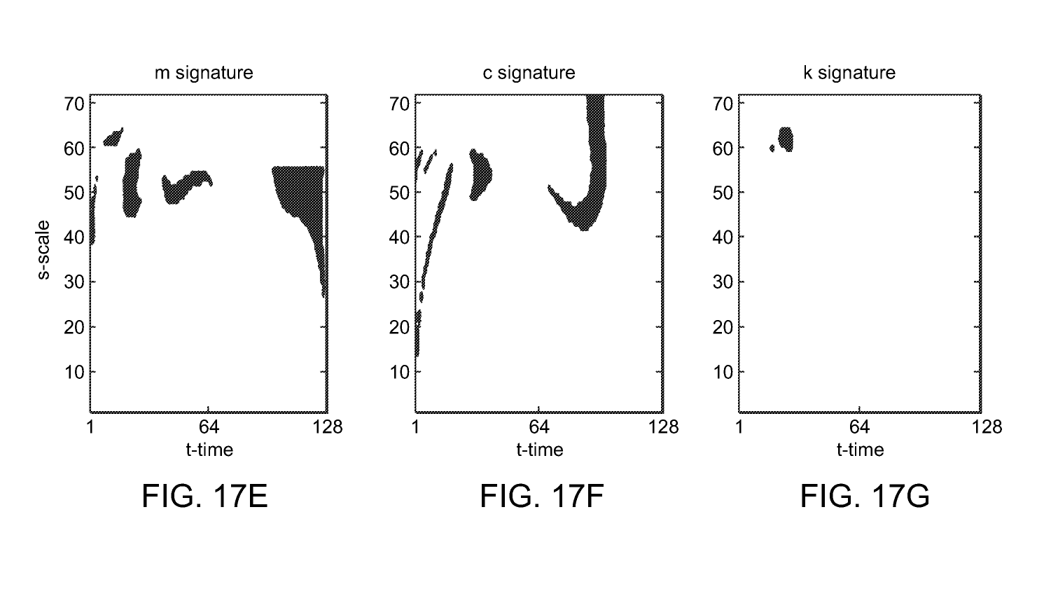

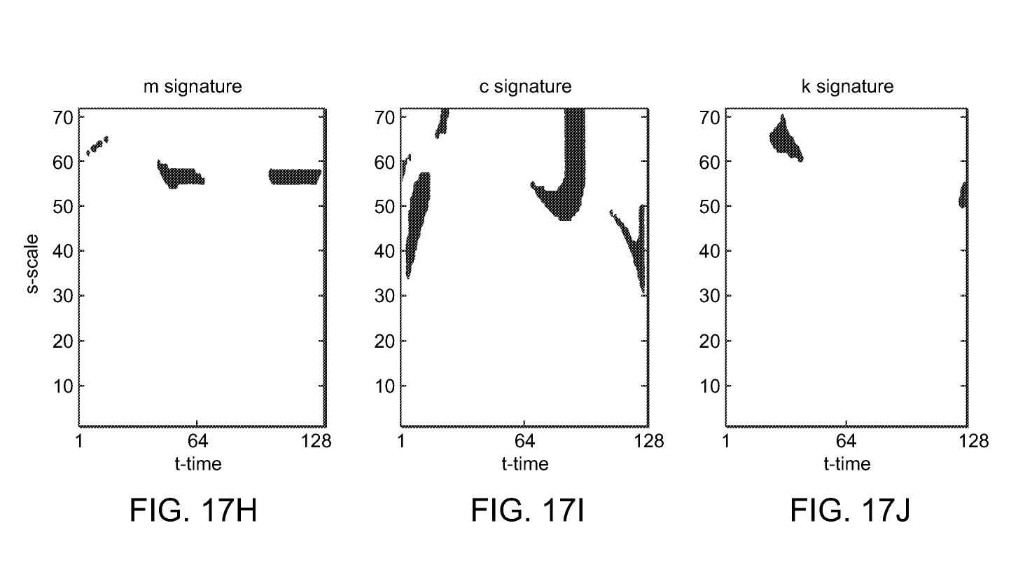

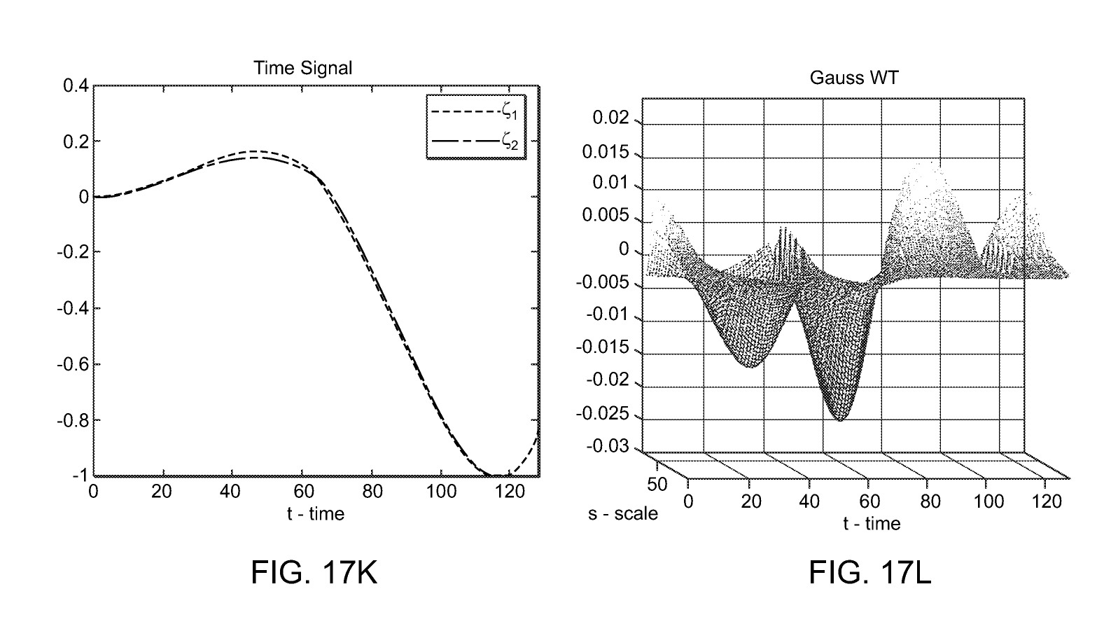

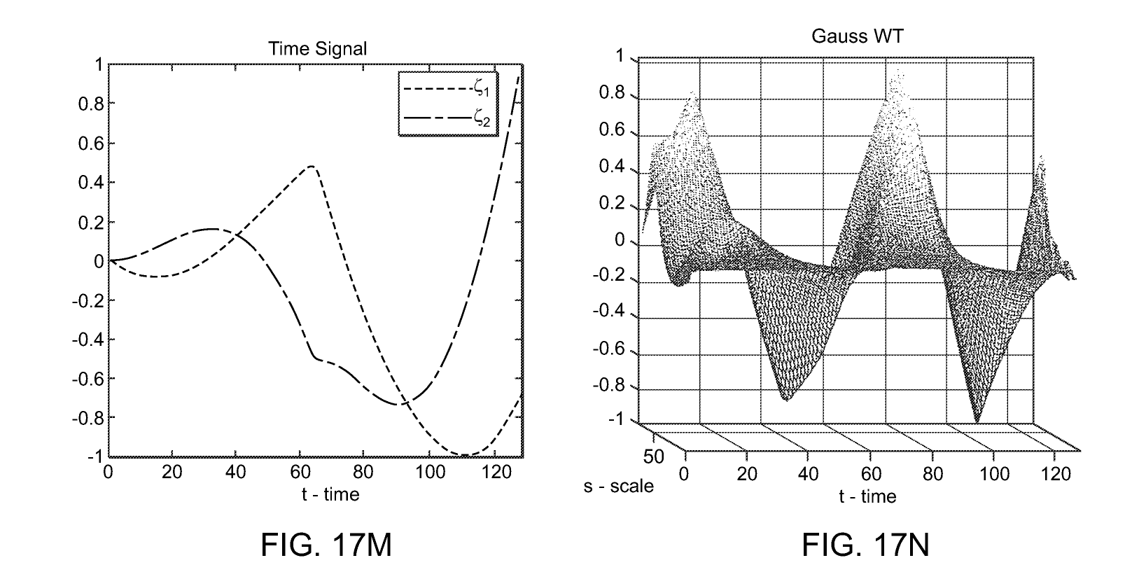

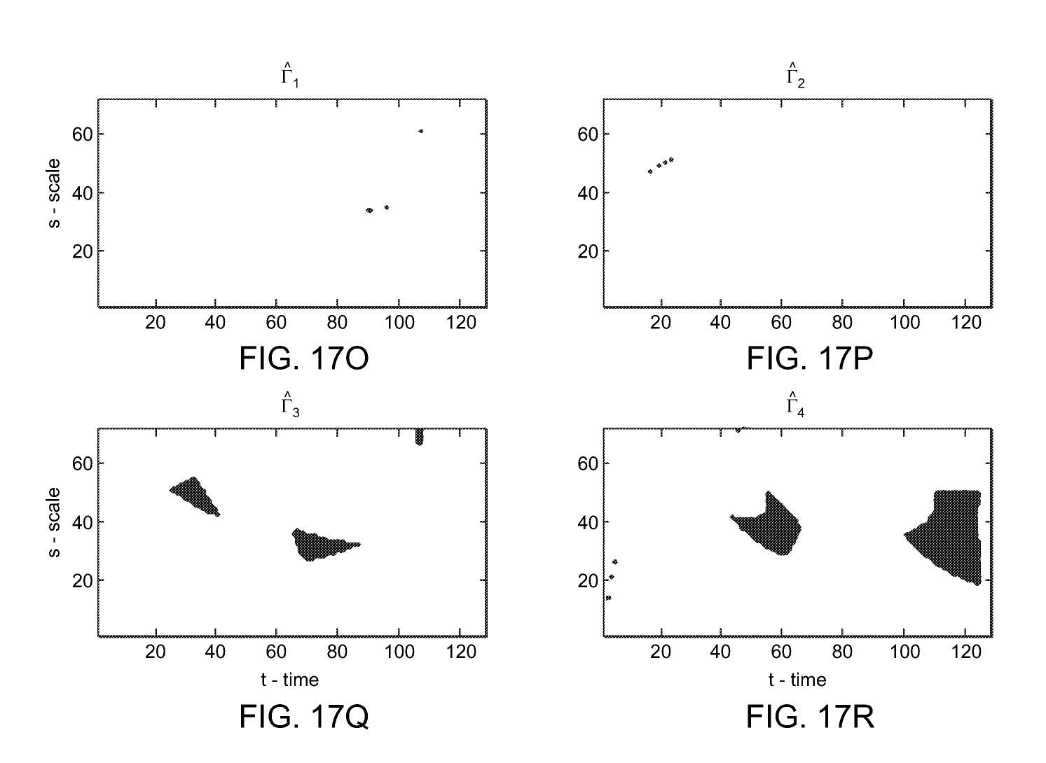

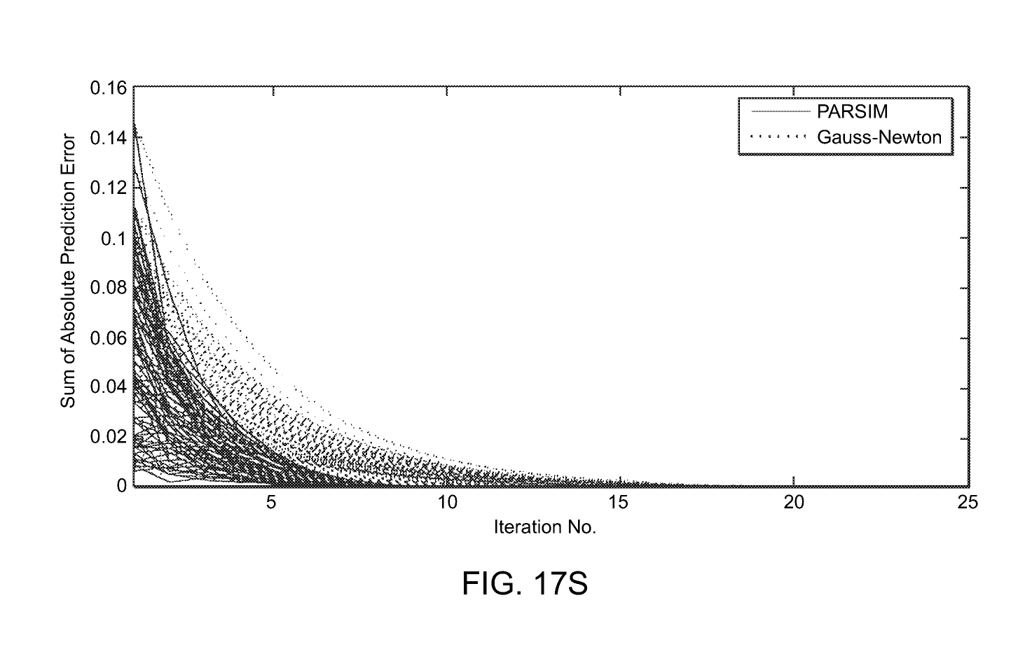

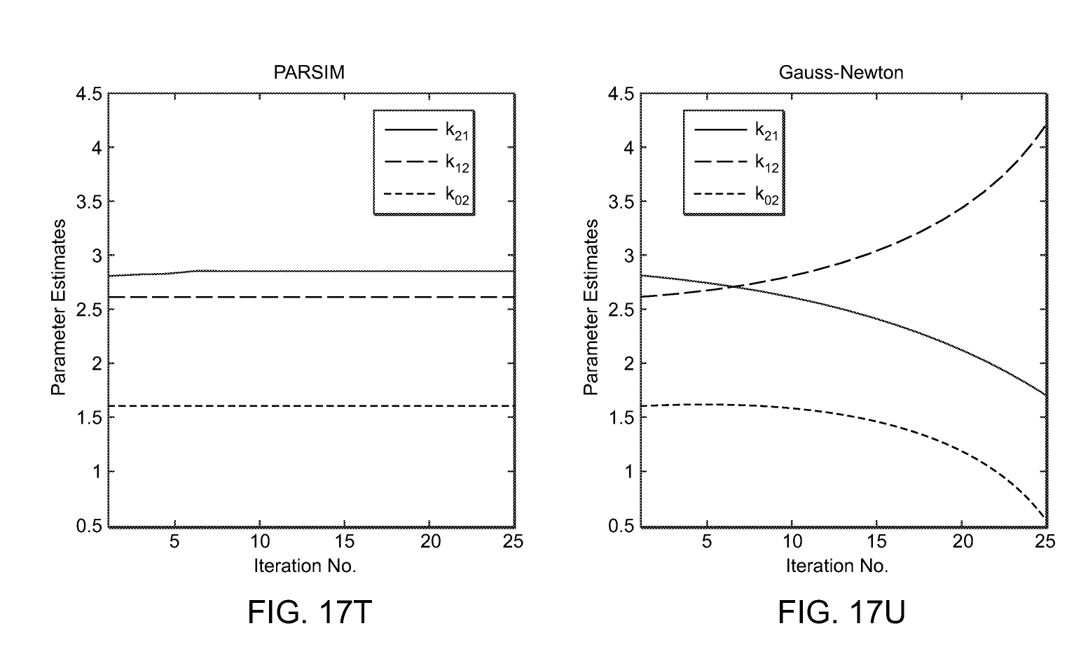

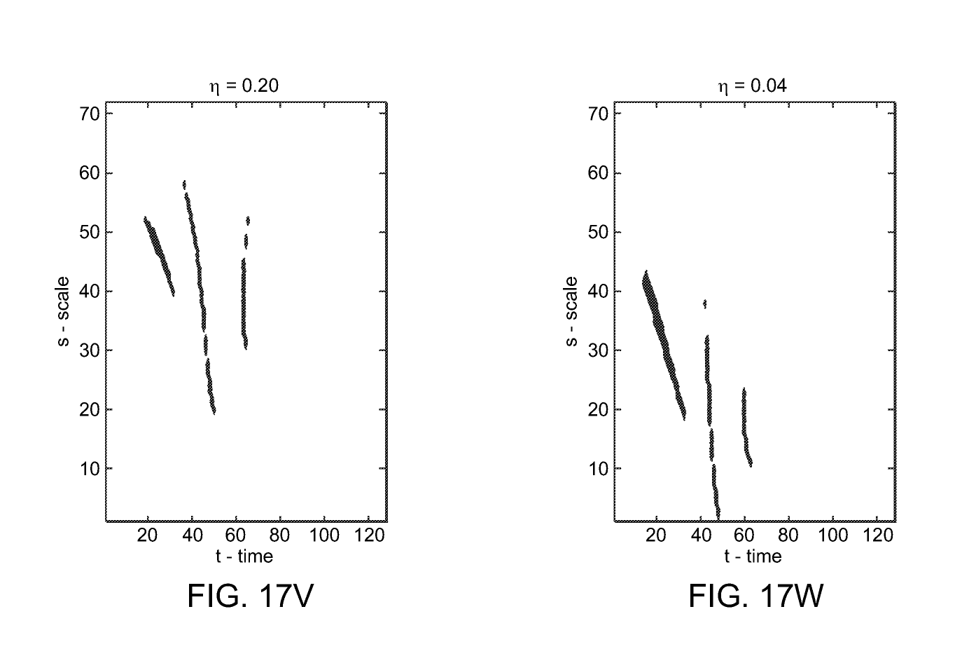

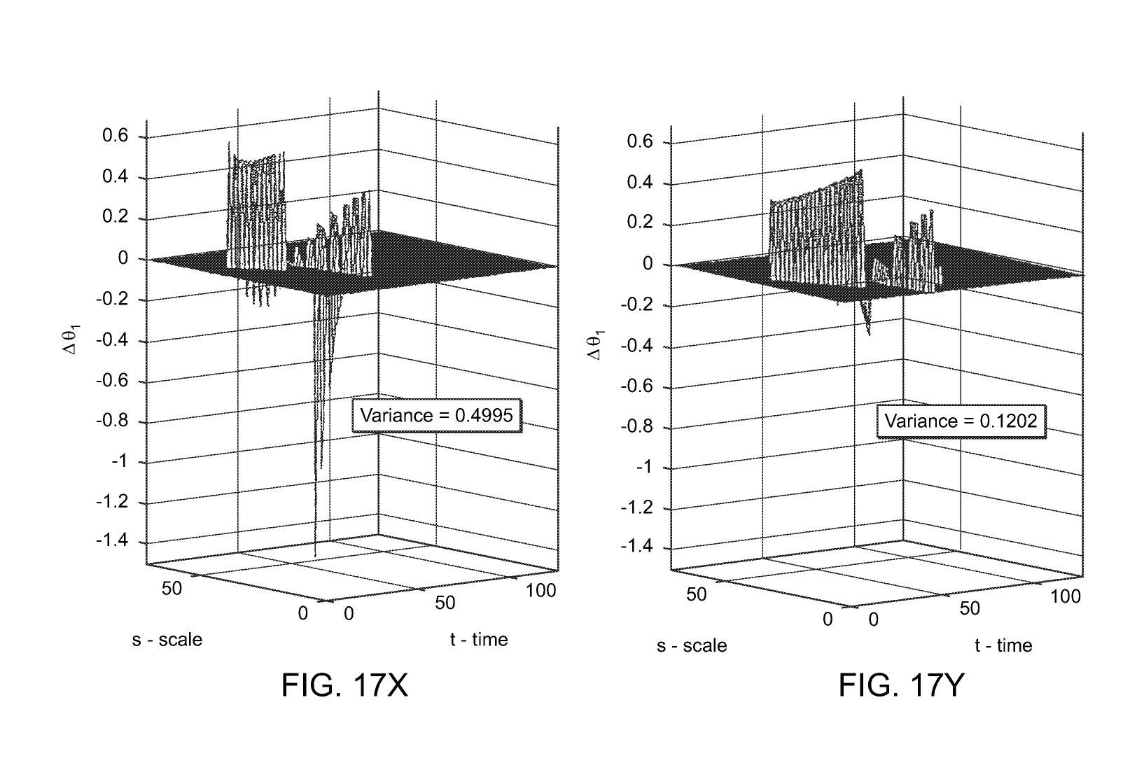

m\ddot{x}(t)+c|\dot{x}(t)|\dot{x}(t)+kx³(t)=u(t) (46)

where x(t) denotes displacement, m the system's lumped mass, c its damping coefficient, k its spring constant, and u(t) an external excitation force. Consider the prediction error, ε(t)=x(t)−\hat{x}(t), to be caused by a mismatch between the nominal parameters Θ̅=[ m̅, c̅, k̅]^{T}=[340,10500,125×10³]^{T} used to obtain \hat{x}(t,u(t), Θ̅) and the true parameters Θ*=[375,9800,130×10³]^{T} used to obtain x(t)=\hat{x}(t,u(t),Θ*)+ν. The simulated prediction error due to an impulse input (u(t)=δ(t)) with ν=0 is shown in the top plot of FIG. 17A (solid line) together with its approximation (dashed line)

$$ɛ ( t , u ( t ) , {Θ}^{*} , \overline{Θ} ) \approx {\sum }_{i = 1}^{Q} Δ {θ}_{i} {E}_{i} ( t , u ( t ) , \overline{Θ} , δ {θ}_{i} ) + v . \qquad ( 47 )$$

The parameter effects were computed according to Eq. with the parameter perturbations δθ at 1% of the parameter values; i.e., δθᵢ=0.01θᵢ. Also shown in the plots of FIGS. 17B-17D are the parameter effects of m, c, and k, which are the constituents of the error approximation in Eq. 47. The results indicate that the error is closely approximated by the weighted sum of the parameter effects in the time-span of simulation.

The differential nature of continuous wavelet transforms can be used to delineate the differences between the parameter effects, due to the fact that differentiation accentuates the differences between signals. This is achieved by considering the parameter effects as time signals and transforming them to the time-scale domain by a continuous wavelet function. As a result of this transformation, Eq. 47 finds the form

$$W \{ ɛ \} \approx {\sum }_{i = 1}^{Q} Δ {θ}_{i} W \{ \frac{\partial \hat{y}}{\partial {θ}_{i}} \} + W \{ v \} \qquad ( 48 )$$

As a side note, analogous to the above in the time domain is finding a component ∂ŷ(tₖ)/∂θᵢ in the sensitivity matrix Φ in Eq. (10) that would be larger than all the other components in that row. If such a single row with such characteristic could be found, it would be considered unpredictable. Yet our findings indicate that such isolated regions can be consistently found within the time-scale plane with different wavelets for all but parameters with collinear parameter effects.

To illustrate the enhanced delineation achieved in the time-scale domain, let us examine the singular values of the parameter effects (i.e., sensitivity matrix Φ) of the nonlinear mass-spring-damper model in Eq. (46) at the nominal parameter vector Θ̅=[ m̅, c̅, k̅]=[383,10290,132600]. In the time domain, the singular values, λᵢₜ, are:

[λ₁ₜ λ₂ₜ λ₃ₜ]=[2.8442 0.1414 0.0144]

but in the time-scale domain the singular values of the transformed parameter effects, λ_{iw}, will be different for each scale and the transformation function used. According to principle component analysis, the more separated the characteristic roots (singular values) are, the more correlated the data. This separation of the singular values can be characterized by the larger value of the product index Πᵢ₌₁³λᵢ or the smaller value of the ratio index λ₁/λ₃. For the above time-domain singular values, these indices are

$${\prod }_{i = 1}^{3} {λ}_{it} = 0.0058 and \frac{{λ}_{1 t}}{{λ}_{3 t}} = 197$$

and for the singular values in the time-scale domain, the above indices for the average singular values across all scales from transformations by the Gaussian smoothing function and the Gauss and Mexican Hat wavelets are shown in Table 9. Although the sum of each set is the same in both the time and time-scale domains as indicated previously; i.e.,

$${\sum }_{i = 1}^{3} {λ}_{it} = {\sum }_{i = 1}^{3} {λ}_{iw} = 3$$

the product index of the average singular values obtained from transformation by the Gauss and Mexican Hat wavelets are larger than their time-domain counterpart, indicating less separation of the singular values in the time-scale domain with these transformations. It is also noteworthy that the ratio index continually decreases from transformation by the Gaussian smoothing function to those by the Gauss and Mexican Hat wavelets, which are the first and second derivatives of the Gaussian function, respectively. Equally noteworthy is the smaller separation of the singular values in the time-scale domain by the Gaussian function due to the smoothing effect of this function on the parameter effects.

TABLE 9
The indices of the average singular values of the transformed
parameter effects in the time-scale domain by the Gaussian
function and Gauss and Mexican Hat wavelets. The upper limit
of summation, M, denotes the number of scales.

| Function | Πᵢ₌₁³ λ̅_{iw} | λ̅_{1w}/ λ̅_{3w} |
|---|---|---|
| Gaussian | 0.004 | 278 |
| function | | |
| Gauss | 0.0089 | 207 |
| wavelet | | |
| Mexican | 0.0202 | 162 |
| Hat | | |
| wavelet | | |

A result of the improved differentiation attained by wavelet transforms one can identify, under broad conditions, locations (pixels) of the time-scale plane wherein a single output sensitivity dominates the rest. Again referring to the union of these pixels for each output sensitivity a parameter signature, as defined below.

The availability of parameter signatures provides significant transparency to the parameter estimation Γᵢ problem, since it makes possible re-formulation of the WT of the prediction error in Eq. (48) into several single-parameter equations, each at the pixels (tₖⁱ,sₗⁱ)∈Γᵢ of the corresponding parameter, as

W{ε}(tₖⁱ,sₗⁱ)≈ΔθᵢW{∂ŷ/∂θᵢ}(tₖⁱ,sₗⁱ)+W{ν}∀(tₖⁱ,sₗⁱ)∈Γᵢ (49)

Using the above single-parameter approximation of the prediction error over the pixels (tₖⁱ,sₗⁱ)∈Γᵢ, the estimate of each parameter error can then be obtained as the mean of estimates at individual pixels of each parameter signature, as

$$\hat{Δ {θ}_{i}} ( \overline{Θ} ) = \frac{1}{{N}_{i}} {\sum }_{k = 1}^{N} {\sum }_{l = 1}^{M} \frac{W \{ ɛ \} ( {t}_{k}^{i} , {s}_{l}^{i} )}{W \{ \frac{\partial \hat{y}}{\partial {θ}_{i}} \} ( {t}_{k}^{i} , {s}_{l}^{i} )} ∀ ( {t}_{k}^{i} , {s}_{l}^{i} ) ∈ {Γ}_{i} \qquad ( 50 )$$

where Nᵢ denotes the number of pixels (tₖⁱ,sₗⁱ) included in Γᵢ. The above estimate of each parameter error then provides the basis for estimating each parameter error separately. We have discussed that the existence of parameter signatures is contingent upon the output sensitivities being uncorrelated, and have demonstrated the feasibility of the parameter error estimates from Eq. (50) in iterative parameter estimation.

It is worth noting here that Eq. (50) can be regarded as a single-parameter gradient-based estimate in the time-scale domain. In Newton-Raphson method, for instance, that uses a gradient-based estimate for a model of the form y=f(θ), the parameter error is estimated as

$$\hat{Δ {θ}_{i}} = \frac{f ( \overline{θ} )}{{f}^{′} ( \overline{θ} )} \qquad ( 51 )$$

where θ̅ denotes the current parameter value and f′ the derivative of f with respect to θ. The parameter error estimate in Eq. (50) is identical to Eq. (50) except that it uses the average of the WT of f divided by WT of f′ at the pixels included in a parameter signature wherein a single-parameter model scenario holds.

A further embodiment includes different techniques for extracting the parameter signatures. The simplest and most reliable technique entails applying a common threshold to the WT of each parameter effect W{Eᵢ} across the entire time-scale plane, and then identifying those pixels wherein only one W{Eᵢ} is nonzero. The threshold operation takes the form of Eq. 26.

Parameter signature extraction then entails searching in the time-scale plane for those pixels (tₖ,sₗ) where only one \overline{W{Eᵢ}} is non-zero. The pixels labeled as (tₖⁱ,sₗⁱ)∈\hat{Γ}ᵢ then satisfy Eq. 27, which again is equivalent to Eq. 28.

From Eq. (26) the threshold η affects the location as well as the size of the parameter signatures. This is illustrated for the parameter effects of FIGS. 17A-17D via the parameter signatures obtained using the Gauss WT at two different threshold levels of η=0.1 and η=0.2 shown in FIGS. 17E-17G and 17H-17J, respectively. The extracted parameter signatures, which are not necessarily restricted to any particular time and/or scale, are clearly affected by the threshold level in size as well as location. Given that the parameter signatures provide the basis for estimating the parameter errors in Eq. (50), it would be informative to also examine the influence of the threshold level η in Eq. (26) on the parameter error estimates. For illustration purposes, the \hat{Δ}\hat{θ}ᵢ obtained for the parameters in Eq. (46) at three different threshold levels with the Mexican Hat WT are shown in Table 10, along with the least-squares estimate \hat{Δ}\hat{Θ} according to

\hat{Δ}\hat{Θ}=(Φ^{T}Φ)⁻¹Φ^{T}ε (52)

where Φ=[E₁(t,u(t), Θ̅),E₂(t,u(t), Θ̅),E₃(t,u(t), Θ̅)]. The results clearly indicate the influence of η on the parameter error estimates. They also indicate consistency between the signs of the estimates and their targets, as well as inconsiderable difference between the estimates and their least squares counterparts. PARSIM can use these estimates to iteratively move the nominal parameter values Θ̅ to their correct values Θ*.

TABLE 10
Parameter estimates by Eq. (27) at an arbitrary Θ̅
using the Mexican Hat WT with the parameter signatures obtained
by different threshold levels, η, in Eq. (29). For reference,
least-squares estimates are also included.

| | | |
|---|---|---|
| Actual | | |
| Parameter | Least- | |
| Errors | Squares | PARSIM Estimates, [symbol] |

| Δθᵢ | [symbol] | η = 0.05 | η = 0.1 | η = 0.2 |
|---|---|---|---|---|
| 75 | 67 | 40 | 26 | 25 |
| −2450 | −1225 | −2103 | −648 | −68 |
| 26000 | 23634 | 100546 | 40663 | 10386 |

Before proceeding to parameter estimation, it is important to identify circumstances in which parameter signatures cannot be extracted. In general, the uniqueness of the parameter estimation solution is contingent upon the posterior identifiability of the model which is a function of the input conditions and noise as well as the structural identifiability of the model. But the ability to extract parameter signatures depends solely on the collinearity of parameter effects; i.e., Eᵢ=γEⱼ, ∀γ∈ [symbol] which is synonymous with a unity correlation coefficient between pairs of parameter effects; i.e., |ρ|=1. This constraint is stated in the following conjecture.

Parameter signatures cannot be extracted for collinear parameter effects. Collinear parameter effects will result in identical nonzero regions for \overline{W{Eᵢ}} and \overline{W{Eⱼ}} according to the threshold operation in Eq. thus making it impossible to extract unique parameter signatures for the corresponding parameters according to Eq. (27).

One way to explain the above conjecture is to consider the WT of a time signal ζᵢ(t):

$$W \{ {ζ}_{i} \} = {\int }_{- ∞}^{∞} {ζ}_{i} ( τ ) \frac{1}{s} ψ ( \frac{t - τ}{s} ) d τ \qquad ( 53 )$$

as the cross-correlation of ζᵢ(t) with ψₛ(t) at different times t and scales s. The wavelet coefficients, which represent the cross-correlation values, will depend upon the magnitude of ζᵢ(t) as well as the conformity of ζᵢ(t) to the shape of the dilated ψ(t) at different scales. The normalization of the wavelet coefficients according to max|W{ζᵢ}| in Eq. (29) nullifies the dependence of the wavelet coefficients on the amplitude of ζᵢ(t) and leaves the correlation between ζᵢ(t) and ψₛ(t) as the only factor affecting the magnitude of the WT at different times and scales. Accordingly, a signal ζ₁(t) that is only slightly different from ζ₂(t) will correlate more than ζ₂(t) with ψₛ(t) at some combination of times and scales and less at some others.

Consider the two signals ζ₁ and ζ₂ in FIGS. 17K AND 17L, representing the parameter effects of two hypothetical parameters θ₁ and θ₂. These two parameters have nearly collinear parameter effects with a correlation coefficient ρ of 0.9997. Yet if we consider the difference between their absolute normalized wavelet transforms, (|W{ζ₁}|/max|W{ζ₁}|)−(|W{ζ₂}|/max|W{ζ₂}|), also shown in FIGS. 17K-17L by the Gauss WT, one observes that they consist of both positive and negative values. This indicates that for each signal, there are regions of the time-scale plane wherein the absolute value of the signal's normalized wavelet coefficient exceeds the other's, albeit by a small margin. Therefore, some threshold η can be found to satisfy Eq. (31). It is also worth noting that because of the small difference margins between the normalized wavelet coefficients in the time-scale plane, the quality of the parameter signatures associated with θ₁ and θ₂ would be quite poor, hence, yielding unreliable parameter error estimates. One can extrapolate these results to multiple signals, with the expectation that the regions included in individual parameter signatures will become smaller with the overlap from the other signals' wavelet coefficients. However, given noncollinearity of parameter effects and adequate resolution in the time-scale plane (i.e., number of pixels), there will always be at least a pixel wherein the wavelet coefficient of each parameter effect will exceed all the others.

As a counterpoint to the highly correlated signals in FIGS. 17K-17L, one may consider the two uncorrelated signals ζ₃ and ζ₄ (ρ=0.08) in FIGS. 17M-17N, associated with the hypothetical parameters θ₃ and θ₄. The (|W{ζ₃}|/max|W{ζ₃}|)−(|W{ζ₄}|/max|W{ζ₄}|) by the Gauss WT in FIGS. 17M-17N not only are similar in trend to those in FIGS. 17K-17L but are also more exaggerated in magnitude, ensuring much more reliable parameter signatures.

In order to extend these results to signature extraction, the parameter signatures of the hypothetical parameters θ₁, θ₂, θ₃, and θ₄ were extracted with the Gauss WT and η=0.1, as shown in FIGS. 17O-17R. The results clearly indicate the sparseness of the parameter signatures \hat{Γ}₁ and \hat{Γ}₂, relative to \hat{Γ}₃ and \hat{Γ}₄, as the direct reflection of near collinearity of their corresponding parameters effects.

The parameter error estimates obtained by Eq. (50) are not exact for the following reasons: (1) local nature of the estimates due to the dependence of Eᵢ(t, Θ̅) on the nominal parameter vector Θ̅; (2) approximate nature of the extracted parameter signatures \hat{Γ}ᵢ by Eq. (26); and (3) neglect of the higher-order terms in the Taylor series approximation of the prediction error in Eq. (47). As such, estimation of parameters based on the parameter error estimates needs to be conducted iteratively, so as to incrementally reduce the error in Θ̅.

The estimated parameter errors \hat{Δ}\hat{θ}ᵢ can be potentially used with any adaptation rule. Here we explore their utility in Newton-type methods to test their fidelity in parameter estimation. Following the general form of adaptation in Newton-type methods, parameter estimation by PARSIM takes the form of Eq. (36), where k is the adaptation iteration number, \hat{Δ}\hat{θ}ᵢ is estimated according to Eq. (50), and μ is the size of adaptation per iteration selected within the range [0,1]. Now consider the evaluation of PARSIM's estimation performance according to Eq. (36) for a variety of different cases. Specifically, PARSIM is evaluated first in a noise-free condition to test the fidelity of parameter error estimates in iterative parameter estimation. Next, it is tested in a noisy environment to consider the effect of noise-distorted WT of the prediction error on the parameter estimates. Finally, PARSIM is applied to two challenging nonlinear models to establish its breadth of applicability in single output cases. For reference, PARSIM's performance is compared in each case with that of the Gauss-Newton method to provide a basis for evaluating its performance vis-à-vis regression. The Gauss-Newton method has the same form as Eq. (36) except that \hat{Δ}\hat{Θ} is obtained according to Eq. (52).

As a first example, PARSIM was applied to the estimation of the nonlinear mass-spring-damper model parameters in Eq. (46) using the model's impulse response as output. One hundred estimation runs were performed with random initial parameter values within 25% of Θ*. A step size of μ=0.50 was used for both PARSIM and the Gauss-Newton method with a threshold level of η=0.10 in Eq. (26) for extracting the parameter signatures in PARSIM. The mean values of the parameter estimates from the 100 estimation runs of PARSIM and the Gauss-Newton method after 50 iterations are listed in Table 11. Along with the parameter estimates are the mean values of the precision error ε_{Θ} obtained as

$${ɛ}_{Θ}^{2} = {\sum }_{i = 1}^{3} {( ( {θ}_{i}^{*} - {\hat{θ}}_{i} ) / {θ}_{i}^{*} )}^{2} \qquad ( 54 )$$

which although not available in practical applications because of unknowable true parameters, is a valuable measure here for its representation of the accuracy of estimates. The results in Table 11 indicate that PARSIM provides less precise estimates than the Gauss-Newton method using the Gauss WT and better estimates with the Mexican Hat WT. Although anecdotal at this point, it is worth noting that these results are consistent with the level of delineation the above wavelet transforms provide for the parameter effects of this model in the time-scale domain, as indicated by the singular values in Table 9. As a measure of the convergence effectiveness of the two methods, the sums of absolute prediction error during the estimation runs of PARSIM using the Mexican Hat WT are compared with those from the Gauss-Newton method in FIG. 17S. The results clearly indicate that PARSIM with the Mexican Hat WT provides a faster convergence than the Gauss-Newton Method.

TABLE 11
Fiftieth-iteration mean of one hundred estimation
runs of the nonlinear mass-spring-damper model parameters by PARSIM
and the Gauss-Newton method. Random initial parameter values within
25% of the true values were used for each estimation run.

| | Parameter Estimates | | | | | |
|---|---|---|---|---|---|---|
| | PARSIM | | | | | |
| True | Gauss WT | | Mexican Hat WT | | Gauss-Newton | |
| Parameters | Mean | St. Dev. | Mean | St. Dev. | Mean | St. Dev. |
| m = 375 | 374.98 | 0.0824 | 375 | 7.6925e⁻¹² | 375 | 1.3578e⁻⁵ |
| c = 9800 | 9800.90 | 4.0381 | 9800 | 6.2681e⁻¹⁰ | 9800 | 7.9358e⁻⁴ |
| k = 130 × 10³ | 129988 | 51.0358 | 130 × 10³ | 1.0591e⁻⁸ | 130 × 10³ | 0.0069 |
| Precision | 5.1492e⁻⁴ | 3.5312e⁻⁴ | 9.8972e⁻¹⁴ | 3.9090e⁻¹⁴ | 9.3542e⁻⁸ | 4.9567e⁻⁸ |
| Error, ε_{Θ} | | | | | | |

PARSIM's performance was next viewed with a noisy output. Here, we could implement a noise suppression technique among those already available in the time-scale domain, but such an implementation would be only cursory given the scope of the present study. As such, we have sufficed to an evaluation of the effect of noise on the parameter estimates. For this test, noise was added to the impulse response of the nonlinear mass-spring-damper model of Eq. (46). The results from one hundred estimation runs of PARSIM using the Mexican Hat WT together with those from the Gauss-Newton method are shown in Table 12. According to the mean and standard deviation of precision error, ε_{Θ}, of the one hundred estimation runs, PARSIM achieves slightly better precision but is not as consistent as the Gauss-Newton method. The main point of this test was to determine if noise would unevenly affect parameter estimates (due to the localized nature of the parameter signatures) by distorting the prediction error in the time-scale plane (i.e., its WT).

TABLE 12
Fiftieth-iteration mean of one hundred estimation runs of
the nonlinear mass-spring-damper model parameters with noisy
outputs by PARSIM using the Mexican Hat WT and the Gauss-
Newton method. Random initial parameter values were used
for each estimation run within 25% of the true values.

| | Parameter Estimates | | | |
|---|---|---|---|---|
| True | PARSIM | | Gauss-Newton | |
| Parameters | Mean | St. Dev. | Mean | St. Dev. |
| m = 375 | 377.77 | 0.0351 | 381.49 | 1.3473e⁻⁵ |
| c = 9800 | 9548.77 | 0.9535 | 9639.89 | 7.6791e⁻⁴ |
| k = 130 × 10³ | 132824 | 4.5650 | 133795 | 0.0073 |
| Precision | 0.0346 | 6.6385e⁻⁵ | 0.0370 | 3.3174e⁻⁸ |
| Error, ε_{Θ} | | | | |

Another point of interest in parameter estimation is the effect of input conditions. To test the performance of PARSIM with a different input condition, estimation was performed using the free response of the nonlinear mass-spring-damper model in Eq. (46) due to an initial displacement. For this, x(t) was simulated in response to an initial displacement of x(0)=0.20 cm. The mean and standard deviation of the adapted parameters from one hundred estimation runs of PARSIM with the Mexican Hat WT and η=0.1 together with those from the Gauss-Newton method are shown in Table 13. As before, random initial parameter values within 25% of the actual parameter values in Θ* were used for each estimation run. The results indicate that the estimated parameters by PARSIM are considerably more accurate and consistent than those by the Gauss-Newton method. Although anecdotal, the results point to a potentially lesser sensitivity of PARSIM to the input conditions, and at the very least, motivate a study of PARSIM's requirements for the input conditions.

TABLE 13
Twentieth-iteration mean and standard deviation values of one
hundred estimation runs of the nonlinear mass-spring-damper model
parameters obtained from the free response of the system to an
initial displacement. As before, the initial parameter values
were randomly selected within 25% of their true values.

| | Parameter Estimates | | | |
|---|---|---|---|---|
| True | Nonlinear mass-spring-damper | | | |
| Parameter | PARSIM | | Gauss-Newton | |
| Values | Mean | St. Dev. | Mean | St. Dev. |
| m = 375 | 374 | 13 | 437 | 80 |
| c = 9800 | 9777 | 352 | 11419 | 2084 |
| k = 130 × 10³ | 129697 | 4668 | 151479 | 27642 |
| Precision | 0.0491 | 0.0331 | 0.2973 | 0.3594 |
| Error, ε_{Θ} | | | | |

To examine its versatility, PARSIM was also applied to two ill-conditioned models. The first model is the nonlinear two-compartment model of drug kinetics in the human body already introduced previously, which has near nonidentifiable parameters. The second case is the Van der Pol oscillator set forth previously, which in addition to being structurally nonidentifiable, exhibits bifurcation characteristics that challenge its first-order approximation by Eq. (47).

As a first step, the collinearity of the parameter effects of k₂₁, k₁₂, and k₀₂ was evaluated by their correlation coefficients as

ρₖ_{₂₁}ₖ_{₁₂}=0.9946 ρₖ_{₂₁}ₖ_{₀₂}=−0.9985 ρₖ_{₁₂}ₖ_{₀₂}=−0.9888

All the three coefficients are near unity, which indicate the difficulty to extract reliable signatures for them. To verify this point, the signatures of the three parameters were extracted using the Gauss WT. Based on these signatures, the parameter errors were estimated according to Eq. (50) as \hat{Δ}\hat{Θ}=[\hat{Δ}\hat{k}\hat{Δk₂₁},\hat{Δ}\hat{k}\hat{Δk₁₂},\hat{Δ}\hat{k}\hat{Δk₀₂}]=[0.1942,0,0] which are null for k₁₂ and k₀₂ due to inability to extract parameter signatures for these two parameters at the current nominal parameters.

Next, parameter estimation was tried. For estimation purposes, the output ŷ(t, \hat{Θ}) of the drug kinetics model in Eq. (41) was simulated. Both PARSIM and the Gauss-Newton method were used to adapt the parameters k₂₁, k₁₂, and k₀₂, which deviated from their true values. The adapted parameters, shown in FIGS. 17T-17U, indicate that the near nonidentifiability of the parameters of this model impedes estimation by either method. However, the results reveal another inherent characteristic of the two methods. In PARSIM's case, the near nonidentifiability of the parameters precludes signature extraction for two of the parameters, so these parameters remain unchanged from their initial values. With the Gauss-Newton method, on the other hand, all three parameters are adapted to minimize the error, but due to near nonidentifiability, the parameter estimates diverge from their true values.

The transparency afforded by the parameters signatures, however, does provide measures for autonomous selection of the threshold η in Eq. (26) and the adaptation step μ in Eq. 36. The criteria and strategies devised for these measures follow.

As noted above, PARSIM relies on the threshold η to extract the parameter signatures according to Eq. (26). As such, the threshold level can have a significant effect on the quality of the extracted parameter signatures as well as their locations, as illustrated for the parameter signature of p₃ of the Lorenz model, shown in FIGS. 17V-17W, extracted with two different threshold levels. It is, therefore, important to devise a strategy whereby a suitable threshold value is selected for extracting quality signatures for each Θ̅.

Assessing the quality of the parameter signatures, however, is not straightforward. Explicit to the definition of the parameter signature Γᵢ is that the W{Eᵢ} be much larger than all the other W{Eⱼ}∀j≠i. But the method used in Eq. (26) only ensures Eq. (28) which does not necessary satisfy the condition of dominance explicit to the definition of parameter signatures. Given that the notion of dominance is associated with the magnitude of W{Eᵢ}, one can potentially consider as a criterion the closeness of the mean of W{Eᵢ} at the pixels (tₖⁱ,sₗⁱ) to the max_{(t,s)}|W{Eᵢ}|. Another possible criterion is the number of pixels included in the parameter signature. However, results indicate that none of the above criteria adequately assesses the quality of parameter signatures. The measure of quality that corresponds the best with parameter estimation performance is the consistency of the parameter error estimates obtained from the individual pixels of the parameter signature, quantified by the variance of the parameter error estimates, as

$${σ}_{{\hat{θ}}_{i}}^{2} = \frac{1}{{N}_{i} - 1} {\sum }_{k = 1}^{N} {\sum }_{l = 1}^{M} {( \frac{W \{ ɛ \} ( {t}_{k}^{i} , {s}_{l}^{i} )}{W \{ {E}_{i} \} ( {t}_{k}^{i} , {s}_{l}^{i} )} - \hat{Δ {θ}_{i}} )}^{2} ∀ ( {t}_{k}^{i} , {s}_{l}^{i} ) ∈ {Γ}_{i} \qquad ( 55 )$$

The reasoning for using the parameter error variance as the measure of parameter signature quality is that ideally every pixel included in the parameter signature ought to provide the same parameter error estimate. Accordingly, large discrepancies between these estimates would indicate a deficiency in the parameter signature extraction process, which may be corrected by the better selection of the threshold level η in Eq. (26).

As an illustration of the effectiveness of the above criterion, the parameter error estimates of b in the Lorenz model are shown at each pixel of the corresponding parameter signature in FIGS. 17X(a)-17X(b) obtained with two different threshold levels. Also shown in the figure, is the variance of the estimates for each signature. The larger variance in the left plot clearly indicates the notably larger scatter among the parameter error estimates relative to those on the right. Ordinarily, if the notion of the parameter signature is satisfied, then all the parameter error estimates should be equal (σ\hat{θ}_{ᵢ}²=0) and there should be no need for averaging them as performed in Eq. (50). In this light, the more scattered the parameter error estimates are (i.e., the higher their variance), the less confidence can be ascribed to the quality of the extracted parameter signature.

A factor that can potentially improve the quality of the extracted parameter signatures is the threshold level η in Eq. (26). A threshold level, however, affects all the parameter signatures, and each parameter signature corresponds to a parameter error variance. Here we have chosen to focus on the largest variance, which is associated with the lowest quality, as the weakest link. Therefore, the search for the threshold level is performed as as to minimize the largest variance among all the parameter error estimates, as

$${η}^{*} ( q ) = arg {min}_{η} {max}_{i} {σ}_{{\hat{θ}}_{i}}^{2} ( q , η ) , {η}_{min} \leq η \leq {η}_{max} \qquad ( 56 )$$

where η* is the selected threshold for the iteration number q within the range [ηₘᵢₙ,ηₘₐₓ. A reasonable range is ηₘᵢₙ=0.02 and ηₘₐₓ=0.20. According to this strategy, the threshold level can be determined for each adaptation step separately, with separate threshold levels considered for each output in multi-output adaptation.

The magnitude of the adaptation step size μ∈(0,1] in Eq. (36) represents the confidence given to the parameter error estimate \hat{Δ}\hat{θ}ᵢ(q) in leading the parameter estimate, \hat{θ}ᵢ(q), to its correct value, θᵢ*. Lower values for μ tend to be more stable, but they prolong the estimation. In time-based estimation, like NLS, the magnitude of μ is selected according to the convexity of the problem and is generally constant at every iteration. In PARSIM, on the other hand, in addition to convexity, the quality of the parameter signature can be a factor in selection of μ, and since the quality of parameter signatures depends on Θ̅ which is different at each iteration, a different μ can be selected for each adaptation iteration. We described above the selection of threshold level at each iteration as a way of improving the quality of parameter signature. Another factor that also affects this quality is the uniqueness of the parameter effects. Using a different adaptation step per iteration leads to the adaptation rule of Eq. (36).

The ability to extract parameter signatures is contingent upon the level of correlation between the parameter effects, computed as

$$\vert {ρ}_{ij} \vert = \frac{\vert {C}_{ij} \vert}{{σ}_{i} {σ}_{j}} = \frac{{\sum }_{k = 1}^{N} ( {E}_{i} ( {t}_{k} ) - {E}_{i} ) ( {E}_{j} ( {t}_{k} ) - {E}_{j} )}{{\sum }_{k = 1}^{N} ( {{E}_{i} ( {t}_{k} )}^{2} - {NE}_{i}^{2} ) ( {\sum }_{k = 1}^{N} {{E}_{j} ( {t}_{k} )}^{2} - {NE}_{j}^{2} )} \qquad ( 57 )$$

where |ρᵢⱼ| is the absolute value of the correlation coefficient between pairs of parameter effects, k represents the sample point and E is the mean value of the parameter effect. According to our findings, it will be impossible to extract parameter signatures when |ρᵢⱼ|=1 and it will be harder to extract quality parameter signatures when |ρᵢⱼ| is closer to 1.

Using the above observation, another factor in the quality of the parameter signature is the level of correlation between a parameter effect and all the other parameter effects. This correlation value can then be factored into the magnitude of μ as

μᵢ(q)=1−max|ρᵢⱼ(q)| ∀j≠i (58)

To evaluate the advantage of the above selection strategies, parameter estimation results were obtained with and without selective thresholding and variable adaptation sizes. The prediction and precision errors for each case are shown in the left and right plots of FIGS. 17Y(a)-17Y(b), respectively. The results in FIGS. 17Y(a)-17Y(b) indicate that both selection strategies enhance the performance of PARSIM and that together they improve the convergence of PARSIM considerably.

Based on the results presented and its description, PARSIM has two attributes that are in contrast to nonlinear least squares. The first attribute is the dormancy caused in the estimation of parameters for which parameter signatures cannot be extracted. The second attribute is the independence of the PARSIM's solution from the contour of the prediction error and its gradient. This solution which deviates from gradient-based solutions, like least-squares, could provide a trajectory that would evade local minima.

The dormancy of the parameter estimation in the absence of parameter signatures is best illustrated with Chua's circuit which is introduced in the next example.

Chua's oscillator is described by a set of three ordinary differential equations called Chua's equations:

$$\begin{matrix} \frac{d {I}_{3}}{d t} = - \frac{{R}_{0}}{L} {I}_{3} - \frac{1}{L} {V}_{2} \\ \frac{d {V}_{2}}{d t} = \frac{1}{{C}_{2}} {I}_{3} - \frac{G}{{C}_{2}} ( {V}_{2} - {V}_{1} ) \\ \frac{d {V}_{1}}{d t} = \frac{G}{{C}_{1}} ( {V}_{2} - {V}_{1} ) - \frac{1}{{C}_{1}} f ( {V}_{1} ) \\ where \\ f ( V 1 ) = {G}_{b} {V}_{1} - ( {G}_{a} - {G}_{b} ) ( \vert {V}_{1} + E \vert - \vert {V}_{1} - E \vert ) \\ and & ( 59 ) \\ \begin{matrix}{Θ}^{*} = [ \begin{matrix}{L}^{*} & {R}_{0}^{*} & {C}_{2}^{*} & {G}^{*} & {G}_{a}^{*} & {G}_{b}^{*} & {C}_{1}^{*} & {E}^{*} ]\end{matrix} \\ = [ \begin{matrix}- 9.7136 & 4.75 & - 1.0837 & 33.932813 & - 0.5 & .0064 & 1 & 1 ]\end{matrix}\end{matrix} & \end{matrix}$$

For this illustration and throughout the paper for this model,

$$\begin{matrix}\overline{Θ} = [ \begin{matrix}\overline{L} & {\overline{R}}_{0} & {\overline{C}}_{2} & \overline{G} & {\overline{G}}_{a} & {\overline{G}}_{b} & {\overline{C}}_{1} & \overline{E} ]\end{matrix} \\ = \begin{matrix}[ 0.98 {L}^{*} & 1.02 {R}_{0}^{*} & 0.98 {C}_{2}^{*} & 1.02 {G}^{*} & 0.98 {G}_{a}^{*} & 1.02 {G}_{b}^{*} & 0.98 {C}_{1}^{*} 1.02 {E}^{*}\end{matrix} ]\end{matrix}$$

The correlation matrix for the parameter effects based on the first output; i.e., y₁=x₁, yields

$$R = [ \begin{matrix}1.0000 & - 0.1462 & 0.6368 & 0.1481 & 0.3840 & - 0.3813 & - 0.5898 & 0.3839 \\ - 0.1462 & 1.0000 & 0.2325 & - 0.9606 & - 0.9655 & 0.9656 & - 0.1170 & - 0.9657 \\ 0.6368 & 0.2325 & 1.0000 & - 0.0675 & - 0.0032 & - 0.0041 & 0.9823 & 0.0042 \\ 0.1481 & - 0.9606 & - 0.0675 & 1.0000 & 0.9515 & - 0.9517 & - 0.0782 & 0.9512 \\ 0.3840 & - 0.9655 & - 0.0032 & 0.9515 & 1.0000 & - 0.9997 & - 0.1018 & 1.0000 \\ - 0.3813 & 0.9656 & - 0.0041 & - 0.9517 & - 0.9997 & 1.0000 & 0.1085 & - 0.9997 \\ - 0.5898 & - 0.1170 & - 0.9823 & - 0.0782 & - 0.1018 & 0.1085 & 1.0000 & - 0.1007 \\ 0.3839 & - 0.9657 & - 0.0042 & 0.9512 & 1.0000 & - 0.9997 & - 0.1007 & 1.0000\end{matrix} ]$$

which indicates collinearity |ρᵢⱼ=1| between the parameter effects of Gₐ G_{b} and E. Parameter estimation was, therefore, performed on only five of the parameters.

With only the first output used; i.e., y=x₁, the estimates by PARSIM are shown in FIGS. 17Z(a)-17Z(e) along with the estimates from the Gauss-Newton method. The estimation results indicate that two of the parameters, C₂ and C₁, remain completely unchanged by PARSIM from their initial values. In contrast, the Gauss-Newton method continues to adapt the parameters at each iteration, albeit for 300 iterations before they reach their correct values. These results are representative of the tendency of the Gauss-Newton method to continually adapt the parameters even when the gradient is quite gradual. Therefore, one advantage of integration of PARSIM with NLS is continual adaptation of parameters. The other advantage is PARSIM's propensity to evade local minima. This is illustrated through a non-convex contour like the one represented by the Van der Pol oscillator in Eq. (45), introduced in Example 3. Both PARSIM the Gauss-Newton method were applied to this model for estimation of parameters c and k. Only these two parameters were considered to enable graphical representation of the error contour. Two starting points were then selected on the non-convex region of the error surface and both PARSIM (using the Gauss wavelet transform) and the Gauss-Newton method were applied to the estimation of parameters from these two starting points. The trajectory of estimates by the two methods obtained with an adaptation step of μ=0.75 are shown in FIGS. 17Z(f)-17Z(g). The results indicate that PARSIM, because of its independence from the gradient of the contour, can lead the estimates to their correct values (the bottom of the bowl) whereas the Gauss-Newton method misses them due to the unfavorable location of the starting points.

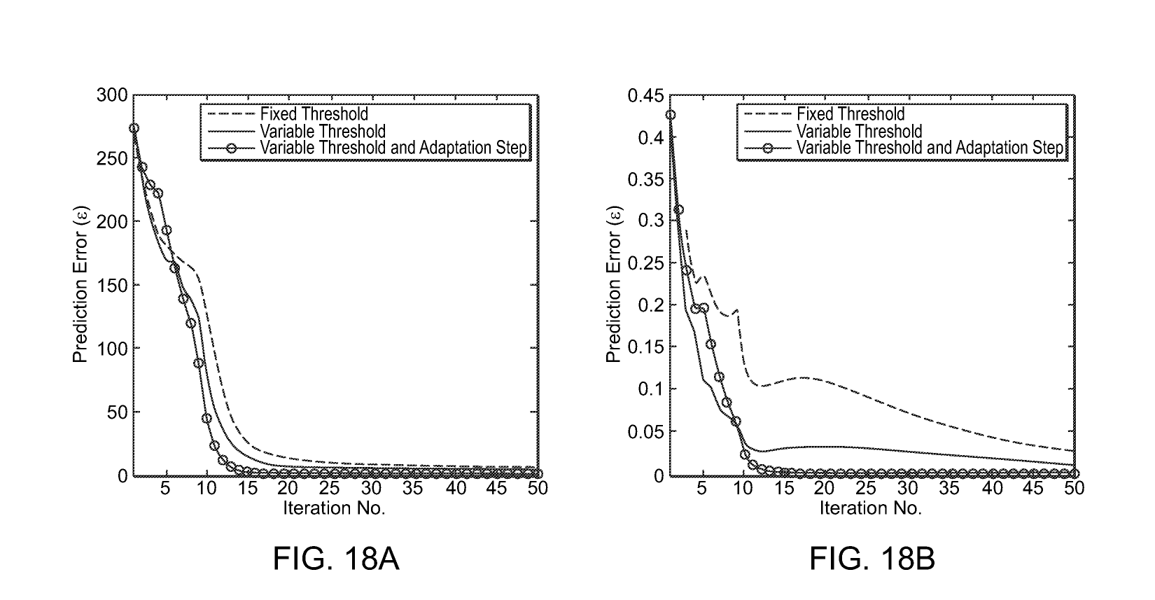

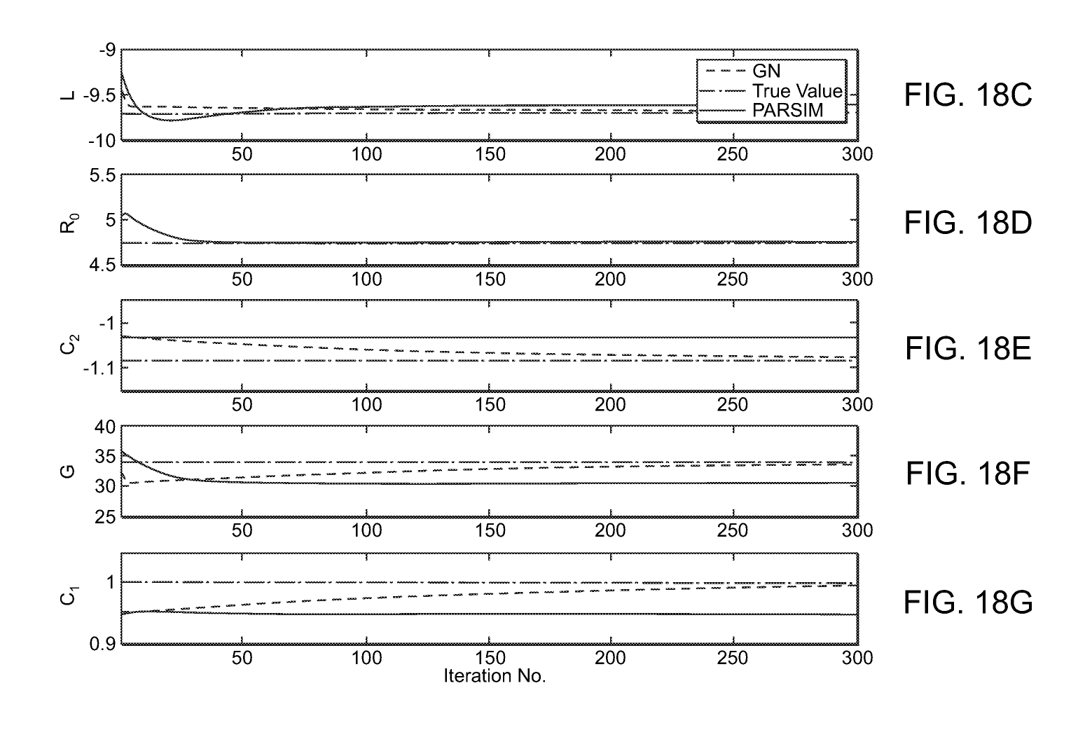

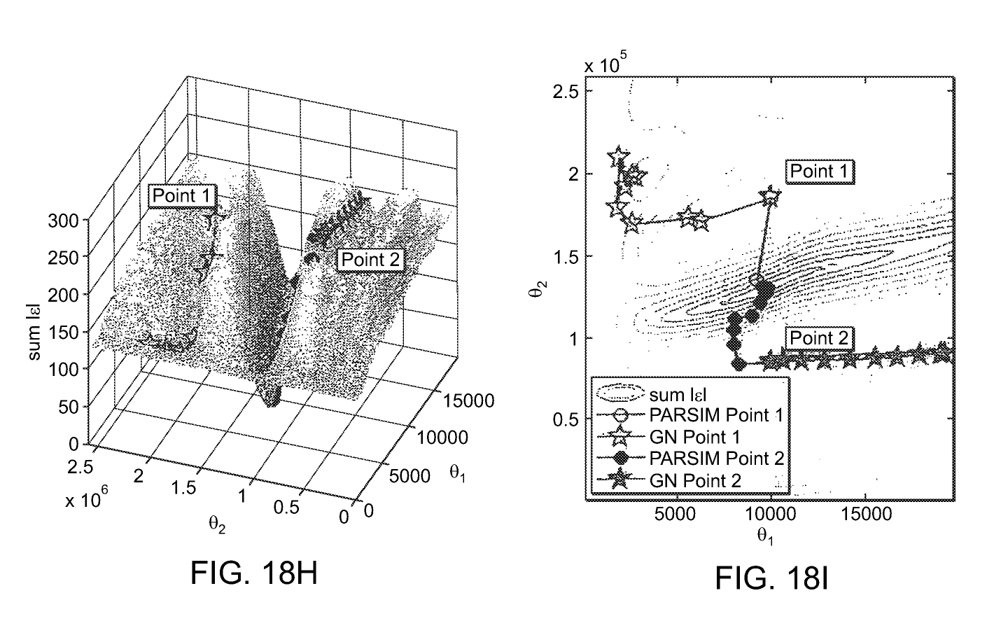

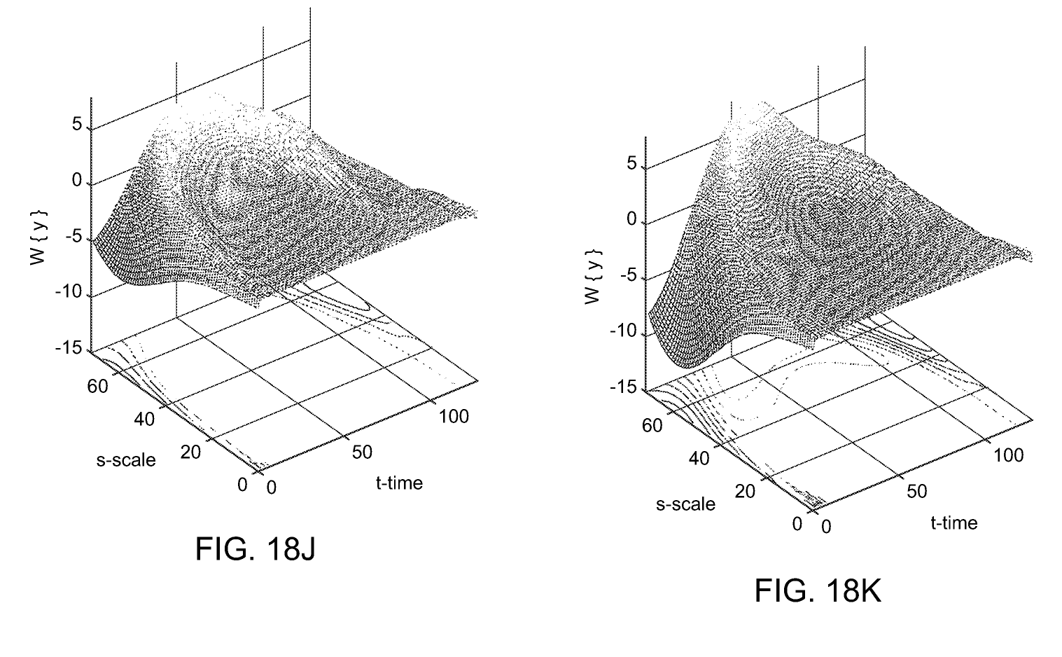

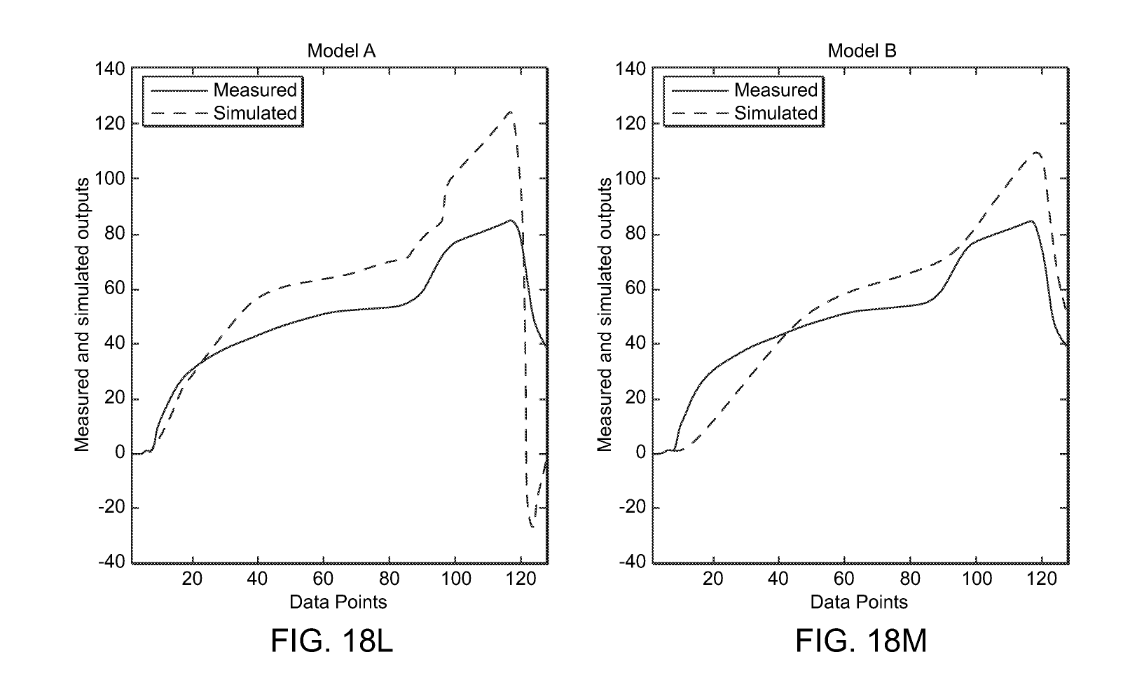

In a preferred embodiment, the present invention can be used to represent sensor data in an industrial system such as pressure in a molding process. Here, the Gauss wavelet transforms of the measured pressure and simulated pressure by Model B in FIGS. 18C and 18D are shown in FIGS. 18A and 18B. As is observed, a characteristic of the approach is to transform the outputs into images as represented by the projected contours of the surfaces in FIGS. 18A and 18B, hence the need for image distances to compare the images.

The enhanced delineation achieved in the time-scale domain can be evidenced from the singular values of the time series. According to principle component analysis (POA), the more separated the characteristic roots (singular values), the more correlated are the data. The singular values of the two time series in the plot of FIG. 18B, representing the measured pressure and simulated pressure by Model B, are

[λ₁ₜ λ₂ₜ]=[1.9673 0.0327]

But in the time-scale domain, the singular values of the transformed signals, λ_{iw}, will be different for each scale and the transformation function used. The mean of the λ_{iw} across all scales from transformations by the Gaussian smoothing function and the Gauss and Mexican Hat wavelets are shown in Table 9. From the results in Table 14, it can be observed that although the sum of each set is the same in both the time and time-scale domains; i.e.,

$${\sum }_{i = 1}^{2} {λ}_{it} = {\sum }_{i = 1}^{2} {λ}_{iw} = 2$$

the average singular values obtained from transformations by the Gauss and Mexican hat wavelets are less separated than their time-domain counterpart, and more separated when transformed by the Gaussian smoothing function. This is consistent with the level of differentiation provided by the Gauss and Mexican hat wavelets, as the first and second derivatives of the Gaussian function, respectively. This method of enhanced delineation, capitalized on by image distances, leads to a more refined model validation metric than the magnitude of the prediction error.

TABLE 14
The average singular values across scales of the transformed measured
pressure and simulated pressure by Model B (FIG. 18D) using the
Gaussian function and Gauss and Mexican Hat wavelets.

| Function | λ̅_{1w} | λ̅_{2w} |
|---|---|---|
| Gaussian | 1.9792 | 0.0208 |
| function | | |
| Gauss | 1.9432 | 0.0568 |
| wavelet | | |
| Mexican | 1.9189 | 0.0811 |
| Hat | | |
| wavelet | | |

Traditionally, validation metrics have been based on scalar measures of the prediction error, such as Akaike and Schwarz criteria, which represent the cumulative differences between the model outputs and process observations. However, more desirable for dynamic systems is a detailed view of such differences. A preferred embodiment involves the pressure measurements inside the mold during an injection molding operation in FIGS. 18A and 18B, together with their simulated counterparts by two different models. The sum of the absolute prediction errors by Models A and B are 2198 and 1400, respectively, so one can deduce from the magnitude of prediction errors that Model B provides a better fit to the measured data. However, most of the error by Model A is associated with the last few data points of its output and a decision on the quality of the model based solely on the magnitude of the prediction error may not be prudent. The transformation to the time-scale domain proposed here is to accentuate the differences of these outputs, and reliance on image distances is to materialize their comparison.

As is observed from the transformed signals in FIG. 18A and the contours of the wavelet coefficients can be viewed as images. As such, image distances are a natural choice for evaluating the closeness of wavelet transform pairs. Two different image distances are considered for this purpose: (1) the Euclidean distance, and (2) the Image Euclidean distance. The Euclidean distance d_{E} between the two M by N images, x=(x¹, x², . . . , x^{MN}) and z=(z¹, z², . . . , z^{MN}), is defined as

$${d}_{E}^{2} ( x , z ) = {\sum }_{m = 1}^{MN} {( {x}^{m} - {z}^{m} )}^{2} \qquad ( 60 )$$

where x^{m} and z^{m} denote the magnitudes of wavelet coefficients at individual pixels of each image, respectively. The Euclidean distance, however, represents the cumulative (lumped sum) difference between two images, and, as such, does not account for pixel by pixel error between the images. The alternative to the Euclidean distance is the Image Euclidean distance, which discounts the error magnitude between pixels according to their mutual distance from each other on the time-scale plane. The Image Euclidean distance d₁ is computed as

$${d}_{I}^{2} ( x , z ) = \frac{1}{2 π {σ}^{2}} {\sum }_{k , l = 1}^{NM} exp \{ - {\vert {P}_{k} - {P}_{l} \vert}^{2} / 2 {σ}^{2} \} ( {x}^{k} - {z}^{k} ) ( {x}^{l} - {z}^{l} ) \qquad ( 61 )$$

where σ is a width parameter that accounts for the discount rate associated with the pixel distance, k and l denote the location of each pixel on the time-scale plane, Pₖ and Pₗ denote pixels and |Pₖ−Pₗ| represents the distance between two pixels on the image lattice. Accordingly, the Image Euclidean distance fully incorporates the difference in magnitude of pixels with identical locations from two images and discounts by the weight exp{−|Pₖ−Pₗ|²/2σ²} the magnitude difference when the two pixels do not coincide on the time-scale plane (image lattice).

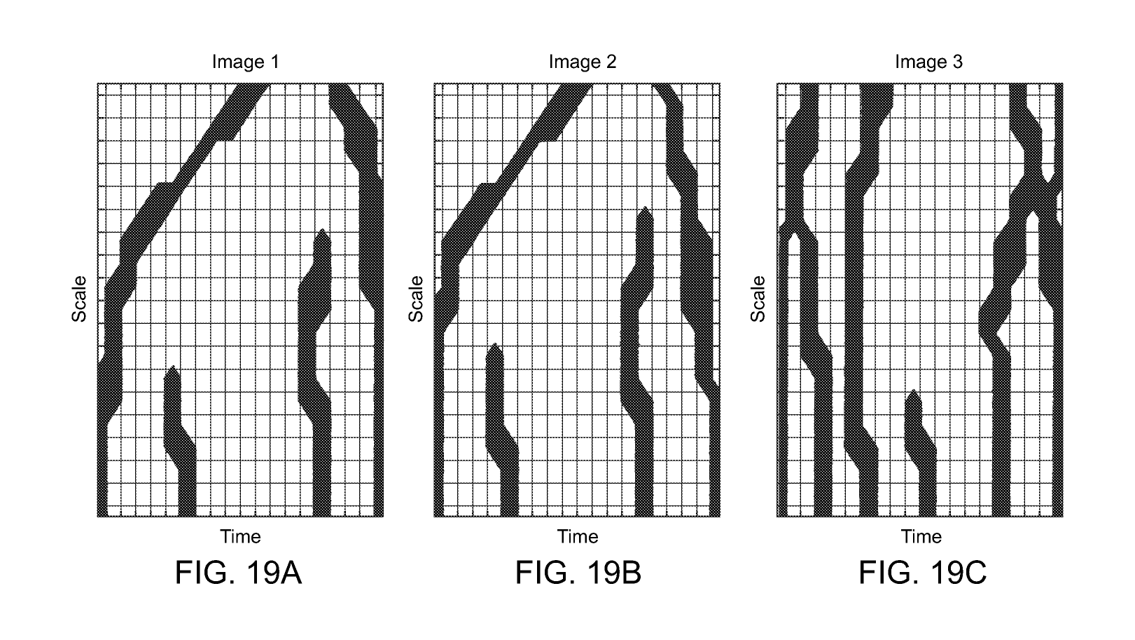

The characteristic of the above image distances is illustrated through the images shown in FIGS. 19A-19C. By visual inspection of these images, which represent the binary modulus maxima (edge magnitudes) of the wavelet transforms of three time series, it is clear that Images 1 and 2 are closer to each other than either is to Image 3. However, the Euclidean distance (d_{E}) between Images 1 and 2 is 102 and it is 88 between Images 1 and 3, indicating a smaller distance between Images 1 and 3. In contrast, the Image Euclidean distance (d₁) between Images 1 and 2 is 0.9675 and is 4.6241 between Images 1 and 3, providing a better agreement with the visual similarity of these images.

Next, the effectiveness in model validation of the above image distances is illustrated via an example wherein individual models are considered, one at a time, to represent the process.

Another preferred embodiment relates to drug kinetics in human body. Consider the drug injected into the blood (compartment 1) as it exchanges linearly with the tissues (compartment 2). Two different models are considered, in turn, to represent the process. Image distances are then obtained between the process and each model to assess the validity of the distances in measuring the closeness of models to the process. The first model assumes that the drug is irreversibly removed with a nonlinear saturation characteristic (Michaelis-Menten dynamics) from compartment 1 and linearly from compartment 2. The second model considers the transformation to be linear from both compartments. The experiment takes place in compartment 1. The state variables x₁ and x₂ represent drug masses in the two compartments, u(t) denotes the drug input, y(t) is the measured drug, k₁₂, k₂₁, and k₀₂ denote constant parameters, V_{M} and Kₘ are classical Michaelis-Menten parameters, and b₁ and c₁ are input and output parameters. The two models are:

$$\begin{matrix}Nonlinear Model \text{:} & \\ {\dot{x}}_{1} ( t ) = - ( {k}_{21} + \frac{{V}_{M}}{{K}_{m} + {x}_{1} ( t )} ) {x}_{1} ( t ) + {k}_{12} {x}_{2} ( t ) + {b}_{1} u ( t ) \\ {\dot{x}}_{2} ( t ) = {k}_{21} {x}_{1} ( t ) - ( {k}_{02} + {k}_{12} ) {x}_{2} ( t ) \\ y ( t ) = {c}_{1} {x}_{1} ( t ) & ( 62 ) \\ Linear Model \text{:} & \\ {\dot{x}}_{1} ( t ) = - {k}_{21} {x}_{1} ( t ) - {k}_{12} {x}_{2} ( t ) + {b}_{1} u ( t ) \\ {\dot{x}}_{2} ( t ) = {k}_{21} {x}_{1} ( t ) - ( {k}_{02} + {k}_{12} ) {x}_{2} ( t ) \\ y ( t ) = {c}_{1} {x}_{1} ( t ) & ( 62 )\end{matrix}$$

For simulation purposes, the ‘true’ parameter values were obtained from the literature to represent galactose intake per kg body weight (kg B W) as

Θ*=[k₂₁*,k₁₂*,V_{M}*,Kₘ*,k₀₂*,c₁*,b₁]*=[3.033,2.4,378,2.88,1.5,1.0,1.0]

Using the nominal parameters

Θ̅=[ k̅₂₁, k̅₁₂, V̅_{M}, K̅ₘ, k̅₀₂, c̅₁, b̅₁]=[2.8,2.6,378,2.88,1.6,1.0,1.0]

the system response to a single dose of drug x₁(0)=0.1 mg/100 ml kg B W, x₂(0)=0 was simulated with either of the two models representing the process. Each model was used, one at a time, to represent the process, for which the “process observations” were obtained at Θ*. One hundred different model outputs were then obtained for each model at random parameters within 30% of Θ̅, similar to Monte Carlo Simulation. The average magnitudes of the prediction error between each set of “process observations” and the one hundred model outputs are shown in Table 15 at different levels of signal-to-noise ratio (SNR) for the combinations of the two models used as process and model, respectively. In order to indicate the degree of separation achieved for each model, also shown in this table are the ratios of the error magnitudes in each column. The signal-to-noise ratio in this table was estimated empirically according to the relationship

SNR=γₛ²/γₙ² (64)

where γₛ² and γₙ² denote the mean squared values of the signal and noise, respectively. The results in Table 15 indicate that, as expected, the magnitudes of the prediction error are lower when the model matches the process (as indicated by bold diagonal numbers). The results also indicate that the magnitudes of the prediction error are affected by the signal-to-noise ratio and that the degree of separation (as indicated by the ratios) is reduced with the noise level.

TABLE 15
Effect of noise as defined by the signal-to-noise
ratio (SNR) of the error on average magnitude of the prediction
error at 100 different parameter sets of the drug kinetics model.

| | Process Form | | | | | | | | | |
|---|---|---|---|---|---|---|---|---|---|---|
| | Linear Model | | | | | Nonlinear Model | | | | |
| | SNR | | | | | SNR | | | | |
| | ∞ | 50 | 12.5 | 5.6 | 3.13 | ∞ | 50 | 12.5 | 5.6 | 3.13 |
| Model Form | Σₜ\|ε(t)\| | | | | | | | | | |
| Linear Model | 0.480 | 0.655 | 1.025 | 1.445 | 1.884 | 4.227 | 4.164 | 4.132 | 4.168 | 4.264 |
| Nonlinear Model | 3.838 | 3.911 | 4.013 | 4.141 | 4.301 | 0.865 | 0.991 | 1.286 | 1.656 | 2.061 |
| Ratio | 8.00 | 5.97 | 3.92 | 2.87 | 2.28 | 4.89 | 4.20 | 3.21 | 2.52 | 2.07 |
| (per column) | | | | | | | | | | |

Next, to evaluate the utility of image distances as measures of model closeness, the Gauss wavelet transforms of the “process observations” and model outputs were obtained. The average Euclidean and Image Euclidean distances are shown in Table 16 along with the ratios of the distance magnitudes in each column, indicating the degree of separation provided for each model. The results indicate that both image distances are effective in matching the model structure with the process, as indicated by the smaller diagonal image distances (shown as bold) between the like process and model forms. The results also indicate that both sets of ratios, associated with the Euclidean distance (d_{E}) and Image Euclidean distance (d_{I}), are larger than those associated with the prediction error in Table 15, and that the ratios associated with the Image Euclidean distance (d_{I}) are larger than the ones associated with the Euclidean distance d_{E}. This indicates a higher degree of separation achieved by the Image Euclidean distance for the two model forms. As with the prediction error in Table 15, both sets of ratios are affected by the signal-to-noise ratio, but the ratios associated with the image distances provide a higher degree of separation between the model forms. Next, the utility of image distances is evaluated in a practical application.

TABLE 16
Effect of noise as defined by the signal-to-noise ratio (SNR) of the “observations” on the
average Euclidean and Image Euclidean distances between the Gauss wavelet
transforms of observations and model outputs at 100 different parameter
sets of the drug kinetics model.

| | Process Form | | | | | | | | | |
|---|---|---|---|---|---|---|---|---|---|---|
| | Linear Model | | | | | Nonlinear Model | | | | |
| Model | SNR | | | | | SNR | | | | |
| Form | ∞ | 50 | 12.5 | 5.6 | 3.13 | ∞ | 50 | 12.5 | 5.6 | 3.13 |
| | d_{E} | | | | | | | | | |
| Linear | 0.017 | 0.020 | 0.028 | 0.038 | 0.048 | 0.114 | 0.115 | 0.116 | 0.119 | 0.123 |
| Model | | | | | | | | | | |
| Nonlinear | 0.113 | 0.114 | 0.115 | 0.118 | 0.121 | 0.014 | 0.019 | 0.027 | 0.037 | 0.048 |
| Model | | | | | | | | | | |
| Ratio | 6.65 | 5.70 | 4.11 | 3.11 | 2.52 | 8.14 | 6.05 | 4.30 | 3.22 | 2.56 |
| (per | | | | | | | | | | |
| column) | | | | | | | | | | |
| | d_{I} | | | | | | | | | |
| Linear | 9.840e−4 | 0.0015 | 0.0023 | 0.0032 | 0.0042 | 0.0153 | 0.0154 | 0.0155 | 0.0157 | 0.0160 |
| Model | | | | | | | | | | |
| Nonlinear | 0.0144 | 0.0144 | 0.0144 | 0.0146 | 0.0148 | 0.0021 | 0.0024 | 0.0031 | 0.0039 | 0.0048 |
| Model | | | | | | | | | | |
| Ratio | 14.63 | 9.60 | 6.26 | 4.56 | 3.52 | 7.29 | 6.42 | 5.00 | 4.03 | 3.33 |
| (per | | | | | | | | | | |
| column) | | | | | | | | | | |

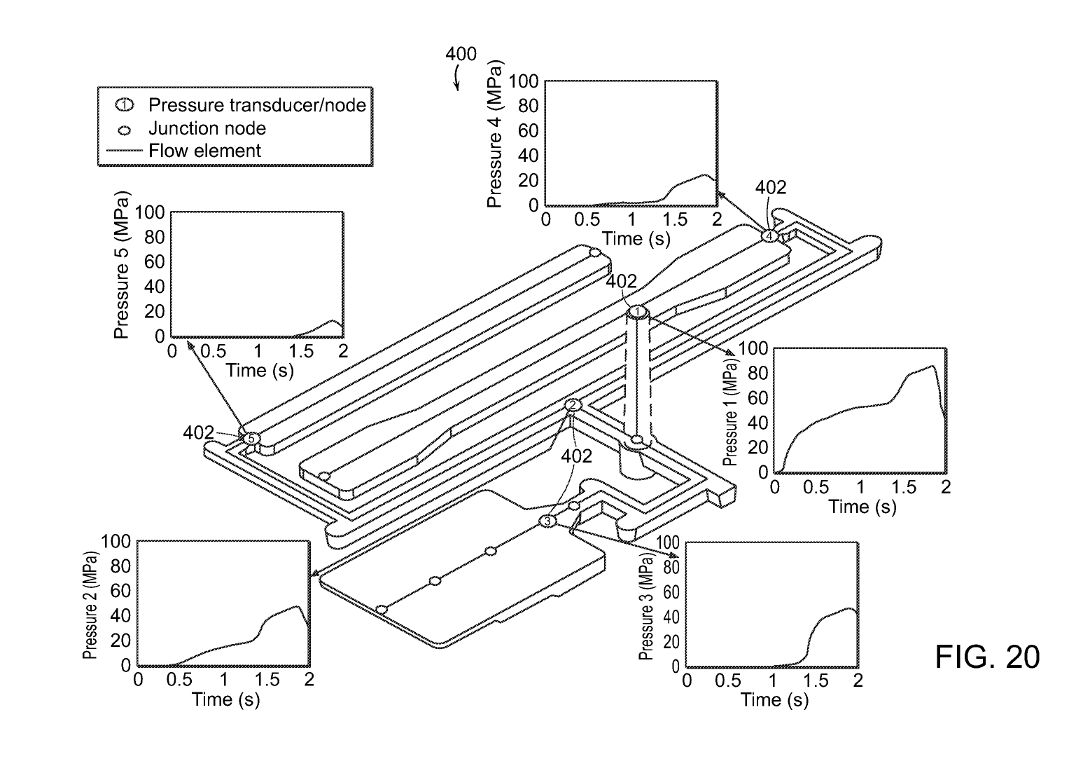

The effectiveness of the image distances in model validation is evaluated in the context of an injection molding cycle. Consider the instrumented ASTM test mold shown in FIG. 20, having three cavities and the actual pressures measured during the molding cycle. Each portion of the mold can be thought of as an “element” with a unique pressure gradient modeled as a rod or strip with two end nodes. By assembling the element conductance matrix and the element flow rate vector, a global conductance equation is formed. The mold is instrumented such that the inlet pressure (P₁), runner pressure (P₂), and cavity entrance pressures (P₃, P₄, and P₅) are measured at the nodal locations shown in FIG. 20.

The mold geometry, melt rheology, and molding conditions are generally but not precisely known. The solution of the mass, momentum, and energy equations yields a vector of pressure predictions that is consistent with the pressures observed by implanted transducers. However, variances in the model parameters and the inaccuracy of the model will lead to errors between the observed and simulated pressures throughout the molding cycle.

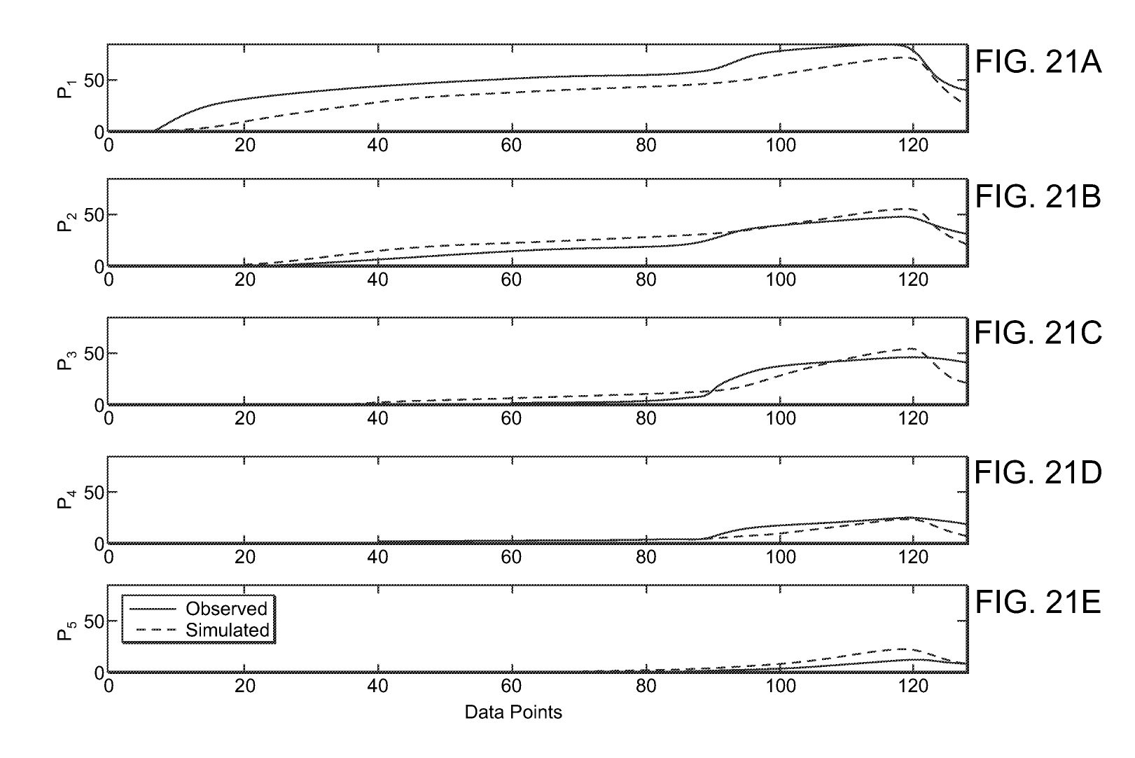

Molding trials were conducted with polypropylene on a 50 metric ton Milacron Ferromatic molding machine. The ASTM test mold 400 was instrumented with piezoelectric pressure transducers 402 at the locations shown in FIG. 20. A full factorial design of measurements was conducted to vary parameters including the melt temperature, coolant temperature, and injection velocity. The measured pressures are shown in FIGS. 21A-21E. Along with the measured pressures are their simulated counterparts in this figure. The simulation results included in FIGS. 21A-21E were obtained with a power law viscosity model (Models 2 and 3) and a first order delay to account for the melt compressibility of β/dt (Model 3). These results would be different if instead the Newtonian or non-isothermal model was used with the assumption of incompressibility (Model 1). As such, a major concern in model validation is to determine if the prediction error is mostly due to error in the model parameters or it is due to qualitative deficiency of the model and assumptions used in simulating the outputs. To better illustrate this point, up to three of the rheological model parameters were adapted using the Gauss-Newton method to reduce the prediction error between the measured and simulated pressures for eight different molding trials conducted with varying temperatures, injection velocities, and other conditions. The other twenty six model parameters which were associated with the mold geometry were assumed to be accurate. The sum of the absolute prediction errors at the five mold locations in FIG. 20 normalized relative to the smallest prediction error for each molding trial before adaptation (BA) and after adaptation (BA) of the rheological parameters are shown in Table 17 with different models.

TABLE 17
Normalized sum of absolute errors at the five
locations of the mold for each input condition before parameter
adaptation (BA) and after parameter adaptation (AA) by the Gauss-
Newton method.

| | Sum of Absolute Prediction Error | | | | | |
|---|---|---|---|---|---|---|
| Input | Model 1 | | Model 2 | | Model 3 | |
| Conditions | Before | After | Before | After | Before | After |
| 1 | 2.07 | 1.70 | 1.45 | 1.37 | 1.04 | 1 |
| 2 | 7.15 | 1.28 | 1.26 | 1 | 1.27 | 1.16 |
| 3 | 1.98 | 1.69 | 1.41 | 1.39 | 1.05 | 1 |
| 4 | 6.58 | 1.22 | 1.24 | 1 | 1.25 | 1.14 |
| 5 | 2.47 | 1.60 | 1.17 | 1.12 | 1.07 | 1 |
| 6 | 6.79 | 1.26 | 1.25 | 1 | 1.26 | 1.14 |
| 7 | 2.65 | 1.63 | 1.22 | 1.14 | 1.08 | 1 |
| 8 | 6.82 | 1.21 | 1.18 | 1 | 1.19 | 1.09 |

The results in Table 17 illustrate the conjugation between the quality of the model on one hand and effectiveness of parameter estimation on the other, which can be a problem of simulation model development. In comparing the prediction error in each column before and after adaptation, one can observe that although the errors are reduced by regression, they never approach zero. Moreover, some of the lower errors may be achieved at the expense of unrealistic (or negative) parameter estimates that ensure model failure at other processing conditions. Indeed, the statistics indicate that the addition of model complexity and related parameters reduces the mean average error but actually increases the standard deviation of the error. For a model to be sufficiently robust for process or quality control, both a low mean and standard deviation of the error are required. The question then arises as when one would decide that the complexity of the model is sufficient and suitable for adaptation. For instance, the results in Table 12 indicate that although there is clear improvement in the simulation results due to the use of Power Law (Models 2 and 3) instead of Newtonian (model 1), the improvements are not as pronounced when considering compressibility in place of incompressibility, especially after adaptation. According to the prediction error results, Model 2 (incompressible melt) provides better estimates for input conditions 2, 4, 6, and 8 (shown as bold), whereas Model 3 seems to be the better model for the other input conditions 1, 3, 5, and 7 (also shown as bold). Furthermore, the errors vary from run to run, indicating that the model's accuracy varies with the molding conditions. So, when does one stop adding to the model complexity and concentrate on adaptation? As is shown through the image distances, we believe the transparency provided in the time-scale domain can provide new metrics to resolve this dilemma.

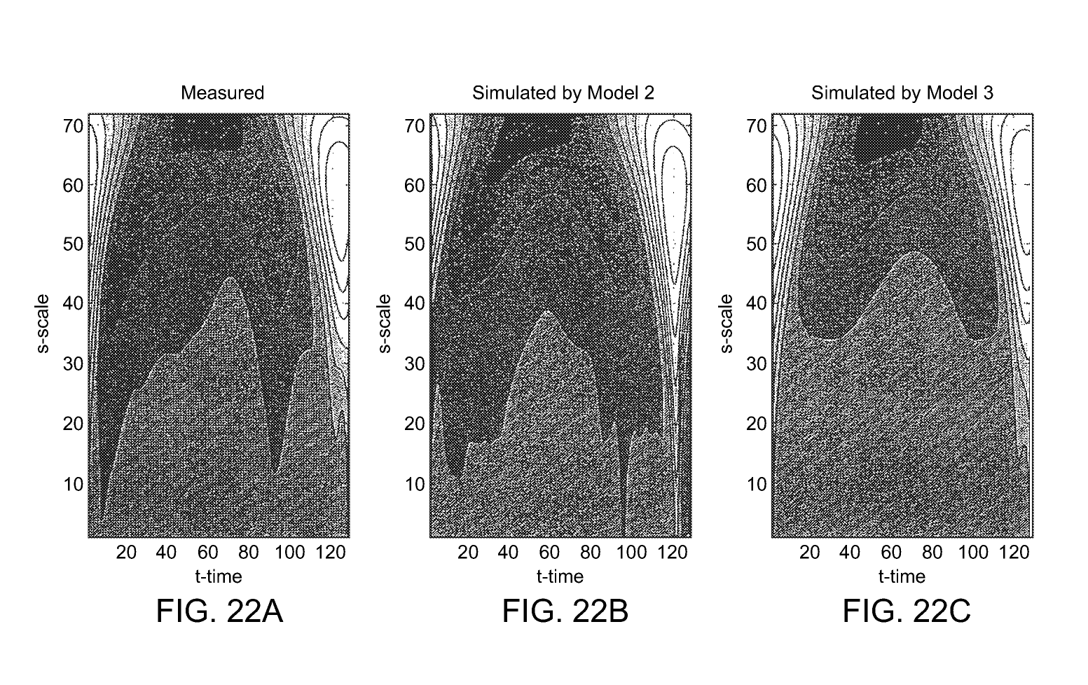

To evaluate the utility of the two image distances considered here in assessing the quality of the models, the Gauss and Mexican Hat wavelet transforms of the measured and simulated pressures by Models 2 and 3 were obtained. A sample of surface contours of the wavelet coefficients of the measured pressure and its simulated values by Models 2 and 3 are shown in FIGS. 22A-22C. The image distances were computed for one hundred different nominal parameter values within 25% of Θ̅=[200,000 0.25 0.1]. The image distances were then normalized relative to the smallest corresponding image distance. The normalized average Euclidean and Image Euclidean distances are shown in Tables 13 and 14 for the Gauss and Mexican Hat wavelet transforms, respectively. The results indicate that while both sets of Image Euclidean distances (d_{I}) in Tables 18 and 19 are consistent in declaring Model 3 (compressible melt) as the closer representation of the process, the Euclidean distances (d_{E}) are mixed when computed by the Gauss wavelet transform (Table 18) but consistent with the Mexican Hat wavelet transform (Table 19). The more consistent results by the Mexican Hat wavelet is due to the better delineation of the outputs in the time-scale domain due to this wavelet, as represented by the singular values in Table 14.

TABLE 18
Average normalized image distances between the
Gauss wavelet transforms of measured pressures
and simulated pressures by Models 2 and 3.

| | Image Distances | |
|---|---|---|
| Input | d_{E} | d_{I} |

| Conditions | Model 2 | Model 3 | Model 2 | Model 3 |
|---|---|---|---|---|
| 1 | 12.5624 | 1 | 13.6142 | 1 |
| 2 | 1.0064 | 1 | 1.0192 | 1 |
| 3 | 9.1677 | 1 | 10.9375 | 1 |
| 4 | 1 | 1.0351 | 1 | 1 |
| 5 | 1.2821 | 1 | 1.3214 | 1 |
| 6 | 1 | 1.0253 | 1.0172 | 1 |
| 7 | 1.2823 | 1 | 1.3247 | 1 |
| 8 | 1.0252 | 1 | 1.1154 | 1 |

TABLE 19
Average normalized image distances between the Mexican Hat wavelet
transforms of y(t) and ŷ(t) with Models 2 and 3.

| | Image Distances | |
|---|---|---|
| Input | d_{E} | d_{I} |

| Conditions | Model 2 | Model 3 | Model 2 | Model 3 |
|---|---|---|---|---|
| 1 | 17.11 | 1 | 16.16 | 1 |
| 2 | 24.14 | 1 | 22.63 | 1 |
| 3 | 15.25 | 1 | 15.94 | 1 |
| 4 | 21.21 | 1 | 20.67 | 1 |
| 5 | 26.18 | 1 | 20.27 | 1 |
| 6 | 20.99 | 1 | 20.13 | 1 |
| 7 | 28.61 | 1 | 23.6 | 1 |
| 8 | 22.10 | 1 | 21.65 | 1 |

The common approach to improving the signal-to-noise ratio is to low-pass filter the measurements. Among them, particularly noteworthy is the method of filtering introduced by Donoho and co-workers which transforms the signal to the time-scale domain, reduces the high frequency noise by thresholding the wavelet coefficients in the lower scales (associated with the higher frequencies) and then reconstructs the wavelet coefficients back in the time domain. Similar to the above approach, is the wavelet shrinkage method that uses Bayesian priors to associate the noise level with the distortion of the wavelet coefficients for their shrinkage. Even though the reconstructed signal has been shown to be minimax, it is not necessarily suitable for improving the parameter estimates, due to the disconnect between denoising and the parameter estimation process. The Parameter Signature Isolation Method (PARSIM) not only provides the missing link between denoising and parameter estimation but also obviates the need to reconstruct the signal in the time domain due to its sole reliance on the time-scale domain for parameter estimation.

In PARSIM, each model parameter error is estimated separately in isolated regions of the time-scale domain wherein the parameter is speculated to be dominantly affecting the prediction error. Since the parameter error estimates depend on the prediction error in isolated regions, they can benefit from a method that discounts the parameter error estimates according to the estimated distortion of the prediction error at each pixel of the time-scale domain. Such a noise compensation method is described here with results that indicate improvement in the parameter estimates beyond the other filtering/denoising techniques considered here.

Most of noise suppression techniques in the time-scale domain are developed for images and focus on removing additive random noise at all pixels of the time-scale plane. But the assumption of additive noise randomly distributed all all pixels of the time-scale domain, although relevant to images, is not consistent with the noise distribution in the time-scale domain of 1-d signals. As such, these denoising techniques are not directly applicable for improving the parameter estimates. The methods of denoising that can potentially improve PARSIM's performance are those developed for denoising 1-D signals. However, all these methods are developed to produce a viable reconstructed signal in the time domain. It is expected that the elimination of the need to reconstruct the signal as a constraint will lead to much more effective use of the underlying concepts in these denoising methods.

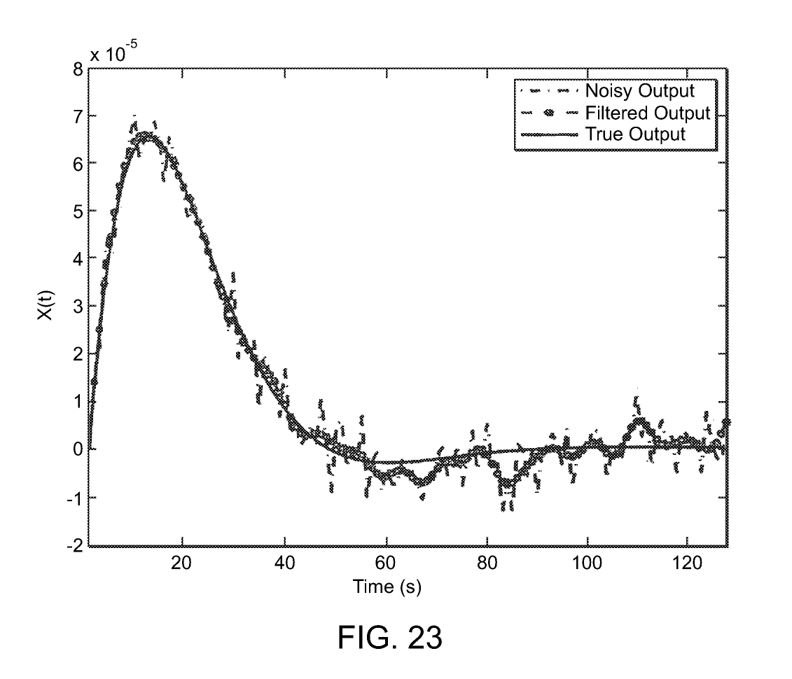

The noise-compensation method proposed here estimates the distortion by noise of the wavelet coefficients of the prediction error, W{ε}. The noise distortion is estimated by relying on both time and scale smoothing and the notion that an estimate of the signal distortion due to noise can be obtained from the difference between the noisy signal and its smoothed version. For an illustration of this notion, one can refer to the three plots in FIG. 23 that show the real and noisy impulse response of the mass-spring-damper model along with its smoothed version by low-pass filtering. It is clear that even though the smoothed signal does not match the true signal, especially in the more choppy segments of the signal, its does provide an estimate of the signal's distortion by noise.

In order to estimate the level of distortion by noise of the wavelet coefficients in different regions of the time-scale domain, the time data at each scale is considered as a signal like the noisy output in FIG. 23. In this light, let us define time and scale smoothing as

Sₛ_{ₗ}(W{f}(tₖ))=S(W{f}(tₖ,sₗ)) t₁≦tₖ≦t_{N} (65)

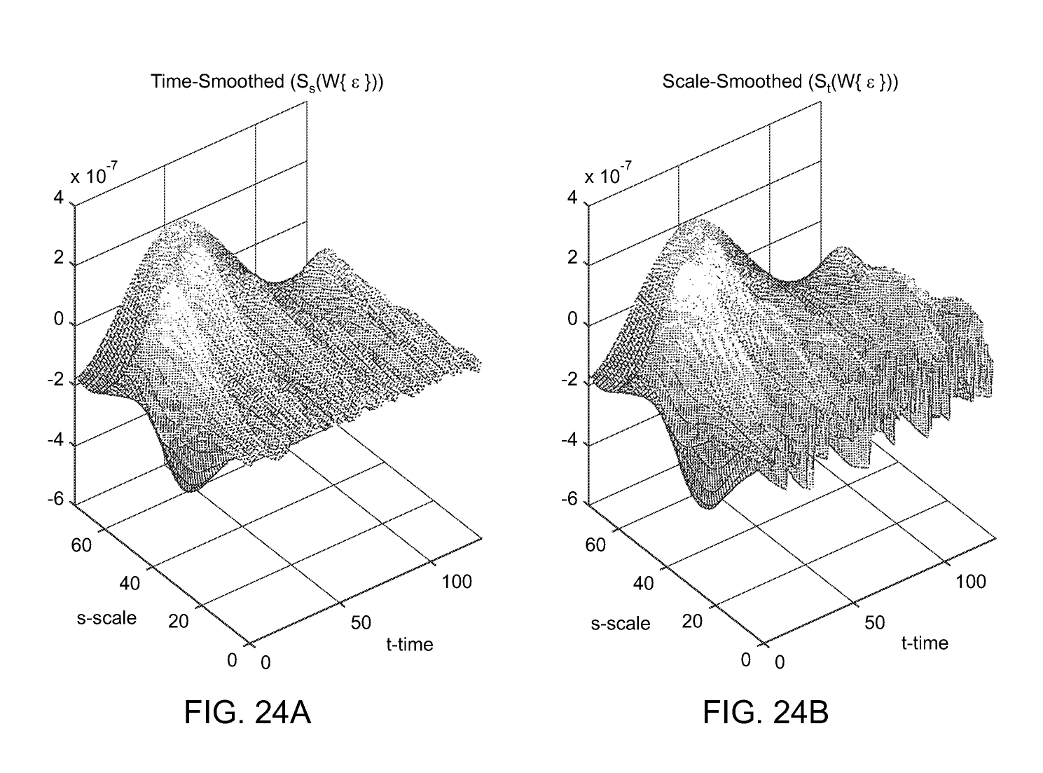

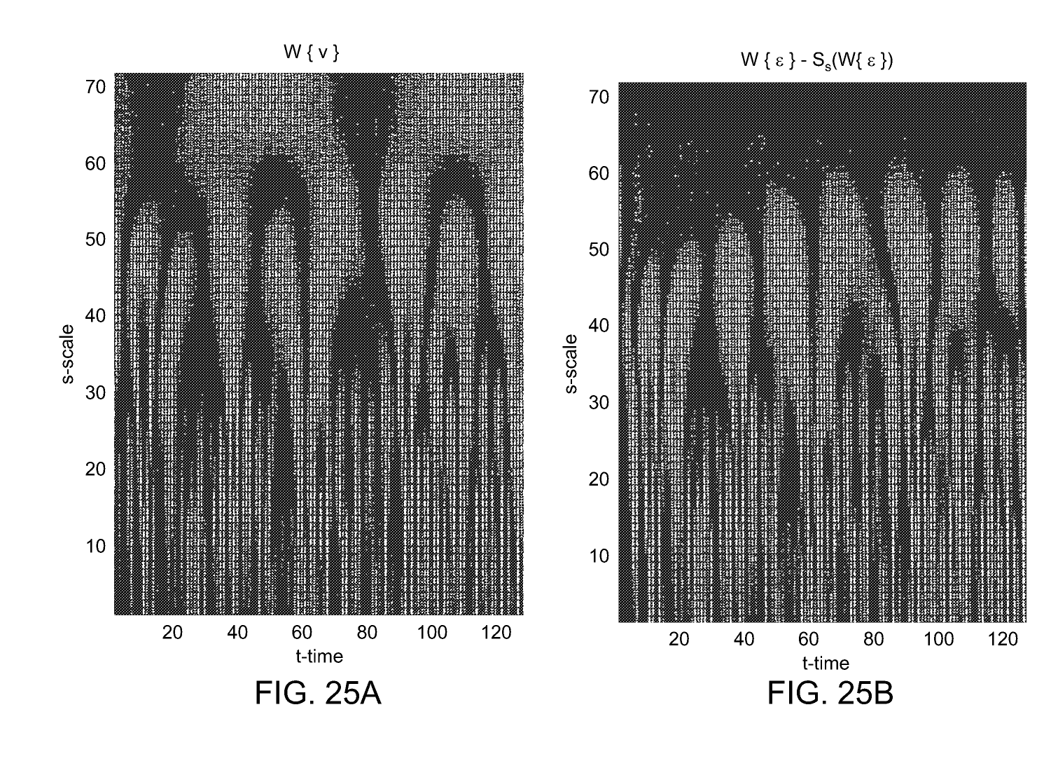

Sₜ_{ₖ}(W{f}(sₗ))=S(W{f}(tₖ,sₗ)) s₁≦sₗ≦s_{M} (66)

where S denotes the smoothing function and Sₛ_{ₗ} the time-smoothed wavelet coefficients along the time samples at scale sₗ. Similarly, Sₜ_{ₖ} denotes the scale-smoothed wavelet coefficients along the scales at time sample tₖ. For illustration purposes, the smoothed W{ε} by an 8th order polynomial fit along scale and time for a sample prediction error ε(t) are shown in FIGS. 24A-24B. It is clear from the results indicate that time-smoothing is more effective than scale-smoothing in reducing the rapid changes in the wavelet coefficients. Using the time-smoothed wavelet coefficients, Sₛ(W{ε}), the distortion by noise at each pixel can be estimated as

Ŵ\hat{{)}\hat{v}{circumflex over (}}=W{ε}−Sₛ(W{ε}) (67)

where Ŵ\hat{{)}\hat{v}{circumflex over (}} denotes the estimate of the wavelet coefficients of noise and Sₛ(W{ε}) represents the time-smoothed wavelet coefficients of the prediction error as defined in Eq. (65) for each pixel.

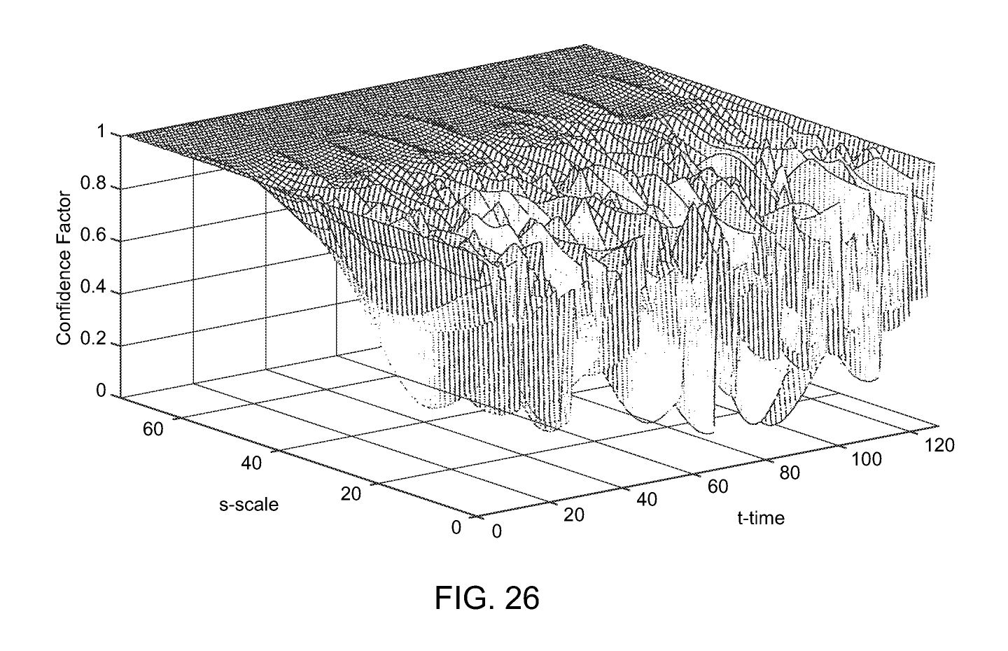

To illustrate this point, let us consider the wavelet transform of the noise in FIG. 23 and its estimate according to Eq. (67), shown in FIG. 26. The two sets of wavelet coefficients indicate that the estimate in Eq. (67) is very similar to reality, particularly in the lower scales where the distortion by noise is the most pronounced. The relatively poor estimate of noise at the higher scales is due to absence of rapid variations of W{ε} at the higher scales which precludes any difference between W{ε} and its time-smoothed version, Sₛ(W{ε}). One can choose to suffice to this estimate assuming that W{ν} is small at the higher scales. On the other hand, one can make an attempt to provide a better estimate of noise at the higher scales. Here scale-smoothing, Sₜ(W{ε}), which can be used to estimate the distortion of the higher scales of W{ε} by mimicking the propagation of noise from the lower scales, can be used in lieu of W{ε} in Eq. (67) to provide a slightly better estimate of noise at the higher scales as

Ŵ\hat{{)}\hat{v}{circumflex over (}}=Sₜ(W{ε})−Sₛ(W{ε}) (68)

The above approximation is, of course, too coarse to be used for denoising the prediction error. Instead, as an estimate of noise distortion of the prediction error, it can be used as a confidence factor in the range [0,1] to discount the parameter error estimates according to Eq. (27). The proposed confidence factor, wₖₗ, which is defined as

$${w}_{kl} = 1 - \vert \frac{\hat{W \{ v \}} ( {t}_{k} , {s}_{l} )}{{max}_{( t , s )} \hat{W \{ v \}}} \vert \qquad ( 69 )$$

can then be incorporated as weights of the prediction error in the estimation of the parameter errors in Eq. (27) to yield the biased parameter estimates as:

$$\hat{Δ {θ}_{ib}} = \frac{1}{{N}_{i}} {\sum }_{k = 1}^{N} {\sum }_{l = 1}^{M} \frac{{w}_{kl} W \{ ɛ \} ( {t}_{k}^{i} , {s}_{l}^{i} )}{W \{ {E}_{i} \} ( {t}_{i}^{i} , {s}_{l}^{i} )} ∀ ( {t}_{k}^{i} , {s}_{l}^{i} ) ∈ {Γ}_{i} \qquad ( 70 )$$

where the subscript b denotes the bias in the parameter error estimates.

For illustration, the confidence factors obtained for the sample prediction error in FIG. 23 are shown in FIG. 26. Using confidence factors such as those in Eq. (56) to bias the parameter error estimates yields the parameter estimates in Table 20 which are shown together with those obtained earlier without the confidence factors. The results show significant improvement in the parameter estimates due to the biased estimates in Eq. (56). What is even more appealing about the proposed noise compensation method is that it can also be used in conjunction with time-filtering. To explore the potential benefit of this two-pronged approach, also shown in Table 20 are the parameter estimates obtained according to Eq. (56) after the prediction error had been filtered with a low-pass filter (Filter 1). The results are clearly more precise than before.

TABLE 20
Twenty-fifth iteration mean estimates of the mass-spring-
damper parameters by PARSIM without and with the confidence
factors before and after filtering the time signal.

| | Parameter Estimates | | |
|---|---|---|---|
| True | | | PARSIM |
| Parameter | | PARSIM | (Filter 1 + |
| Value | PARSIM | (Biased) | Biased) |
| m = 375 | 358 | 361 | 371 |
| c = 9800 | 9606 | 9593 | 9690 |
| k = 130 × 10³ | 128 × 10³ | 130 × 10³ | 132 × 10³ |
| Precision | 0.0518 | 0.0439 | 0.0240 |
| Error | | | |

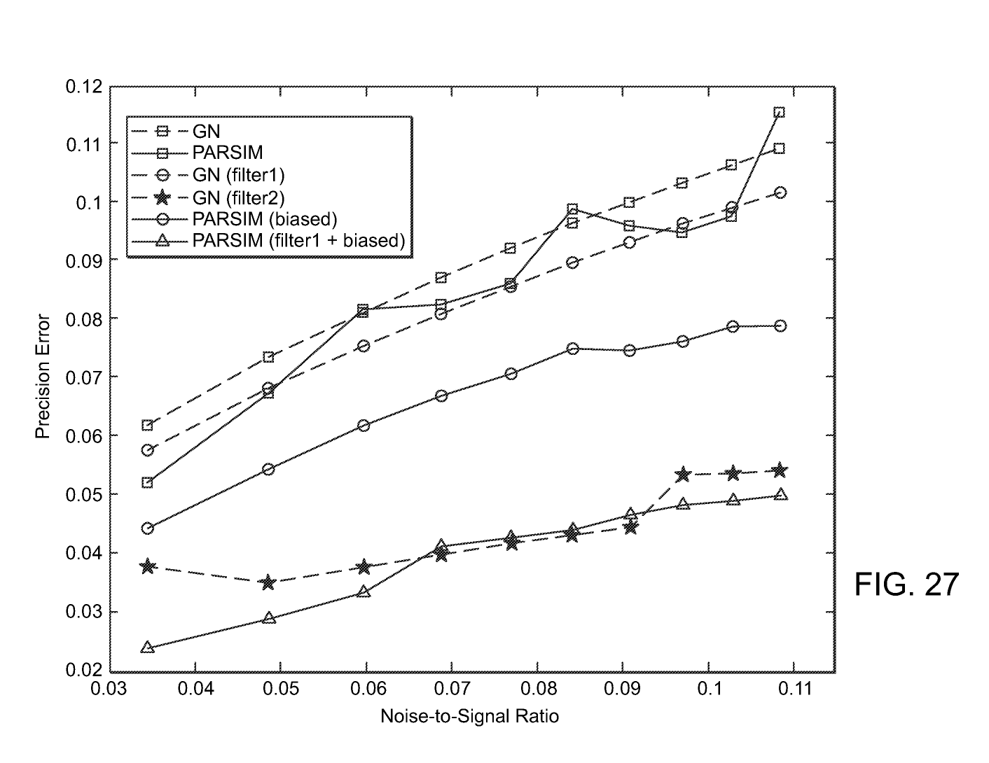

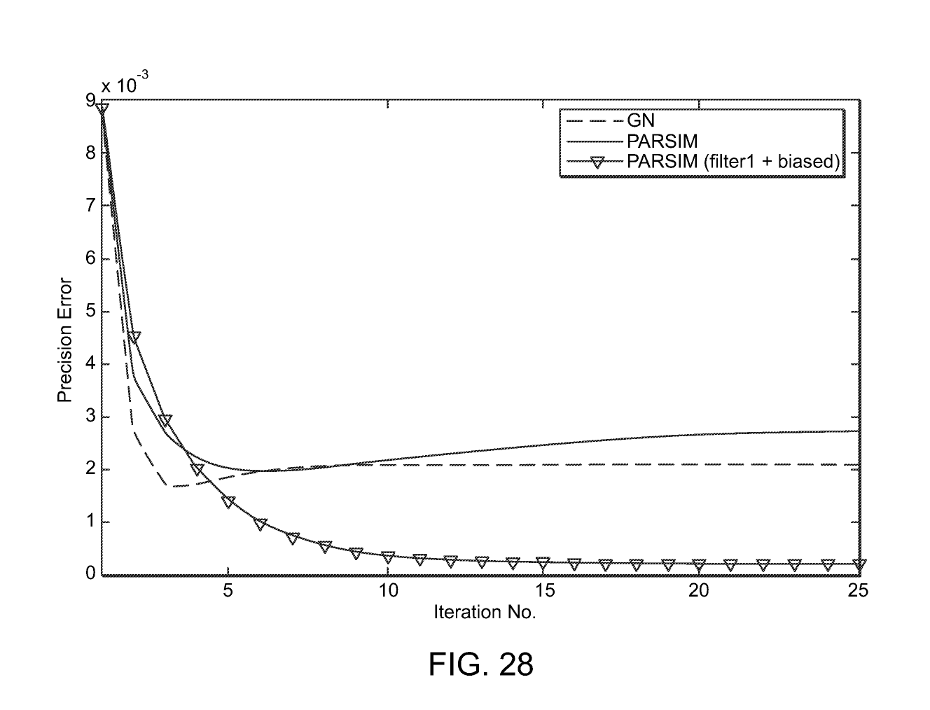

The results reported here, although not comprehensive, demonstrate the effectiveness of the proposed noise compensation method. The improvement in the parameter estimates depends not only on the smoothing method used but also the convexity of the model, the wavelet transform used, the resolution of the time-scale plane (number of time samples and scales used for transformation), as well as the level of noise present in the data. Among these, the level of noise and its effect on the parameter estimates requires further attention. For this, parameter estimates were obtained with different noise levels by both PARSIM and the Gauss-Newton method. The Estimation results obtained with zero mean Gaussian noise of different magnitudes are shown in FIG. 27. The parameter estimates from the Gauss-Newton method were obtained with noisy output, and filtered outputs by a low-pass filter, Filter 1, and a denoising filter based on hard wavelet thresholding of lower frequencies, Filter 2. The estimation results from PARSIM were obtained with the noisy output according to both Eq. (50) and Eq. (56) and with a filtered output, by Filter 1, using Eq. (70). The results indicate that, as expected, all the estimates are adversely affected by the noise level. They also confirm that the Gauss-Newton method benefits from filtering in the time domain and that the most benefit is attained from Filter 2 which performs thresholding of the wavelet coefficients in the time-scale domain. The best overall estimates, however, are still provided by PARSIM using biased estimates with low-pass filtered outputs. Here it should be noted that these results are not necessarily the best that could be obtained with PARSIM. For instance, the smoothing in the time-scale domain, which was obtained with a polynomial fit of the same order at all the noise levels, can be changed to more effectively estimate the noise distortion. It is also be possible to take advantage of a denoising measure like thresholding to better estimate the noise distortion.

Another issue worth evaluating is the type of noise. All the results obtained so far are with additive zero-mean Gaussian noise, so the question arises as whether the proposed method would be as effective with another type of noise, say, one with a uniform distribution. This point was evaluated by repeating the estimates with an output contaminated with additive uniformly distributed noise. For brevity, only shown in FIG. 27 are the estimates from the Gauss-Newton method, PARSIM and biased PARSIM with the low-pass filtered time signal, which show that the biased estimates from PARSIM with the low-pass filtered signal are equally as improved as their counterparts with Gaussian noise.

In systems that are conducive to sensory measurements of different types and/or at different locations, there is often a need to select sensors and/or locations for elimination of redundancy so as to improve computation performance and efficiency, and to reduce sensor cost and maintenance. The case in point is sensor location selection for physical structures that need to be monitored for damage due to natural phenomena such as earthquakes and/or deterioration by age.

Sensors and their locations may be selected according to practical considerations such as ease of measurement, sensor reliability and cost. But these considerations are secondary to the value of information provided by the measurement. A customary approach for assessing this value is though the degree of parameter identifiability provided by the measurements. Parameter identifiability is essential to model updating as a way of evaluating structural deterioration.

The main concern in identifiability analysis is “whether the parameters of a model can be uniquely (globally or locally) determined from data” as defined in Eq. (5). For linear models, structural identifiability is equivalently defined using the model's transfer function, which is independent of the input u(t). However, for nonlinear models, structural identifiability analysis is more difficult, since the test needs to accommodate various model structures. The most recent solutions rely on differential algebra and are algorithmic in nature. Nevertheless, they are concerned with a priori identifiability analysis that assumes adequate excitation and noise-free measurements. Posterior identifiability, on the other hand, involves real data that may be inadequately excited and contaminated with noise.

In the absence of analytical methods for posterior identifiability analysis, empirical criteria have been proposed for measurement (sensor location) selection. Among these, Udwalia proposed the Fisher's information matrix, which is the lower bound of the Cramer-Rao criterion, for assessment of suites of sensor locations. He used the maximum of the information matrix trace as the marker of an optimum suite. Another basis for sensor location is the information entropy, which for linear models and prediction errors represented by independent Gaussian probability density functions is equivalent to the determinant of the Fisher's information matrix. Yet another criterion used for sensor selection is the sensitivity of the prediction error to model parameters, that is equivalent to the sensitivity of the output to the parameters widely considered for input design. In general, the different variants of the information matrix, such as its trace or determinant, are indicators of the dispersion of data and, as such, the uniqueness of information content provided by individual measurements.

The present invention indicates that the dispersion of data can be better differentiated in the time-scale domain by the quality of parameter signatures extracted as follows:

The covariance of any unbiased estimator of a linear system obeys the Cramer-Rao inequality

cov\hat{Θ}≧M_{θ}⁻¹ (71)

where the lower bound M_{θ} is the Fisher's information matrix. That is, an unbiased estimator is said to be efficient if its covariance is equal to the Cramer-Rao lower bound. As such, minimizing this lower bound satisfies the objective of reducing the variance of the estimate for an efficient unbiased estimator of the system, hence a mechanism for output selection.

Formally, the output selection process entails selecting the optimal P-dimensional output suite Y_{O}∈ [symbol] out of a total of M outputs Y_{T}∈ [symbol] where M≧P. This selection can be performed by any of the following strategies: (i) minimizing the trace of M_{θ}⁻¹; i.e., min_{Y}_{_{O}}_{⊂Y}_{_{T}}tr(M_{θ}⁻¹), (ii) minimizing its largest eigenvalue; i.e., min_{Y}_{_{O}}_{⊂Y}_{_{T}}λₘₐₓ(M_{θ}⁻¹), or (iii) minimizing the determinant; i.e., min_{Y}_{_{O}}_{⊂Y}_{_{T}}|M_{θ}⁻¹|.

It can be shown that for a structurally identifiable (Eq. (5) linear-in-parameter model, where each output ŷⱼ=[yⱼ(t₁) . . . yⱼ(t_{N})]^{T}, sampled at tₖ∈[t₁,t_{N}], is defined as

ŷⱼ=Θ*^{T}Φⱼ (72)

in terms of the true parameter vector Θ*=[θ₁*, . . . , θ_{Q}*]^{T}∈ [symbol] and a known matrix Φⱼ∈ [symbol] independent of Θ, if individual measurements yⱼ

y(t)=\hat{y}(t,Θ*)+v (73)

are normally distributed with the mean ŷⱼ and zero mean noise ν with variance σ²I; i.e., yⱼ:N(Θ*^{T}Φⱼ,ρ²I), then the Fisher information matrix has the form

M_{θ}⁻¹=(Φⱼ^{T}Φⱼ)⁻¹ρ² (74)

and the least squares estimator:

\hat{Θ}(Φⱼ^{T}Φⱼ)⁻¹Φⱼ^{T}yⱼ (75)

is the minimum variance unbiased estimator. For this case, then, minimizing |M_{θ}⁻¹| is analogous to minimizing the spread of eigenvalues of Φⱼ or maximizing the spread of its columns.

This concept can be extrapolated to a nonlinear system with locally defined prediction error where the dependence on Θ̅ of the matrix Φⱼ( Θ̅), corresponding with each output, yields a nonlinear-in-parameter formulation for the prediction error and would require an iterative approach to parameter estimation as in nonlinear least squares (NLS).

From the parameter estimates for nonlinear least squares (NLS) in Eq. (32), it is clear that even for nonlinear-in-parameter models the success of parameter estimation is contingent upon the non-singularity of the Jacobian matrix Φⱼ, which corresponds to the distinctness of output sensitivities. As such, the strategy of using measurements that yield the maximum determinant of (Φⱼ^{T}Φⱼ); i.e., minimum (Φⱼ^{T}Φⱼ)⁻¹ adopted for linear models, is also relevant for nonlinear-in-parameter models in that it ensures maximal separation between the output sensitivities and improved local estimation performance by NLS at every iteration of adaptation.

The present systems and methods also adhere to the notion of enforcing maximal separation between the output sensitivities, but instead relies on the quality of parameter signatures to evaluate the separation of output sensitivities provided by each measurement. The relation of parameter signatures to the separation of output sensitivities is discussed below.

Parameter signatures as defined above are a idealism that can only be estimated in practice. We described earlier the simple technique of applying a common threshold to the WT of each output sensitivity W{∂ŷⱼ/∂θᵢ} across the entire time-scale plane to identify those pixels wherein only one W{∂ŷⱼ/∂θᵢ} is nonzero. But a technique that complies more closely with the definition of parameter signatures is to perform a search of the time-scale plane to identify pixels that satisfy the notion of parameter signatures by a dominance factor η_{d}. Such a search for the individual pixels (tₖ,sₗ) takes the form

$$If ( {t}_{k} , {s}_{l} ) \vert \overline{W \{ \partial {\hat{y}}_{j} / \partial {θ}_{i} \}} ( {t}_{k} , {s}_{l} ) \vert > {η}_{d} \vert \overline{W \{ \partial {\hat{y}}_{j} / \partial {θ}_{m} \}} ( {t}_{k} , {s}_{l} ) \vert \\ ∀ m = 1 , … , Q \neq i ⇒ ( {t}_{k} , {s}_{l} ) ∈ {Γ}_{i} \\ where \\ \overline{W \{ \partial {\hat{y}}_{j} / \partial {θ}_{i} \}} = \frac{W \{ \partial {\hat{y}}_{j} / \partial {θ}_{i} \}}{{max}_{( t , s )} \vert W \{ \partial {\hat{y}}_{j} / \partial {θ}_{i} \} \vert} \qquad ( 76 )$$

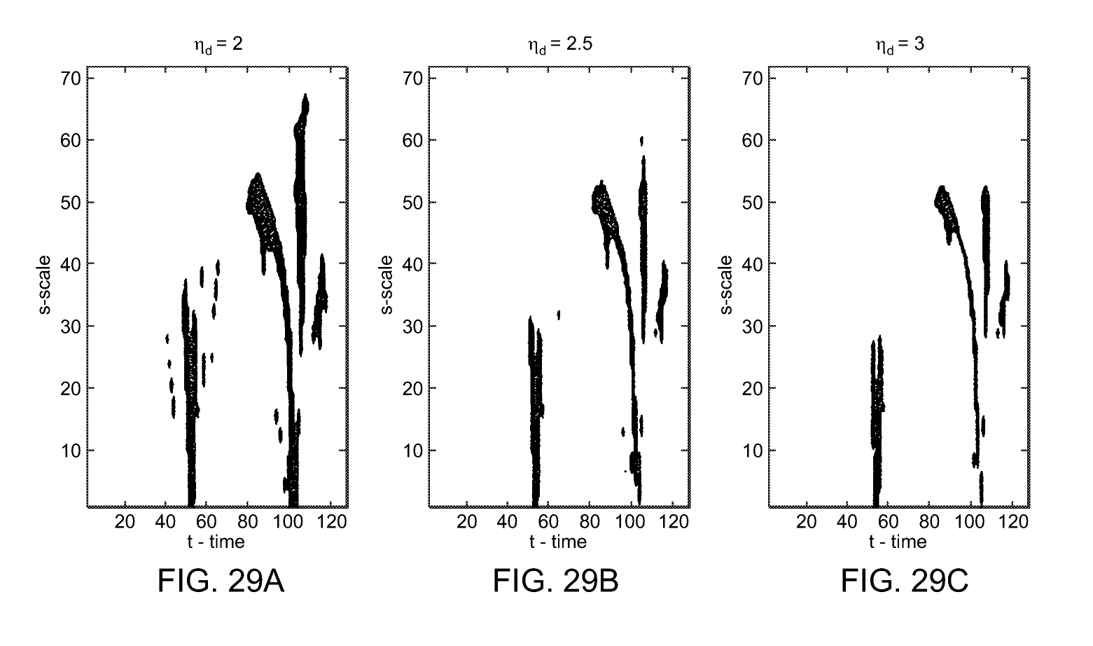

It is clear from (62) that the dominance factor η_{d} affects the location as well as the size of the parameter signatures. This is illustrated via the parameter signatures shown in FIGS. 29A-29C for a parameter at three different dominance factors. The results indicate that as the dominance factor is raised, fewer pixels are included in the parameter signatures. But this is not the only consequence of the dominance factor. As discussed below, the dominance factor also affects the quality of parameter signatures, which can then be used to assess the integrity of data content as the criterion for measurement selection. As observed in FIGS. 29A-29C, using a higher dominance factor to extract the parameter signature in Eq. (76) results in fewer pixels; i.e., Nᵢ in Eq. (50), and therefore affects the value of the estimated parameter error \hat{Δ}\hat{θ}ᵢ in Eq. (50). This raises the question, in turn, as whether the quality of the estimate is also affected by the higher quality pixels included in the parameter signature. To illustrate this point, let us consider the graphical representation of the parameter error estimates in FIGS. 29A-29C obtained at individual pixels of the parameter signatures in FIGS. 29A-29C. Taking note that in this example the desired estimate is positive, it is clear that with the higher dominance factor, there is better consistency among the estimates. That is, with a dominance factor of 2, there are a significant number of estimates scattered in both the positive and negative direction, whereas at the dominance factor of 3 the number of negative estimates decreases and more of the positive estimates approach the desired estimate.

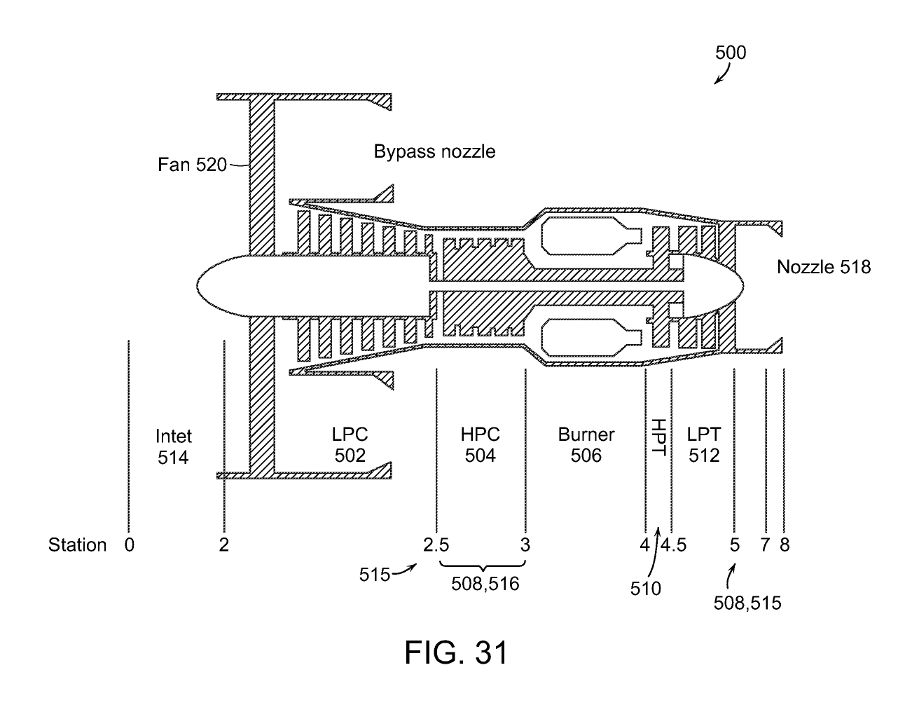

To illustrate the concept of measurement selection based on parameter signatures, let us consider the engine model FANJETPW provided by Pratt & Whitney. FANJETPW is a simplified representation of the NPSS model in Matlab/Simulink™ form. The schematic of the engine 500 represented by this model is shown in FIG. 31 along with the stations where outputs are simulated by the model. The model consists of five modules, the low and high pressure compressors 502, 504 and turbines 510, 512 and the fan 520. Gas entering the system at inlet 514 is compressed, ignited at burner 506 to drive turbines before exiting exhaust nozzle 518. Each module consists of two parameters: efficiency and flow capacity, that are all accessible for perturbations within the model. Various date outputs (sensor data) can be accessed by this model, including pressures, temperatures, and flows at various stations as well as the rotational speed of both the core and the fan. The outputs considered in this are temperature outputs 508 at stations 2.5 (T25), 3.0 (T30), and 5.0 (T50), pressure outputs 516 at stations 2.5 (P25) and 3.0 (P30), the flow outputs 515 at stations 2.5 (W25) and 5.0 (W50), and the rotational speeds of both the core (Nc) and the fan (Nf). For brevity, refer to each parameter and output by an assigned number. The parameters are numbered in the following order: HPC_{Nc}, HPC_{eff}, HPT_{Nc}, HPT_{eff}, LPC_{Nc}, LPC_{eff}, LPT_{Nc}, LPT_{eff}, fan_{Nc}, and fan_{eff}, and the outputs as: Nc, Nf, T25, T50, W25, P25, T30, P30, and W50.

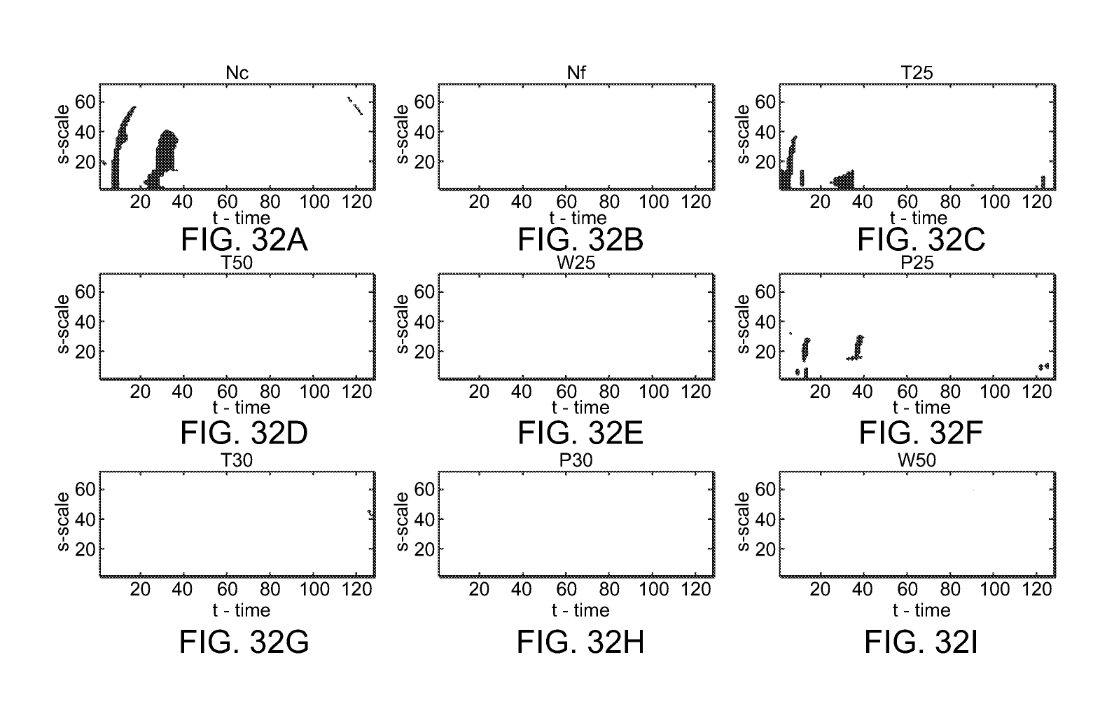

One potential criterion for evaluating parameter identifiability by individual outputs is the existence of parameter signatures. For this the dominance factor used for parameter signature extraction becomes an issue. To illustrate this concept, the parameter signatures extracted for parameter 2, HPC_{eff}, from the 9 outputs at a dominance factor of 2 are shown in FIGS. 32A-32I. The results indicate that there are only four of the outputs, namely Nc, T25, P25, and T30, that yield parameter signatures for this parameter. They, therefore, indicate that this parameter would be identifiable by only four of the outputs, if one were to use the presence of parameter signatures at this dominance factor as the criterion for identifiability.

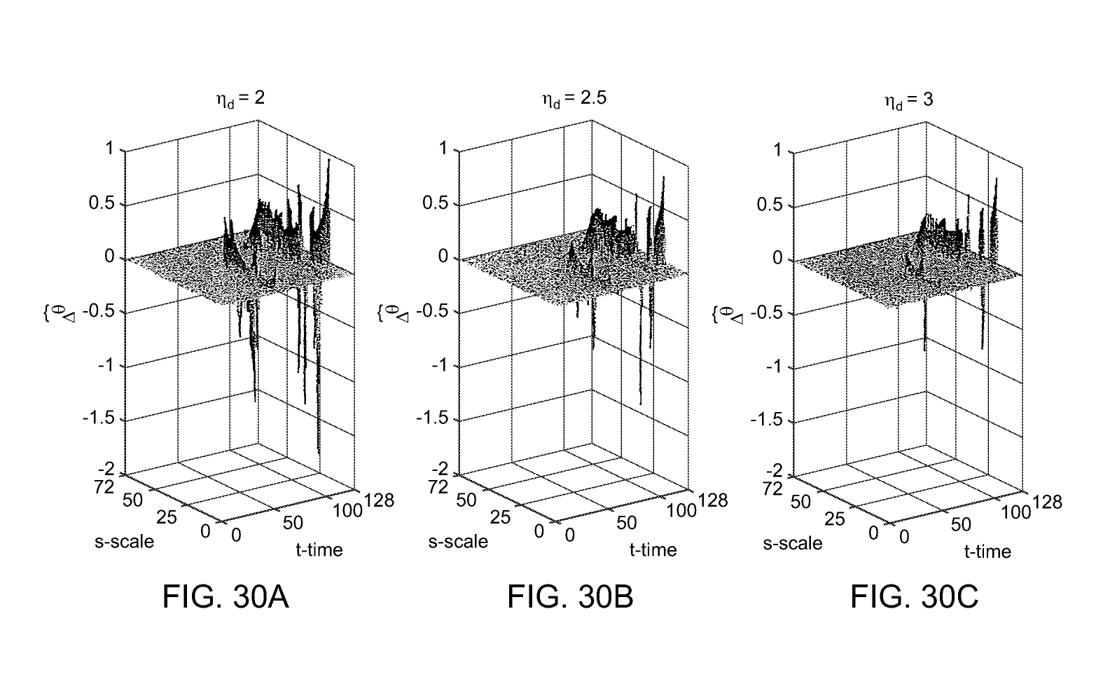

The benefit of increasing the dominance factor is that as the magnitude increases, the parameter signatures become more refined and the consistency of the estimated parameter error across the pixels of the parameter signature is improved, as illustrated in FIGS. 29 and 30A-30C. On the other hand, extreme dominance factors will diminish parameter signatures and will mislead identifiability analysis. There is, therefore, a need to determine the suitable dominance factor for reliable identifiability analysis.

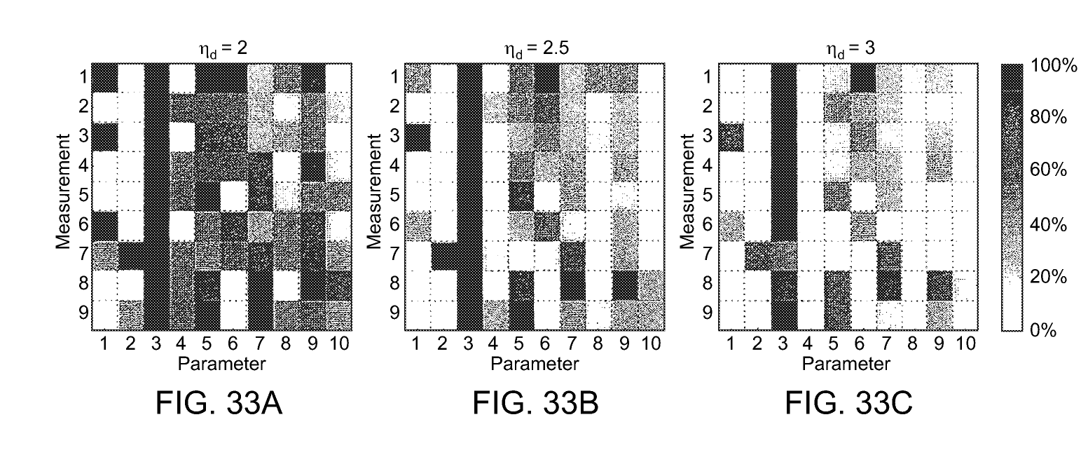

Given the nonlinearity of the system and dependence of the output sensitivities on the nominal parameter vector Θ̅ (see Eq. (13), the extracted parameter signatures are also dependent on the nominal parameters of the model. A possible approach to accounting for the variability of the parameter signatures due to this dependence is to average out the effect of the parameter values. To illustrate the approach, parameter signatures were extracted at ten different nominal parameter vectors randomly generated within ±4% of the original model values. The ratio of instances at which a parameter signature could be extracted is shown in the block corresponding to the output/parameter pair in FIGS. 33A-33C for the three dominance factors of 2, 2.5, and 3. At the dominance factor of 2 most of the measurements yield parameter signatures for most of the parameters at more than 50% of the instances, but the ratios diminish considerably at the dominance factor of 3. Nevertheless, the presence of parameter signatures can be used to determine the identifiability of each parameter by individual measurements. For instance, according to the results in FIGS. 33A-33C for the dominance factor of 2, measurements 1, 2, 7, and 8 are necessary for estimating all the parameters.

High quality engineered products, like turbojet engines, rely upon computer-based simulation models to benchmark and optimize process behavior. Whereas these simulation models embody the physical knowledge of the process, they are in qualitative agreement with it. However, even when qualitative reliability is ascertained, there is need for a tuning stage whereby the model parameters (i.e., model coefficients and exponents) are adjusted so as to improve the accuracy of simulation relative to the experimental data (e.g., deck-transients) available from the process.

The simulation models developed for propulsion systems are commonly modeled via the simulation software package Numerical Propulsion System Simulation (NPSS), developed by NASA in partnership with leaders in the propulsion industry. The simulation software relies on models of the aero-thermodynamics of the physical system and is capable of performing transient studies to evaluate the dynamic response of engines. Heat transfer, rotor, and volume dynamics are included in the dynamic simulation. The goal of the NPSS high-fidelity engine simulations is to enable engine manufacturers to numerically evaluate engine performance interactions, prior to building and testing the engine, and to subsequently use the simulation calibrated to the built engine to estimate inaccessible performance specifications.

Each simulation consists of modules which represent the equivalent components of the propulsion system. For example, a single spool turbo-jet engine can be modeled with a single shaft, compressor module, a burner module, a turbine module and a nozzle. Depending on the level of fidelity demanded from the model, ducts, bleeds, and horsepower extraction can also be added. The simulation is driven by a quasi-Newton-Raphson solver employing the Broyden method to update the Jacobian matrix used to balance inputs and outputs between modules and to maintain continuity through the gas-turbine. Once the Jacobian is generated, it is used to provide a search direction for the Newton-Raphson iteration, while convergence is defined by remaining continuity errors in the nonlinear model. The Jacobian is retained until the simulation exceeds a predefined convergence criterion at which time a new Jacobian is generated. This is also the case with simulation in dynamic mode where the transient response of gas-turbine is sought. In this case, the Jacobian generated by the solver is not too different for each time-step until it is updated because of violation of the predefined convergence criterion.

The outputs of the modules are primarily flows, pressures and temperatures. The module itself consists of maps and equations. Behavior of the modules in gas-turbine simulations differ only in the performance of the individual components, i.e., in the case of the turbine, the ratio of work extracted from the gas stream to drive the compressor and the work used to accelerate the stream itself. To adjust simulations, map scalars (also known as engine deviation parameters (EDPs) or health parameters) are incorporated in the embedded maps of the various modules to adjust their performance. In the case of the turbine module, these map scalars represent deviations in efficiency and turbine area. To perform simulation tuning, delta scalars in the form of adders and multipliers are applied to the map scalars. For fault diagnosis, the map scalars are estimated by Kalman filters to indicate the deviation of the engine from its normal behavior, as represented by the model. Further details describing the use of the present system and methods can be found in McCusker et al., “Measurement Selection for Engine Transients by Parameter Signatures,” Journal of Engineering for Gas Turbines and Power, Vol. 132, 121601-1 (December 2010), the entire contents of which is incorporated herein by reference.

Based on the results presented and its description, PARSIM has two distinguished properties relative to nonlinear least squares (NLS). The first property is independence of its solution from the contour of the prediction error and its gradient that can be potentially useful in evading local minima. The second property is potential dormancy of estimation when parameter signatures cannot be extracted. Therefore, one advantage of the integration of PARSIM with NLS is the added propensity to evade local minima. The second advantage is to ensure continual estimation that is provided by NLS. The approach taken here relies on the integration of PARSIM and NLS through a competitive mechanism whereby the two solutions are evaluated concurrently after every so many adaptation iterations by the two methods to evaluate their effectiveness in reducing the prediction error.

To evaluate the effectiveness of the proposed hybrid approach, the engine model FANJETPW provided by Pratt & Whitney Company was used. FANJETPW is a simplified representation of the NPSS model in Matlab/Simulink™ form. The schematic of the engine represented by this model is shown in FIG. 31 along with the stations at which outputs are simulated by the model. The model consists of five modules, the low and high pressure compressors and turbines, and the fan. Each module consists of two map scalars, efficiency and flow capacity, that need to be estimated for calibration of the model according to deck transient outputs. Various outputs can be accessed by this model, including pressures, temperatures, and flows at various stations as well as the rotational speed of both the core and the fan. The outputs considered in this study are temperature outputs at stations 2.5 (T25), 3.0 (T30), and 5.0 (T50), pressure outputs at stations 2.5 (P25) and 3.0 (P30), the flow outputs at stations 2.5 (W25) and 5.0 (W50), and the rotational speeds of both the core (N1) and the fan (N2).

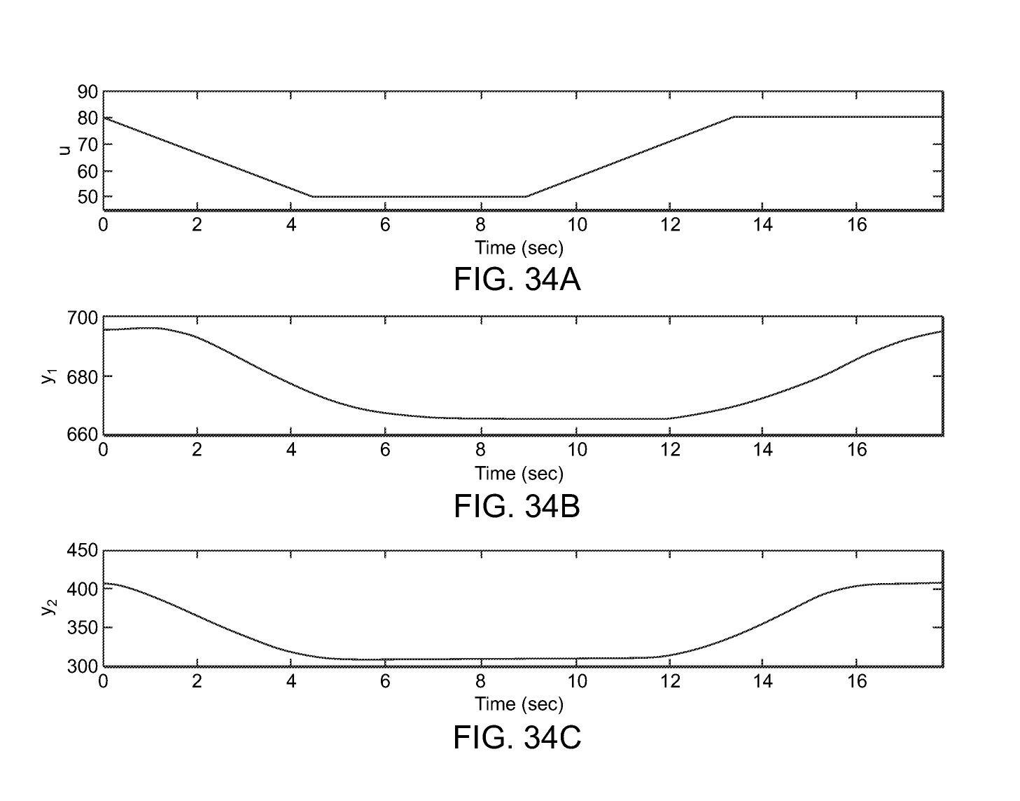

In the absence of actual deck transient data, the model outputs obtained at a set of map scalars (emulating Θ* in Eq. (4)) were used in lieu of measured deck transients. The input (Power Lever Angle (degrees)) used for generating the transients along with two of the outputs (Temperature at Station 2.5 (° R) and Pressure at Station 3 (psia)) are shown in FIGS. 34A-34C.

An issue that needs to be considered in the application of PARSIM is the integration of potentially different parameter error estimates obtained from different outputs according to Eq. (50). To provide an illustration of this point, a snapshot of the parameter error estimates for four map scalars at one iteration of PARSIM is shown in Table 21 which indicates that the parameter error estimates differ not only in magnitude but also in direction. This calls for a method to consolidate the parameter error estimates into one, so that a single parameter error estimate can be used in Eq. (34). For this, the approach in multi-objective optimization can be adopted wherein different weights are applied to the parameter error estimates from different outputs. The implementation of such strategy in PARSIM would yield the following adaptation rule, in lieu of the adaptation rule in Eq. (34),

$${\hat{θ}}_{i} ( q + 1 ) = {\hat{θ}}_{i} ( q ) + \frac{1}{P} {\sum }_{p = 1}^{P} {μ}_{i}^{P} ( q ) {\hat{Δ θ}}_{i}^{p} ( q ) \qquad ( 77 )$$

wherein the adaptation step size μ is replaced with the weighted sum of the adaptation step sizes associated with individual outputs. In the above formulation, the superscript p specifies the output and P is the total number of outputs considered.

TABLE 21
The [symbol] values obtained for four map scalars
(HPC_{eff}, HPT_{eff}, LPC_{eff}, LPT_{eff}) from nine different outputs.

| Output | HPC_{eff} | HPT_{eff} | LPC_{eff} | LPT_{eff} |
|---|---|---|---|---|
| Nc | 0 | 0 | 0.0269 | −0.0002 |
| Nf | 0.0088 | −0.0032 | 0.0191 | −0.0132 |
| T25 | 0.006 | 0.0024 | 0.0119 | −0.005 |
| T50 | −0.0062 | 0.0103 | 0.0212 | 0 |
| W25 | −0.033 | 0.0132 | 0.0481 | −0.0088 |
| P25 | 0.0052 | 0 | 0.0342 | −0.0048 |
| T30 | 0.0112 | −0.0003 | 0.0086 | −0.0001 |
| P30 | 0 | 0.0064 | 0.0476 | −0.0004 |
| W50 | 0.0114 | 0.0148 | 0.0481 | −0.0067 |

Two different approaches have been demonstrated here for selecting the adaptation step size μᵢ^{p}(q) in Eq. (77). The first approach associates μᵢ^{p} with the level of correlation of the corresponding parameter effect with all the other parameter effects, to relate the adaptation step size to the quality of the extracted parameter signature. It is computed as

Approach 1: μᵢ^{p}(q)=1−max|ρᵢⱼ^{p}(q)| ∀j≠i (78)

where ρᵢⱼ^{p}(q) refers to the correlation coefficient between parameter effect Eᵢ and parameter effect Eⱼ for output p. The second approach uses the number of pixels of the parameter signature as the measure of its quality, and computes the adaptation step size as

$$Approach 2 \text{:} {μ}_{i}^{p} ( q ) = \frac{{N}_{i}^{p}}{{\sum }_{p = 1}^{P} {N}_{i}^{p}} \qquad ( 79 )$$

The consolidated \hat{Δ}\hat{θ}ᵢ values using the above approaches are shown in Table 22. The results indicate that the \hat{Δ}\hat{θ}ᵢ from the two approaches are consistent in direction and that those associated with Approach 1 are significantly lower than the ones with Approach 2. Given the stringent design tolerances of the FANJETPW simulation model, which do not allow large parameter adjustments to the model, Approach 1 is selected as the consolidation choice for the remainder of the analysis. However, this is a case-specific choice, since Approach 2 may offer a quicker convergence solution to the parameter estimation problem.

TABLE 22
1The consolidated [symbol] values obtained for
four map scalars (HPC_{eff}, HPT_{eff}, LPC_{eff}, LPT_{eff})
from the two approaches in Eqs. (64) and Eq. (65).

| Approach | HPC_{eff} | HPT_{eff} | LPC_{eff} | LPT_{eff} |
|---|---|---|---|---|
| 1 | 0.0005 | 0.0062 | 0.0295 | −0.0049 |
| 2 | 0.0168 | 0.0173 | 0.0436 | −0.0141 |

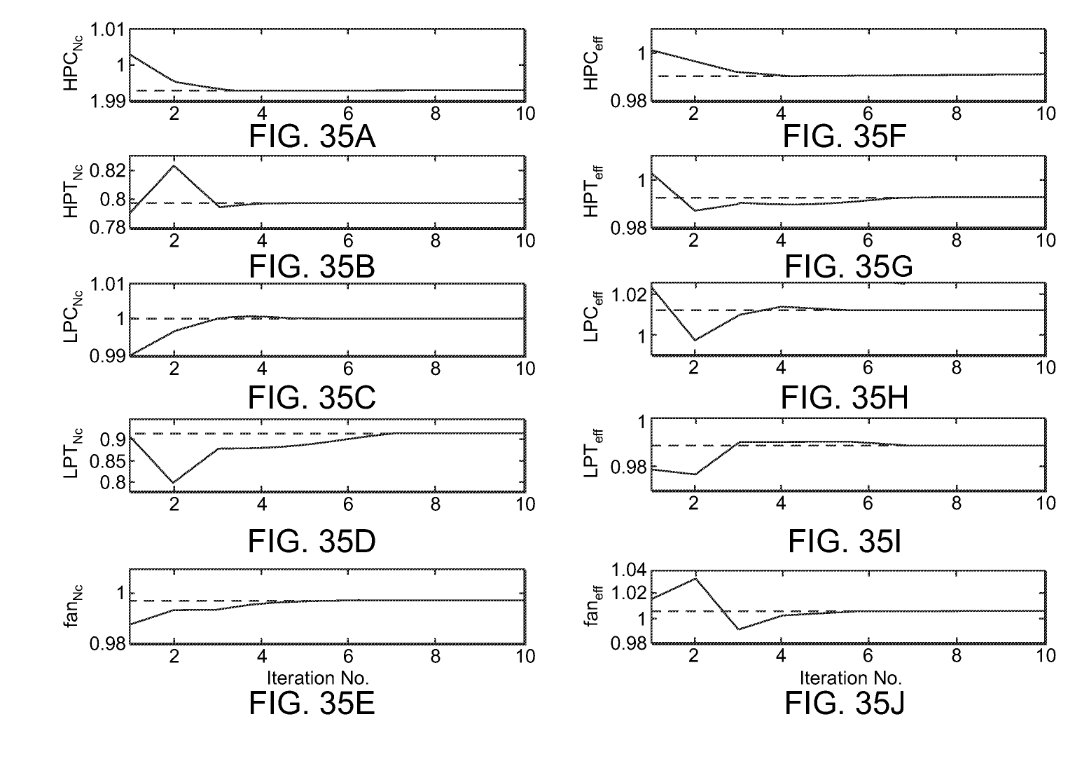

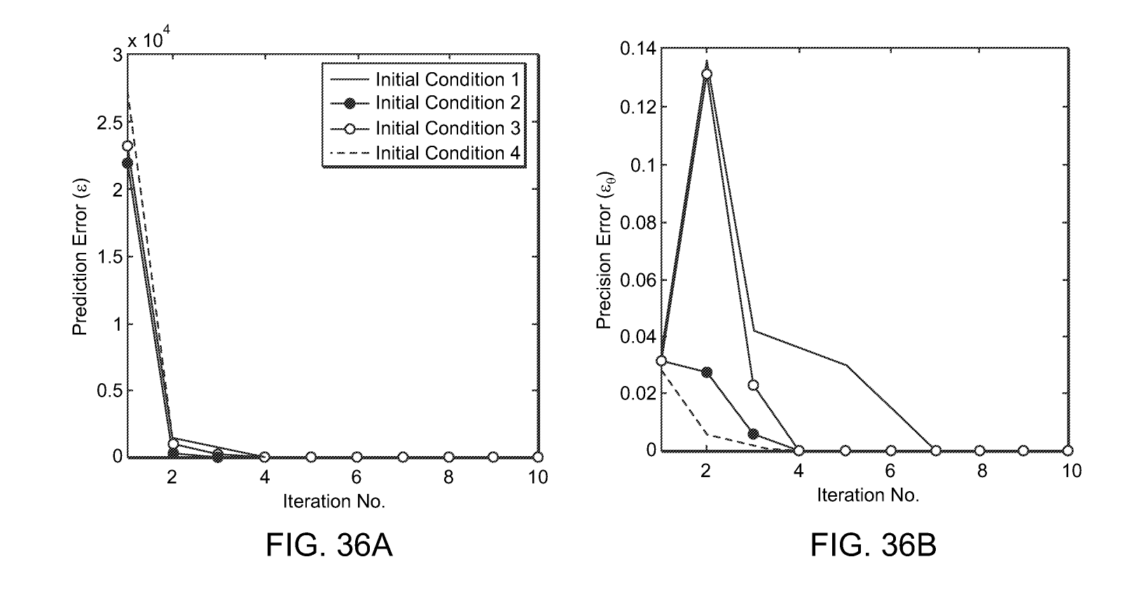

The hybrid approach was applied to the FANJETPW simulation model by estimating all ten map scalars based on the nine available outputs. Four different sets of initial parameter values within ±1% of the true map scalars were used to ascertain the robustness of the adaptation approach to nominal conditions. The parameter estimates obtained from one set of initial parameter values by iterative adaptation of the hybrid method are shown in FIGS. 35A-35J. Shown in FIGS. 36A-36B are the prediction error and precision error of the estimates for all four initial parameter sets. The results in FIG. 35 indicate that the hybrid approach rapidly reduces both the prediction and precision errors. It is worth noting that unlike the prediction error in FIGS. 36A-36B, which continually decreases over the first few iterations in all cases, the precision error rises drastically in two of the cases before decreasing. This phenomenon is a byproduct of using prediction error as the selection criterion in the hybrid approach. Unlike PARSIM which focuses on reducing individual parameter errors, NLS is designed to reduce the prediction error alone. As such the NLS solution is often preferred when both PARSIM and NLS offer viable solution trajectories and the prediction error comprises the sole selection criterion.

As a side note to this analysis, it is important to note that a major limitation in adaptation of the FANJETPW model was the sensitivity of the simulation routine to combinations of parameter values. Since this model is dependent on derivative maps that are obtained experimentally, simulation would fail when posed by parameter values outside this map. As a result, it was difficult to perform estimation runs with initial parameter sets beyond ±1%.

The results presented above were obtained with all nine outputs to ensure maximal identifiability for the parameter. However, this raises the question as to how many of the outputs are needed for identifiability and which combinations of outputs are adequate for parameter estimation. Although not explored here, the transparency afforded by PARSIM through the quality of parameter signatures obtained from individual outputs provides a reliable lead into output selection and identifiability analysis. For instance, by observing the parameter signatures it becomes clear that no parameter signature can be obtained for the flow capacity of the High Pressure Turbine (HPT_{Nc}) and that parameter signature associated with the flow capacity of the Low Pressure Turbine (LPT_{Nc}) is of low quality, as indicated by the sparse pixels within the parameter signature. This can be explained by the lack of a sensor located at station 4.5 which makes it difficult to separate the parameter effects (output sensitivities) with respect to the efficiencies of HPT and LPT. Because the compressor and turbine share a common drive shaft, there is considerable coupling between the compressor/turbine pairs. As a result of this coupling, HPT_{Nc} should be observable from sensors measuring the inlet conditions of the HPC. However, E_{HPT}_{_{Nc}} would be hard to separate from E_{HPC}_{_{Nc}}. This mis-accounting historically has been of great concern. Other techniques, such as Kalman filtering, used to estimate these parameters related to the HPC/HPT suffer from this same handicap. Since station 4.5 of the Gas-turbine engine is a location of high temperatures and high degree of flow turbulence, measurements in this area suffer from a high degree of measurement uncertainty and low reliability.

Tuning controllers continues to be of interest to process industry, and among the controllers used, proportional-integral-derivative (PID) control is the most popular. Some of the manual tuning methods for PID control, such as Ziegler-Nichols, rely on the ‘ultimate point’ of the system's Nyquist plot that is obtained either at the critical gain of a proportional controller or by replacing the controller with a relay. Even though the relay feedback approach avoids operation of the process near instability, it is still only applicable to plant structures that underly the Ziegler-Nichols method.

As an alternative to manual tuning of PID controllers, the method of Iterative Feedback Tuning (IFT) has been developed which iteratively adapts the parameters of a controller with fixed structure to minimize a cost function of the form

$$J ( Θ ) = \frac{1}{2 N} E [ {\sum }_{t = {t}_{1}}^{{t}_{N}} {( {L}_{y} {\tilde{y}}_{t} ( Θ ) )}^{2} + λ {\sum }_{t = {t}_{1}}^{{t}_{N}} {( {L}_{u} {u}_{t} ( Θ ) )}^{2} ] \qquad ( 80 )$$

where E denotes expected value and Θ represents the vector of controller parameters. The cost function J comprises two components: the performance error, \tilde{y}ₜ(Θ), between the closed-loop step response of the system, yₜ(Θ), and its desired response, yₜ^{d}, as

\tilde{y}ₜ=yₜ^{d}−yₜ (81)

and the control effort, uₜ(Θ). The functions L_{y} and Lᵤ denote frequency weighting filters that can be used for noise suppression, λ is the weight of the control effort relative to performance error in the cost function, and N denotes the number of data points. A mask in the form of a time-window can be applied to \tilde{y}ₜ and/or uₜ, through the selection of t>t₁ as the lower bound of summation in (58), so as to neglect the initial transient in favor of attaining a closer match of the steady state value and a shorter settling time. Given that the above cost function is nonlinear-in-parameter, the tuning formulation

$$\hat{Θ} = arg {min}_{Θ} J ( Θ ) \qquad ( 82 )$$

defines a nonlinear optimization problem, which in IFT is sought through nonlinear least-squares (Gauss-Newton method). However, regardless of the solution method used, the above formulation of controller tuning is based on the compaction of the performance error/control effort into a scalar cost function.

In application to controller tuning, PARSIM offers several potential advantages to time-based controller tuning. One advantage is the capacity to extend masking of frequency in addition to time. Another advantage is the availability of an alternative solution trajectory to the one by IFT. A third potential advantage is the capacity to implement noise compensation strategies available in the time-scale domain. The performance of PARSIM is demonstrated in application to the benchmark plants in. Next, its capacity in masking frequency together with time is demonstrated in improving the system response. Finally, a hybrid method of controller tuning is implemented to integrate PARSIM with IFT for added robustness of the controller tuning solution.

To analyze PARSIM's performance in controller tuning, its performance is first evaluated in application to the four benchmark plants discussed in the literature. Next, the additional degree of freedom available to PARSIM in masking frequency is demonstrated. Finally, the solution trajectory by PARSIM is contrasted with that of IFT and a hybrid method of controller tuning is implemented to improve upon the performance of both.

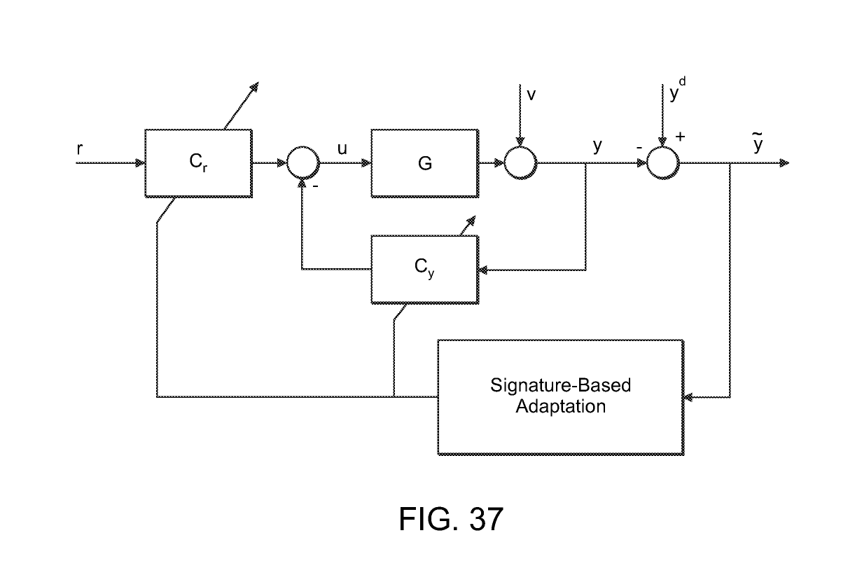

Tuning the controllers by PARSIM is depicted in FIG. 37. Like IFT, PARSIM does not require knowledge of the plant, nor does it require any particular controller form. The only requirement is that the desired output y^{d} be attainable by the closed-loop system considered. As a first step in the evaluation of PARSIM, its performance is tested in application to the benchmark plants considered in the literature. For this, the plants shown in Table 16 were used one at a time as G in the system shown in FIG. 36. The sampling time was chosen so as to generate 128 data points for the span of simulation. PARSIM was then used to tune the controller parameters for each plant, using as target y^{d} defined as

$${y}^{d} = {L}^{- 1} \{ \frac{1}{s} \frac{1}{s + 1} {e}^{- 10 s} \} \qquad ( 83 )$$

For comparison, the parameters of the control system were also tuned by the Gauss-Newton method, which was verified to produce the same results as IFT for a step target output applied to G₁(s) in Table 23. Controller parameters were adapted by IFT as

\hat{θ}(q+1)=\hat{θ}(q)+μ\hat{Δ}\hat{θ}(q) (84)

where

\hat{Δ}\hat{θ}=(φ_{T}φ)⁻¹φ^{T}\tilde{y}ₜ (85)

with φ=[E₁(t,u(t),\hat{θ}),E₂(t,u(t),\hat{θ}),E₃(t,u(t),\hat{θ})].

TABLE 23
Transfer function of the four benchmark plants
considered in the literature.
$\begin{matrix}{G}_{1} ( s ) = \frac{1}{1 + 20 s} {e}^{- 5 s} {G}_{2} ( s ) = \frac{1}{1 + 20 s} {e}^{- 20 s} \\ {G}_{3} ( s ) = \frac{1}{{( 1 + 10 s )}^{8}} {G}_{4} ( s ) = \frac{1 - 5 s}{( 1 + 10 s ) ( 1 + 20 s )}\end{matrix}$

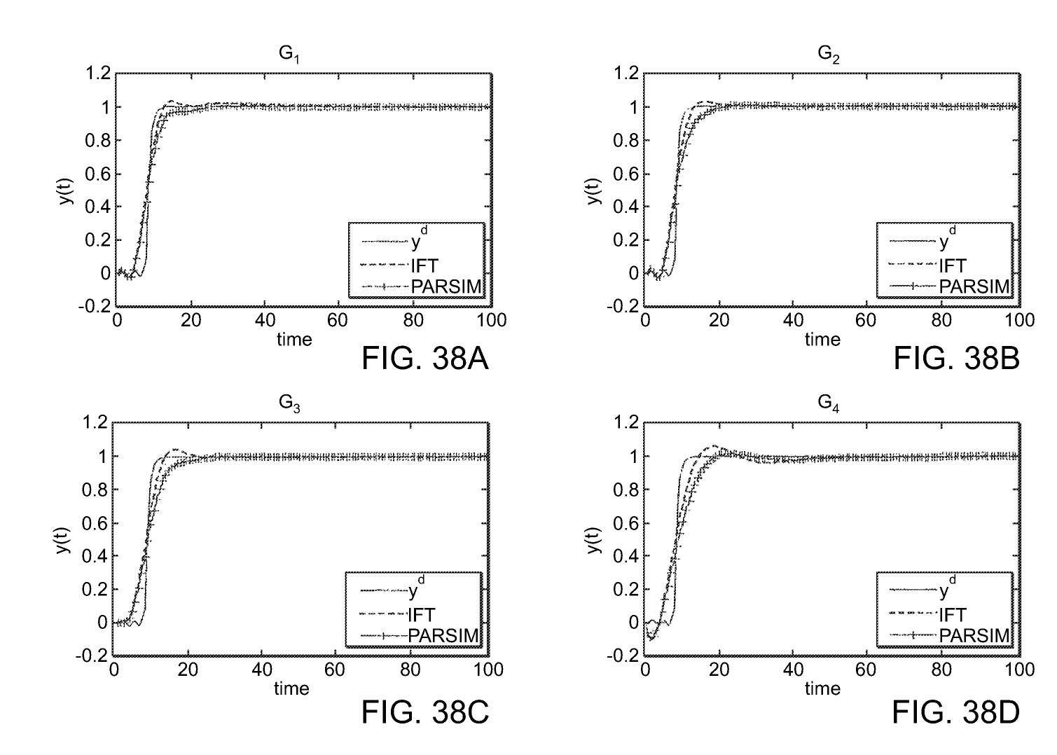

As in the literature, the initial parameter values of each adaptation run were those obtained by the Ziegler-Nichols method, as referenced in the literature. The adaptation trials by both methods were conducted with the adaptation step size of μ=0.5. With PARSIM, a threshold level of η=0.20 was used in Eq. (26). For each case, the parameter values obtained after 25 adaptation iterations of PARSIM are compared with their counterparts from IFT as well as with those from Ziegler-Nichols (ZN), the Integral Square Error (ISE), the Internal Model Control (IMC) and Iterative Feedback Tuning (IFT) in Table 24. Also the system responses according to the parameter values by PARSIM and IFT in Table 24 are shown in FIG. 37, with the corresponding control efforts shown in FIGS. 38A-38D. Although both IFT and PARSIM provide the capacity to mask the time data, the results in Table 24 are obtained using the entire time data.

TABLE 24
1 PID parameters obtained by PARSIM and IFT for the four plants in Table 23.
For comparison, also shown are the parameter values from four other tuning
methods reported in the literature.

| Tuning | G₁ (s) | | | G₂ (s) | | | G₃ (s) | | | G₄ (s) | | |
|---|---|---|---|---|---|---|---|---|---|---|---|---|
| Method | K | Tᵢ | T_{d} | K | Tᵢ | T_{d} | K | Tᵢ | T_{d} | K | Tᵢ | T_{d} |
| ZN | 4.06 | 9.25 | 2.31 | 1.33 | 30.95 | 7.74 | 1.10 | 75.90 | 18.98 | 3.53 | 16.80 | 4.20 |
| ISE | 4.46 | 30.54 | 2.32 | 1.36 | 36.44 | 8.11 | 1.26 | 74.10 | 26.30 | 3.53 | 28.75 | 4.20 |
| IMC | 3.62 | 22.43 | 2.18 | 0.94 | 30.54 | 6.48 | 0.76 | 64.69 | 14.37 | 3.39 | 31.59 | 3.90 |
| IFT | 3.28 | 24.12 | 1.91 | 0.88 | 28.01 | 5.45 | 0.64 | 50.40 | 15.56 | 2.11 | 38.89 | 3.14 |
| PARSIM | 3.00 | 26.01 | 1.96 | 0.77 | 27.64 | 6.37 | 0.55 | 50.61 | 17.94 | 1.79 | 36.50 | 4.02 |

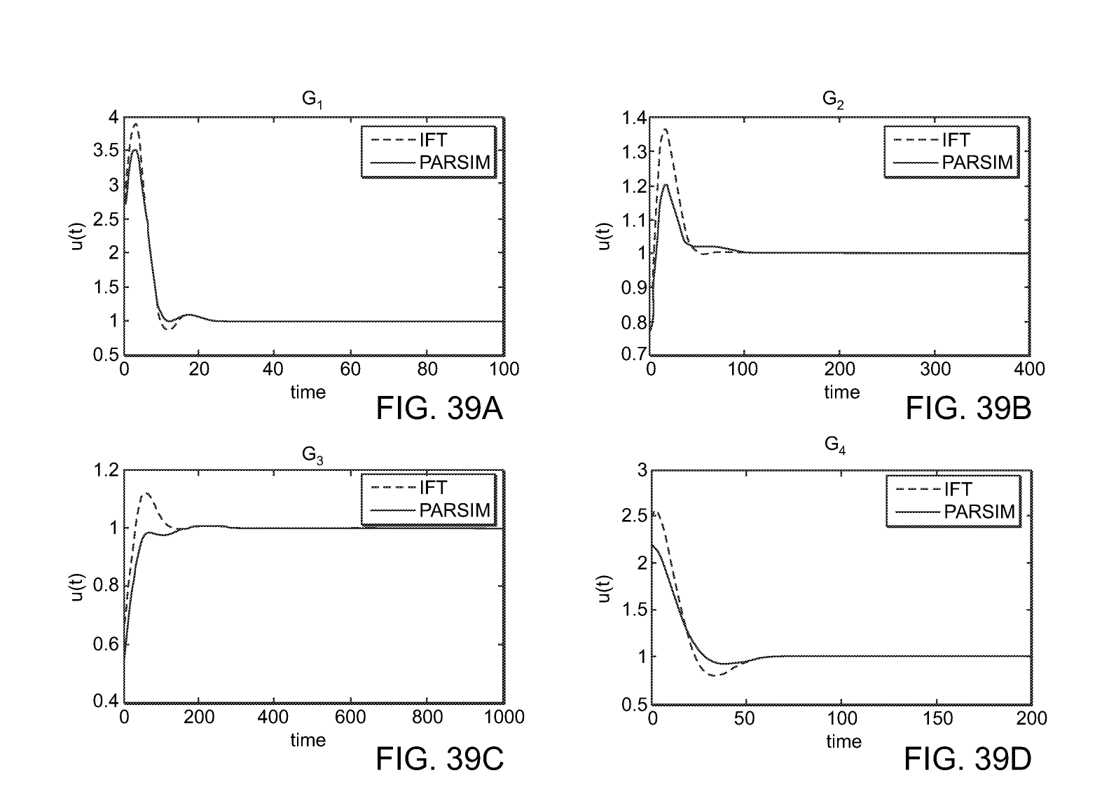

The results in Table 24 indicate that the parameter values by PARSIM and IFT are in general agreement. Here it should be noted that the controller parameters by IFT reported here are different from those in the literature because of the different target responses used in the two methods, the exclusion of masks and the absence of the control effort in all the cost functions here. The closed-loop responses of the four systems in FIGS. 38A-38D indicate that PARSIM, like IFT, provides a close approximation of the target response. The results in FIGS. 39A-39D, however, indicate that the control efforts by PARSIM are smaller than those by IFT. Although this is a beneficial feature in controller tuning, it cannot be ascertained as a generic characteristics of PARSIM, since it does not rely on any minimization strategies that would result in such a feature. The results, nevertheless, indicate that PARSIM provides as effective a replication of the desired response as IFT for the four benchmark plants considered.

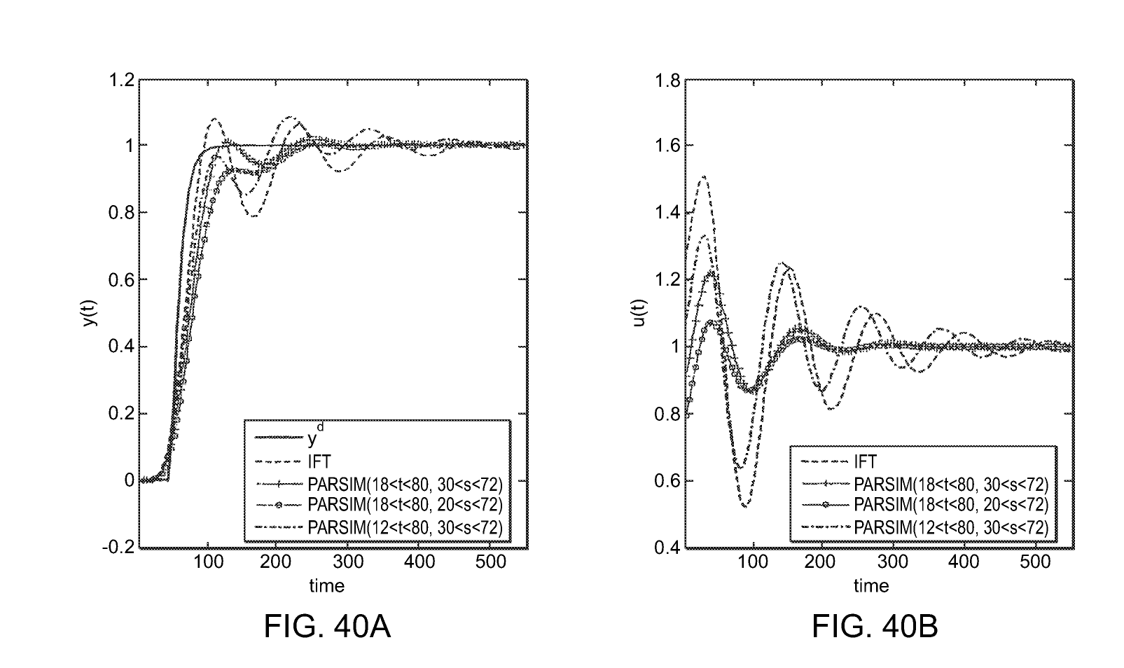

PARSIM also provides the capacity to consider specific regions of the time-scale domain for parameter signature extraction, reminiscent of the ‘masks’ in IFT and in Extremum Seeking Control. To illustrate this point, the plant G₃ in Table 17 is considered again but with a different simulation time span to make target matching more challenging, hence, the motivation for applying the masks. The difficulty to match the target response y^{d} in Eq. (69) is indicated by the response of the IFT-tuned system in FIGS. 40A-40B. This difficulty can of course be interpreted as a model mismatch and, therefore, a violation of the assumption in Eq. (4). However, as is also shown in FIG. 40A-40B, this difficulty can be mitigated by limiting the parameter signatures to specific regions of the time-scale domain. The results in FIGS. 40A-40B indicate that a better replication of the desired response can be achieved by this restriction, analogous to the time-windowing of the performance error provisioned in IFT. According to the results, the time range (12<t<80 vs. 18<t<80) has a more direct relation to the settling time than the scale range. On the other hand, the scale range seems to influence the oscillation of the system response more (20<s<72 vs. 30<t<72), which is expected from the direct relation between scale and frequency. Here we have only shown the different results achieved by this exercise without any attempt to link the time-scale regions to various aspects of the system response. Establishing such a link, which is the subject of future studies, will be the first step toward devising a strategy for selecting the appropriate time-scale segments for improved tuning.

The single-parameter nature of PARSIM's adaptation is also its primary contribution. The ability to define the performance error in terms of individual parameters allows PARSIM to decouple the multi(Q)-parameter error approximation of Eq. (24) into Q single-parameter error approximations in the form of Eq. (26), so that each parameter correction can be performed independent of the others. As such, the parameter error minimization approach of PARSIM contrasts with the performance error minimization of regression. It also makes the solution independent of the contour of the performance error and its gradient, leading potentially to a different trajectory than that of IFT.

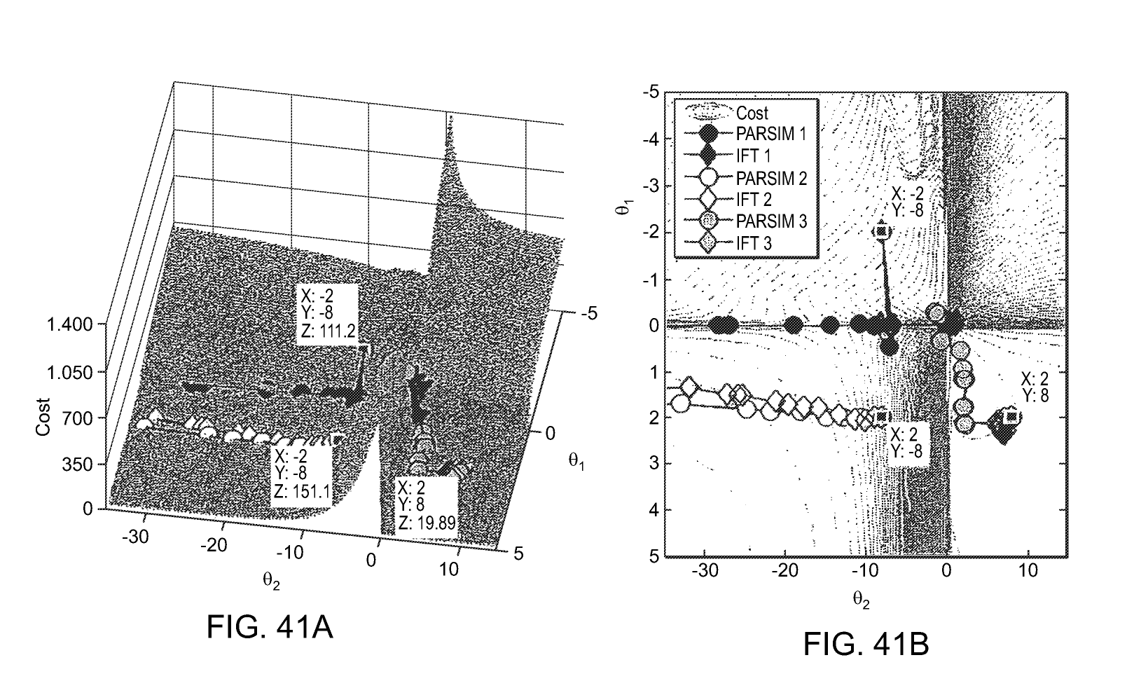

To illustrate the contrasting solutions by the two methods, the solution trajectories of PARSIM and IFT are shown for a hypothetically difficult surface in FIGS. 41A-41B. The global minimum in this figure is at point (0,0). Solution trajectories with three different starting points are shown, with the trajectories by PARSIM marked by circles and those by IFT shown with triangles. According to the results in FIGS. 41A-41B, there is a case where PARSIM fails (starting point (x:−2, y:−8)), one where IFT fails (starting point (x:2, y:8)), and one where both fail (starting point (x:2, y:−8)) in leading the solution to the global minimum.

The potentially different solution trajectories by PARSIM and IFT provide the significant advantage of implementing a hybrid approach that considers the two solutions during adaptation. A possible approach to the integration of the two solutions is through a competitive mechanism whereby the two solutions are evaluated concurrently after every so many iterations to evaluate their effectiveness in reducing the performance error. Of course, similar techniques like this can be devised between IFT and other search algorithms, like genetic search that are equally immune to local minima entrapments. However, the advantage of PARSIM over the other search algorithms is that it is as efficient as IFT in finding the global minimum, so the cost associated with the added search will not be as extensive.

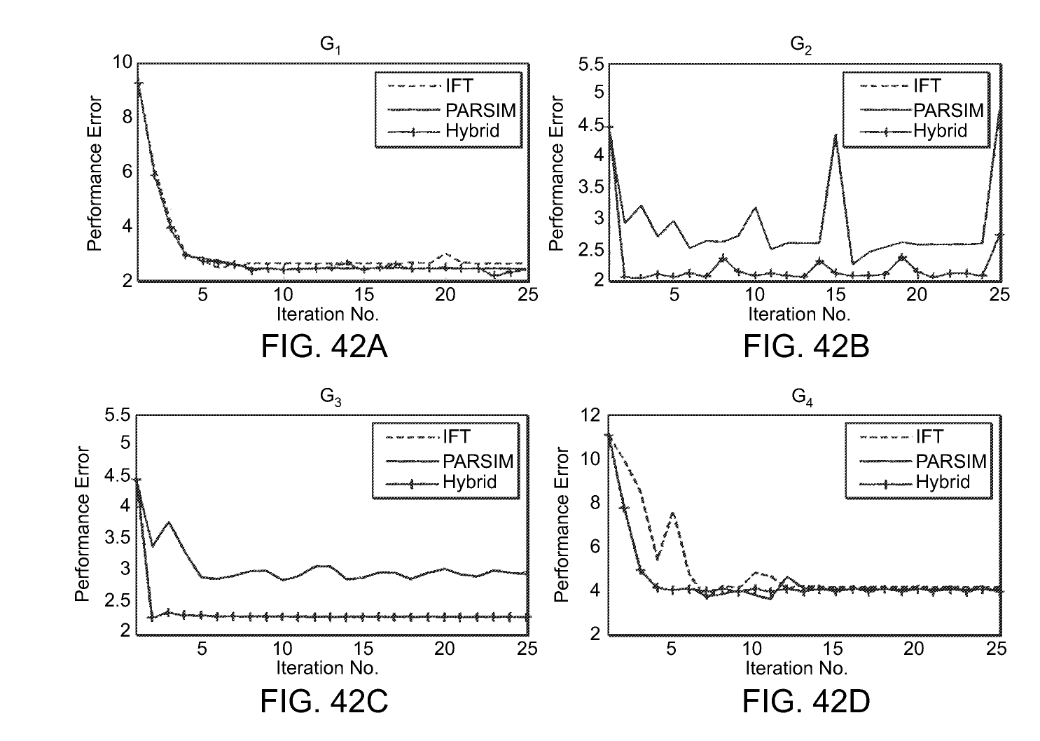

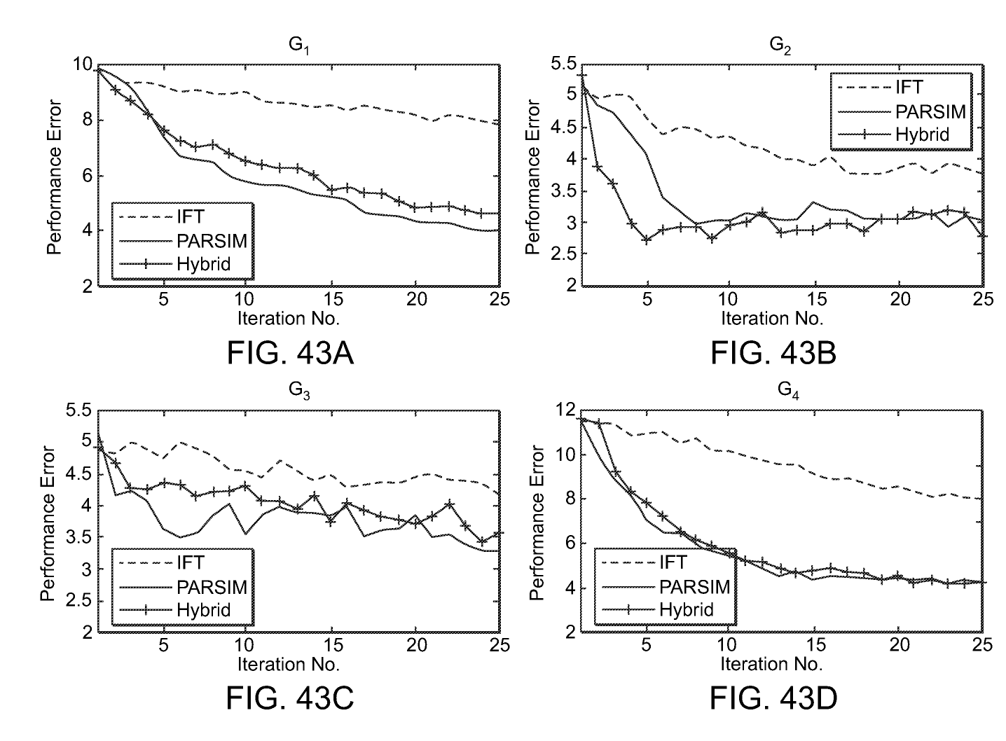

For illustration purposes, we tested a competitive scheme whereby the better solution was determined after every iteration of PARSIM and IFT according to the magnitude of performance error associated with each solution. The performance error from the application of this competitive approach to the benchmark plants in Table 17 are shown in FIGS. 42A-42D and 43A-43D without and with noise present in the output, respectively. For these applications, the adaptation step size was μ=0.75 and the entire range of time and time-scale data was considered for IFT and PARSIM, respectively. The parameter signatures for PARSIM were obtained with a threshold level of η=0.2. For the results in FIG. 42, Gaussian noise was added to the system output (through ν in FIG. 42). The performance errors in FIGS. 42A-42D indicate that the Hybrid method tends to favor the solutions from IFT when no noise is present, but this tendency is switched towards PARSIM in presence of noise, as indicated by the results in FIGS. 43A-43D. Here it should be noted that the reason the solution from the Hybrid method does not match the better solution in all cases is the randomness caused by the presence of noise.

Many changes in the details, materials, and arrangement of parts, herein described and illustrated, can be made by those skilled in the art in light of teachings contained hereinabove. Accordingly, it will be understood that the following claims are not to be limited to the embodiments disclosed herein and the equivalents thereof, and can include practices other than those specifically described.

1. A computer implemented method for determining system parameter adaptation comprising:
transforming a plurality of operating parameters to a selected domain;
selectively varying parameter values to determine adjusted parameter values; and
using the adjusted parameter values to adjust a system operation.

2. The method of claim 1 wherein the selected domain comprises a time-scale plane.

3. The method of claim 1 wherein each parameter of the plurality of parameters is separately varied to provide adjusted parameter values.

4. The method of claim 1 wherein the method comprises applying a filter to parameter data to obtain the adjusted parameter values.

5. The method of claim 1 further comprising using a computer program to obtain the adjusted parameter values.

6. The method of claim 1 further comprising adjusting model parameters.

7. The method of claim 1 wherein the transformation comprises a wavelet transformation.

8. The method of claim 1 further comprising obtaining a parameter signature.

9. The method of claim 8 wherein the parameter signature comprises a plurality of pixel values in the selected domain.

10. The method of claim 9 wherein the parameter signature comprises a union of all pixel values in a time scale plane.

11. The method of claim 9 further comprising obtaining a parametric error value.

12. The method of claim 11 further comprising determining a parametric error value for a selected parameter of the plurality of operating parameters separately from determining the parametric error values of non-selected parameters.

13. The method of claim 11 wherein the step of obtaining a parameter signature comprises applying a filter to transformed parameter values.

14. The method of claim 1 further comprising estimating parameter effects by univariately adjusting operating parameter values and subsequently transforming the operating parameter values to the selected domain.

15. The method of claim 8 wherein the step of selectively varying parameter values further comprises minimizing an error value associated with the parameter signature.

16. The method of claim 15 further comprising iterating steps of the method until convergence of parameter values.

17. The method of claim 1 further comprising using the adjusted parameter values for financial modeling.

18. The method of claim 1 further comprising using the adjusted parameter values to tune a system controller.

19. The method of claim 1 further comprising using the adjusted parameter values with a simulation model.

20. A system for providing adjusted parameter values comprising:
a processor programmed with a computer program that transforms operating parameter to a selected domain with a filter and that determines adjusted parameter values.

21. The system of claim 15 wherein the software program transforms the parameter values to a time-scale plane.

22. The system of claim 15 wherein the system provides adjusted model parameter values.

23. The system of claim 15 further comprising a memory to store adjusted parameter values.

24. The system of claim 15 further comprising a graphical user interface.

25. The system of claim 20 wherein the computer program is executable in the processor, the computer program comprises code configuring the processor to transform parameter values and adapt the parameters to minimize error associated with the parameter.

26. The system of claim 25 wherein the computer program further comprises the iteration of steps to converge parameter values.

27. The system of claim 20 wherein the system adjusts parameters of a feedback control system.

28. The system of claim 20 wherein the system adjusts model parameters of a simulation computer program.
